(19) United States
(12) Patent Application Publication
(10) Pub. No.: US 2013/0181051 A1
(43) Pub. Date: Jul. 18, 2013

(54) TWO-PLANE OPTICAL CODE READER FOR ACQUISITION OF MULTIPLE VIEWS OF AN OBJECT

(71) Applicants: Bryan L. Olmstead, Eugene, OR (US); Alan Shearin, Eugene, OR (US)

(72) Inventors: Bryan L. Olmstead, Eugene, OR (US); Alan Shearin, Eugene, OR (US)

(21) Appl. No.: 13/740,150

(22) Filed: Jan. 11, 2013

Related U.S. Application Data
(60) Provisional application No. 61/586,618, filed on Jan. 13, 2012.

(51) Int. Cl. G06K 7/10

(52) U.S. Cl. CPC G06K 7/1096
USPC 235/440

(57) ABSTRACT

An optical code reader (80,150,180,210) forms images of an optical code on an object (20). The reader (80,150,180,210) comprises first and second viewing surfaces generally transverse to one another. The surfaces bound a viewing volume (64) in which the object (20) may be imaged. The reader (80,150,180,210) also comprises a set of one or more imagers (60) positioned on an opposite side of one or more of the first and second viewing surfaces relative to the viewing volume (64), and oriented and configured to capture images of the object (20) from at least three different views (62). Each of the views (62) passes through one of said first and second viewing surfaces. At least one of said views (62) passes through the first viewing surface, and at least one of said views (62) passes through the second viewing surface. The reader (80,150,180,210) also comprises at least one mirror (130), off which is reflected at least one of the views (62).

### RELATED APPLICATIONS

This application claims priority from U.S. Provisional Patent Application No. 61/586,618, filed Jan. 13, 2012.

The disclosures of U.S. provisional patent application No. 61/140,930, filed Dec. 26, 2008; U.S. application Ser. No. 12/370,497, filed Feb. 12, 2009; U.S. provisional application No. 61/028,164, filed Feb. 12, 2008; U.S. provisional application No. 61/140,930; U.S. patent application Ser. No. 12/645,984, filed Dec. 23, 2009; U.S. patent application Ser. No. 12/646,794 filed Dec. 23, 2009; and U.S. patent application Ser. No. 12/646,829, filed Dec. 23, 2009, are incorporated herein by reference in their entireties.

### TECHNICAL FIELD

The field of this disclosure relates generally to imaging, and more particularly but not exclusively to reading of optical codes (e.g., bar codes).

### BACKGROUND INFORMATION

Optical codes encode useful, optically-readable information about the items to which they are attached or otherwise associated. Perhaps the best known example of an optical code is the bar code. Bar codes are ubiquitously found on or associated with objects of various types, such as the packaging of retail, wholesale, and inventory goods; retail product presentation fixtures (e.g., shelves); goods undergoing manufacturing; personal or company assets; and documents. By encoding information, a bar code typically serves as an identifier of an object, whether the identification be to a class of objects (e.g., containers of milk) or a unique item (e.g., U.S. Pat. No. 7,201,322).

Bar codes include alternating bars (i.e., relatively dark areas) and spaces (i.e., relatively light areas). The pattern of alternating bars and spaces and the widths of those bars and spaces represent a string of binary ones and zeros, wherein the width of any particular bar or space is an integer multiple of a specified minimum width, which is called a “module” or “unit.” Thus, to decode the information, a bar code reader must be able to reliably discern the pattern of bars and spaces, such as by determining the locations of edges demarking adjacent bars and spaces from one another, across the entire length of the bar code.

Bar codes are just one example of the many types of optical codes in use today. Bar codes are an example of a one-dimensional or linear optical code, as the information is encoded in one direction—the direction perpendicular to the bars and spaces. Higher-dimensional optical codes, such as, two-dimensional matrix codes (e.g., MaxiCode) or stacked codes (e.g., PDF 417), which are also sometimes referred to as “bar codes,” are also used for various purposes.

An imager-based reader utilizes a camera or imager to generate electronic image data (typically in digital form) of an optical code. The image data is then processed to find and decode the optical code. For example, virtual scan line techniques are known techniques for digitally processing an image containing an optical code by looking across an image along a plurality of lines, typically spaced apart and at various angles, somewhat like a laser beam's scan pattern in a laser-based scanner.

Imager-based readers often can only form images from one perspective—usually that of a normal vector out of the face of the imager. Such imager-based readers therefore provide only a single point of view, which may limit the ability of the reader to recognize an optical code in certain circumstances. For example, because the viewing volume of an imager-based reader is typically conical in shape, attempting to read a bar code or other image in close proximity to the scanning window (reading “on the window”) may be less effective than with a basket-type laser scanner. Also, when labels are oriented such that the illumination source is reflected directly into the imager, the imager may fail to read properly due to uniform reflection washing out the desired image entirely, or the imager may fail to read properly due to reflection from a textured specular surface washing out one or more elements. This effect may cause reading of shiny labels to be problematic at particular reflective angles. In addition, labels oriented at extreme acute angles relative to the imager may not be readable. Lastly, the optical code may be oriented on the opposite side of the package, being hidden from view of the imager by the package itself.

Thus, better performance could result from taking images from multiple perspectives. A few imager-based readers that generate multiple perspectives are known. One such reader is disclosed in the present assignee's U.S. Pat. No. 7,398,927, in the names of inventors Olmstead et al., which discloses an embodiment having two cameras to collect two images from two different perspectives for the purpose of mitigating specular reflection. U.S. Pat. No. 6,899,272, issued on May 31, 2005, discloses one embodiment that utilizes two independent sensor arrays pointed in different orthogonal directions to collect image data from different sides of a package. Unfortunately, multiple-camera imager-based readers that employ spatially separated cameras require multiple circuit boards and/or mounting hardware and space for associated optical components which can increase the expense of the reader, complicate the physical design, and increase the size of the reader. Another embodiment according to the '272 patent utilizes a single camera pointed at a moveable mirror that can switch between two positions to select one of two different imaging directions. Additionally, the present assignee's U.S. Pat. No. 5,814,803, issued to Olmstead et al. on Sep. 29, 1998, depicts in its FIG. 62 a kaleidoscope tunnel formed from two mirrored surfaces, resulting in eight different, rotated versions of the same barcode from an object on a single imager.

### BRIEF DESCRIPTION OF THE DRAWINGS

FIG. 1 is an illustration of an exemplary six-sided box-shaped object that may be passed through a viewing volume of an optical code reader.

FIGS. 2A-2D are illustrations of cameras positioned to capture direct perspectives looking into a viewing volume.

FIGS. 3A-3D are respective side, isometric, front, and top views of an optical code reader capable of capturing multiple views from different perspectives, according to one embodiment.

FIG. 3E is a side view of mirrors reflecting a top upper perspective of a view volume along an image path to an imager of the optical code reader of FIGS. 3A-3D, showing the image path and view volume with shading lines.

FIG. 3F is a top view of mirrors reflecting a left upper perspective of a view volume along an image path to an imager of the optical code reader of FIGS. 3A-3D, showing the image path and view volume with shading lines.

FIG. 3G is a top view of mirrors reflecting a right upper perspective of a view volume along an image path to an imager of the optical code reader of FIGS. 3A-3D, showing the image path and view volume with shading lines.

FIG. 3I-1 is a front view of mirrors reflecting a left lower perspective of a view volume along an image path to an imager of the optical code reader of FIGS. 3A-3D, and showing the image path and view volume with shading lines.

FIG. 3I is a front view of mirrors reflecting a right lower perspective of a view volume along an image path to an imager of the optical code reader of FIGS. 3A-3D, and showing the image path and view volume with shading lines.

FIG. 3J is a side view of mirrors reflecting a back lower perspective of a view volume along an image path to an imager of the optical code reader of FIGS. 3A-3D, showing the image path and view volume with shading lines.

FIG. 3K is an isometric view of multiple image paths and respective multiple perspective view volumes that form a cumulative view volume of the optical code reader of FIGS. 3A-3D.

FIGS. 4A-4D are respective side, isometric, front, and top views of an optical code reader capable of capturing multiple views from different perspectives, according to another embodiment.

FIG. 4E is a side view of mirrors reflecting an upper perspective of a view volume along an image path to an imager of the optical code reader of FIGS. 4A-4D, showing the image path and view volume with shading lines.

FIG. 4F is a diagram of an image field of the horizontal imager in the optical code reader of FIGS. 4A-4D, divided into three regions to capture separate views.

FIG. 4G is a diagram of another image field of the horizontal imager in the optical code reader of FIGS. 4A-4D, divided into three alternative regions to capture separate views.

FIG. 4I-1 is a front view of mirrors reflecting a left lower perspective of a view volume along an image path of the optical code reader of FIGS. 4A-4D, showing the image path and view volume with shading lines.

FIG. 4I is a front view of mirrors reflecting a right lower perspective of a view volume along an image path to an image of the optical code reader of FIGS. 4A-4D, showing the image path and view volume with shading lines.

FIG. 4J is a side view of mirrors reflecting a back lower perspective of a view volume along an image path to an imager of the optical code reader of FIGS. 4A-4D, showing the image path and view volume with shading lines.

FIG. 4K is an isometric view of a compound mirror structure used with the horizontal imager in the optical code reader of FIGS. 4A-4D.

FIG. 4L is an isometric view of multiple image paths and respective multiple perspective view volumes that form a cumulative view volume of the optical code reader of FIGS. 4A-4D.

FIGS. 5A-1 through 5D-1 are respective side, isometric, front, and top views of an optical code reader capable of capturing multiple views from different perspectives, according to another embodiment.

FIG. 5A-2 is a side view of mirrors reflecting a left lower perspective of a view volume along an image path to an imager of the optical code reader of FIGS. 5A-1 through 5D-1, showing the image path and view volume.

FIG. 5E-1 is a map of an image field of the vertical imager in the optical code reader of FIGS. 5A-1 through 5D-1, divided into two regions to capture separate views.

FIG. 5F-1 is a side view of a mirror reflecting a top upper perspective of a view volume along an image path to an imager of the optical code reader of FIGS. 5A1-5D1, showing the image path and view volume.

FIG. 5G-1 is a top view of mirrors reflecting a left upper perspective of a view volume along an image path to an imager of the optical code reader of FIGS. 5A-1 through 5D-1, showing the image path and view volume.

FIG. 5H-1 is a top view of mirrors reflecting a right upper perspective of a view volume along an image path to an imager of the optical code reader of FIGS. 5A-1 through 5D-1, showing the image path and view volume.

FIG. 5I-1 is an isometric view of a compound mirror structure used with the vertical imager in the optical code reader of FIGS. 5A-1 through 5D-1.

FIG. 5J-1 is a map of an image field of the horizontal imager in the optical code reader of FIGS. 5A-1 through 5D-1, divided into two regions to capture separate views.

FIG. 5K-1 is a front view of mirrors reflecting a left lower perspective of a view volume along an image path to an imager of the optical code reader of FIGS. 5A-1 through 5D-1, showing the image path and view volume.

FIG. 5L-1 is a front view of mirrors reflecting a right lower perspective of a view volume along an image path to an image of the optical code reader of FIGS. 5A-1 through 5D-1, showing the image path and view volume.

FIG. 5KL-1 is a front view of mirrors reflecting right and left lower perspectives of a view volume along an image path to an imager of the optical code reader of FIGS. 5A-1 through 5D-1, showing the image path and view volume.

FIG. 5M-1 is an isometric view of mirrors reflecting a lower right perspective of a view volume along an image path to an imager of the optical code reader of FIGS. 5A-1 through 5D-1, showing the image path and view volume.

FIG. 5M-2 is a simplified alternative isometric view of mirrors reflecting a lower right perspective of a view volume along an image path to an imager of the optical code reader of FIGS. 5A-1 through 5D-1, showing the image path and view volume.

FIG. 5M-3 is a simplified alternative isometric view showing an unfolded natural lower right perspective of a view volume of FIG. 5M-2.

FIG. 5M-4 is a simplified alternative right side and back isometric view of mirrors reflecting a lower right perspective of a view volume along an image path to an imager of the optical code reader of FIGS. 5A-1 through 5D-1, showing the folded image path, view volume, and unfolded natural lower right perspective.

FIG. 5N-1 is an isometric view of mirrors reflecting a lower left perspective of a view volume along an image path to an imager of the optical code reader of FIGS. 5A-1 through 5D-1, showing the image path and view volume.

FIG. 5N-2 is a simplified alternative isometric view of mirrors reflecting a lower left perspective of a view volume along an image path to an imager of the optical code reader of FIGS. 5A-1 through 5D-1, showing the image path and view volume.

FIG. 5N-3 is a simplified alternative isometric view showing an unfolded natural lower left perspective of a view volume of FIG. 5N-2.

FIG. 5N-4 is a simplified alternative back view of mirrors reflecting a lower right perspective of a view volume along an image path to an imager of the optical code reader of FIGS. 5A-1 through 5D-1, showing the folded image path, view volume, and unfolded natural lower right perspective.

FIG. 5MN-1 is an isometric view of multiple image paths and respective lower left and right perspective view volumes of the optical code reader of FIGS. 5A-1 through 5D-1.

FIG. 5MN-2 is an isometric view of the natural unfolded lower left and right perspectives and their view volumes.

FIG. 5MN-3 is an alternative isometric view of multiple image paths and respective lower left and right perspective view volumes of the optical code reader of FIGS. 5A-1 through 5D-1.

FIG. 5MN-4 is a simplified alternative right side and back isometric view of mirrors reflecting lower right and left perspectives of a view volume along image paths to an imager of the optical code reader of FIGS. 5A-1 through 5D-1, showing the image paths and view volume.

FIG. 5O-1 is an isometric view of multiple image paths and respective multiple perspective view volumes that form a cumulative view volume of the optical code reader of FIGS. 5A-1 through 5D-1.

FIG. 5P-1 is an image captured by a prototype optical code reader similar to that described with respect to FIGS. 5A-1 through 5O-1, the image showing a label on the back side of a jar as captured by right and left image fields of the imager.

FIG. 5Q-1 is an image captured by a prototype optical code reader similar to that described with respect to FIGS. 5A-1 through 5O-1, the image showing a label on the back side of a can as captured by right and left image fields of the imager.

FIG. 5R-1 is an image captured by a prototype optical code reader similar to that described with respect to FIGS. 5A-1 through 5O-1, the image showing the bottom and sides of a container as well as a label on the back side of the container as captured by right and left image fields of the imager.

FIGS. 5A-5D are respective side, isometric, front, and top views of an optical code reader capable of capturing multiple views from different perspectives, according to another embodiment.

FIG. 5E is a map of an image field of the vertical imager in the optical code reader of FIGS. 5A-5D, divided into three regions to capture separate views.

FIG. 5F is a side view of a mirror reflecting a top upper perspective of a view volume along an image path to an imager of the optical code reader of FIGS. 5A-5D, showing the image path and view volume with shading lines.

FIG. 5G is a top view of mirrors reflecting a left upper perspective of a view volume along an image path to an imager of the optical code reader of FIGS. 5A-5D, showing the image path and view volume with shading lines.

FIG. 5H is a top view of mirrors reflecting a right upper perspective of a view volume along an image path to an imager of the optical code reader of FIGS. 5A-5D, showing the image path and view volume with shading lines.

FIG. 5I is an isometric view of a compound mirror structure used with the vertical imager in the optical code reader of FIGS. 5A-5D.

FIG. 5J is a map of an image field of the horizontal imager in the optical code reader of FIGS. 5A-5D, divided into three regions to capture separate views.

FIG. 5K is a front view of mirrors reflecting a left lower perspective of a view volume along an image path to an imager of the optical code reader of FIGS. 5A-5D, showing the image path and view volume with shading lines.

FIG. 5L is a front view of mirrors reflecting a right lower perspective of a view volume along an image path to an image of the optical code reader of FIGS. 5A-5D, showing the image path and view volume with shading lines.

FIG. 5M is a side view of mirrors reflecting a back lower perspective of a view volume along an image path to an imager of the optical code reader of FIGS. 5A-5D, showing the image path and view volume with shading lines.

FIG. 5N is an isometric view of a compound mirror structure used with the horizontal imager in the optical code reader of FIGS. 5A-5D.

FIG. 5O is an isometric view of multiple image paths and respective multiple perspective view volumes that form a cumulative view volume of the optical code reader of FIGS. 5A-5D.

FIGS. 6A-6D are respective side, isometric, front, and top views of an optical code reader capable of capturing multiple views from different perspectives, according to another embodiment.

FIG. 6E is a map of an image field of the imager in the optical code reader of FIGS. 6A-6D, divided into three regions to capture separate views.

FIG. 6F is a side view of a mirror reflecting an upper perspective of a view volume along an image path to an imager of the optical code reader of FIGS. 6A-6D, showing the image path and view volume with shading lines.

FIG. 6G is a front view of mirrors reflecting a left lower perspective of a view volume along an image path to an imager of the optical code reader of FIGS. 6A-6D, showing the image path and view volume with shading lines.

FIG. 6H is a front view of mirrors reflecting a right lower perspective of a view volume along an image path to an imager of the optical code reader of FIGS. 6A-6D, showing the image path and view volume with shading lines.

FIG. 6I is an isometric view of a compound mirror structure used in the optical code reader of FIGS. 6A-6D.

FIG. 6J is an isometric view of multiple image paths and respective multiple perspective view volumes that form a cumulative view volume of the optical code reader of FIGS. 6A-6D.

FIG. 6K is an isometric view of an optical code reader capable of capturing views from different perspectives, according to an alternative embodiment.

FIG. 6L is a map of an image field of the imager of FIG. 6K, divided into four regions to capture separate views.

FIG. 6M is a side view of mirrors reflecting a back perspective of a view volume along an image path to an imager of the optical code reader of FIG. 6K, showing the image path and view volume with shading lines.

FIG. 6N is an isometric view of a compound mirror structure in the optical code reader of FIG. 6K.

FIG. 7A is an illustration of an omnidirectional virtual scan line pattern over a one-dimensional optical code.

FIG. 7B is an illustration of a unidirectional virtual scan line pattern over a two-dimensional optical code.

### DETAILED DESCRIPTION OF EMBODIMENTS

With reference to the above-listed drawings, this section describes particular embodiments and their detailed construction and operation. The embodiments described herein are set forth by way of illustration only and not limitation. Those skilled in the art will recognize in light of the teachings herein that, for example, other embodiments are possible, variations can be made to the embodiments described herein, and there may be equivalents to the components, parts, or steps that make up the described embodiments.

For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

### I. INTRODUCTION & OVERVIEW

Various imager-based optical code readers and associated methods are described herein. Some embodiments of these optical code readers and systems improve the performance of optical code readers by providing multiple image fields to capture multiple views.

In some embodiments, an image field of an imager may be partitioned into two or more regions, each of which may be used to capture a separate view of the view volume. In addition to providing more views than imagers, such embodiments may enhance the effective view volume beyond the view volume available to a single imager having a single point of view.

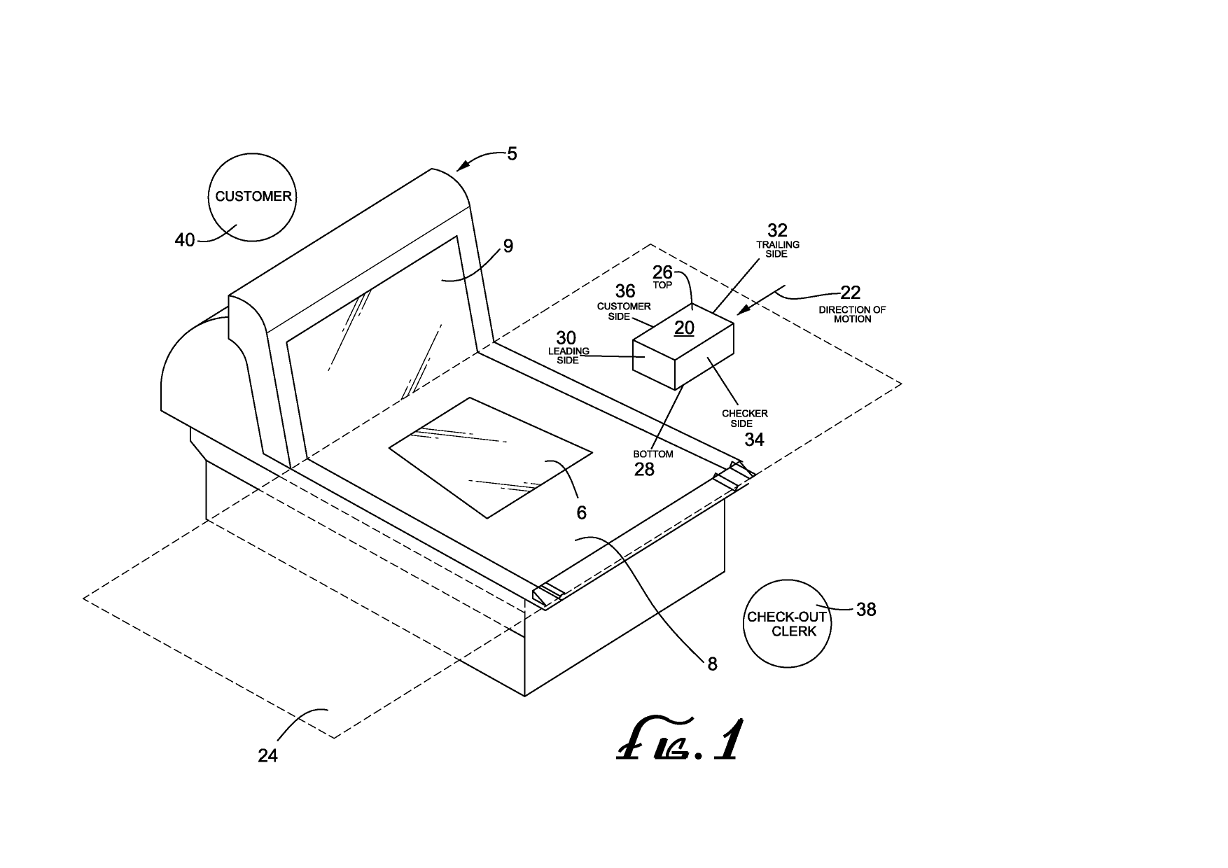

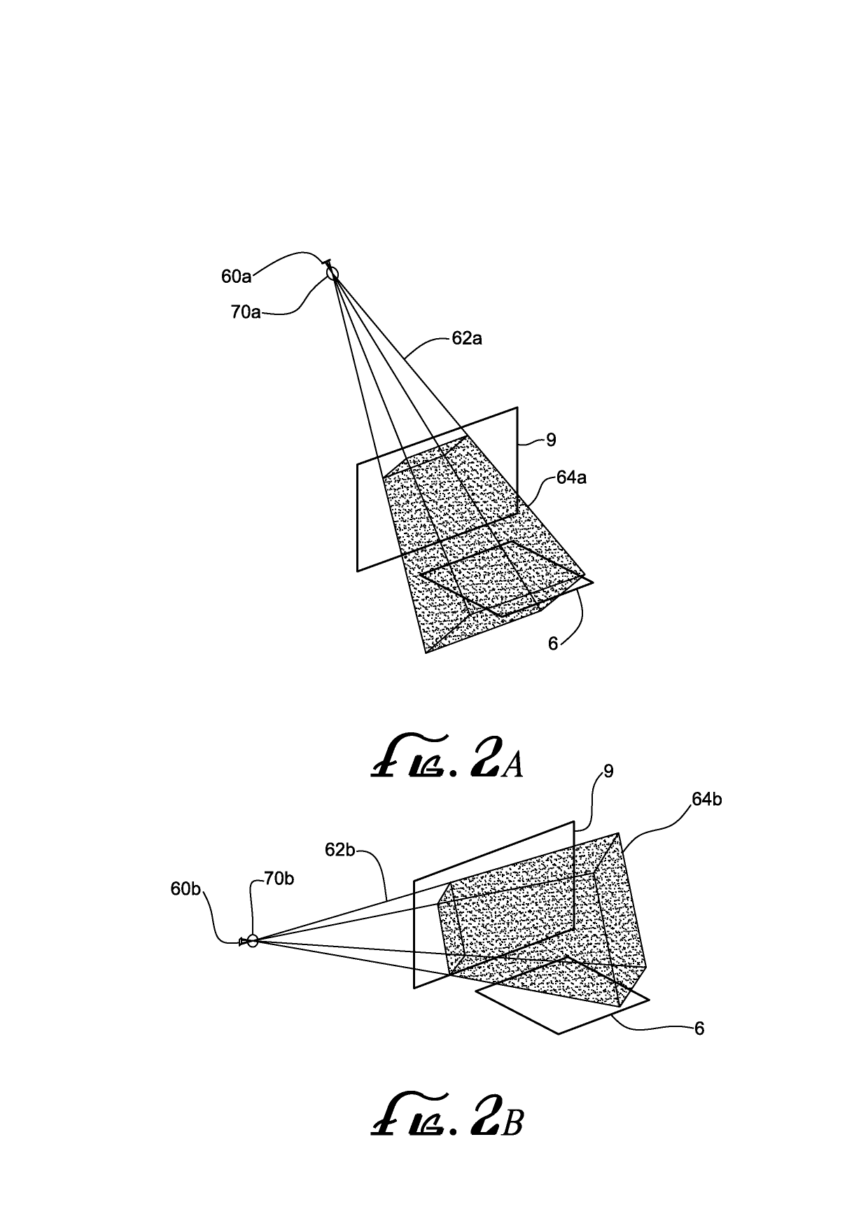

FIG. 1 is an illustration of an exemplary object 20 that may be passed through a viewing volume of an example optical code reader 5. The optical code reader 5 is illustrated as a two-plane or bioptic reader having a generally horizontal window 6 and a generally vertical window 9. The upper window 9 and lower window 6 are preferably portions of a two-plane weigh scale platter 8 such as the All-Weighs® platter available from Datalogic Scanning, Inc. of Eugene, Oreg. The viewing volume may be a function of the enclosure and style of the optical code reader 5 and the perspectives of the views in which images of the objects are captured. A perspective may encompass a location, direction, angle, or the like—or any combination of the foregoing—that characterize a vantage or point of view for seeing, imaging, visualizing via machine vision, or illuminating the object 20 or a part of an object 20. Different perspectives are generally generated from the horizontal window 6 and the vertical window 9. Single or multiple views—each from the same or different perspectives—may be obtained through each window, depending on the design of the reader 5. The collection of all views together constitutes a cumulative view, which defines the viewing volume or scan volume of the reader 5. Different views may enable reading of an optical code on different sides of the object 20.

For general purposes of discussion, the object 20 is represented by a rectangular-shaped six-sided polyhedron, such as a cereal box (hereinafter referred to as a box-shaped item or object) that may be passed through a checkout stand at a supermarket. The object 20 may have any three-dimensional form and the checkout stand 24 is an exemplary use for the optical code readers discussed herein and should not be considered as limiting.

For convenience, this box-shaped object 20 may be described with respect to an arbitrary direction of travel 22 across the reader 5. For the purposes of description relative to the ability of an optical code reader to read certain of the sides of the box-shaped object 20 being passed through the scan volume in the orientation as illustrated, the box-shaped object may be described as having a top side 26, a bottom side 28, and four lateral sides 30, 32, 34, and 36. The lateral sides may be referred to as the left or leading side 30, the right or trailing side 32, the checker side 34 (because it may be in proximity to a checkout clerk 38), and the customer side 36 (because it may be in proximity to a customer 40). A housing or housing portion of an optical code reader 5 may separate the customer 40 from the object 20 if the optical code reader 5 is a vertical optical code reader or a bi-optic optical code reader, as shown. The customer side 36 may alternatively be described as a wall side 36 or an opposite side 36 or a front side. In some settings, the checker side 34 may be called the back side. The terminology indicated in FIG. 1 and described in this paragraph is introduced to facilitate discussion of the concepts described in this document; in other contexts, different terminology may be used to describe the sides of the object 20.

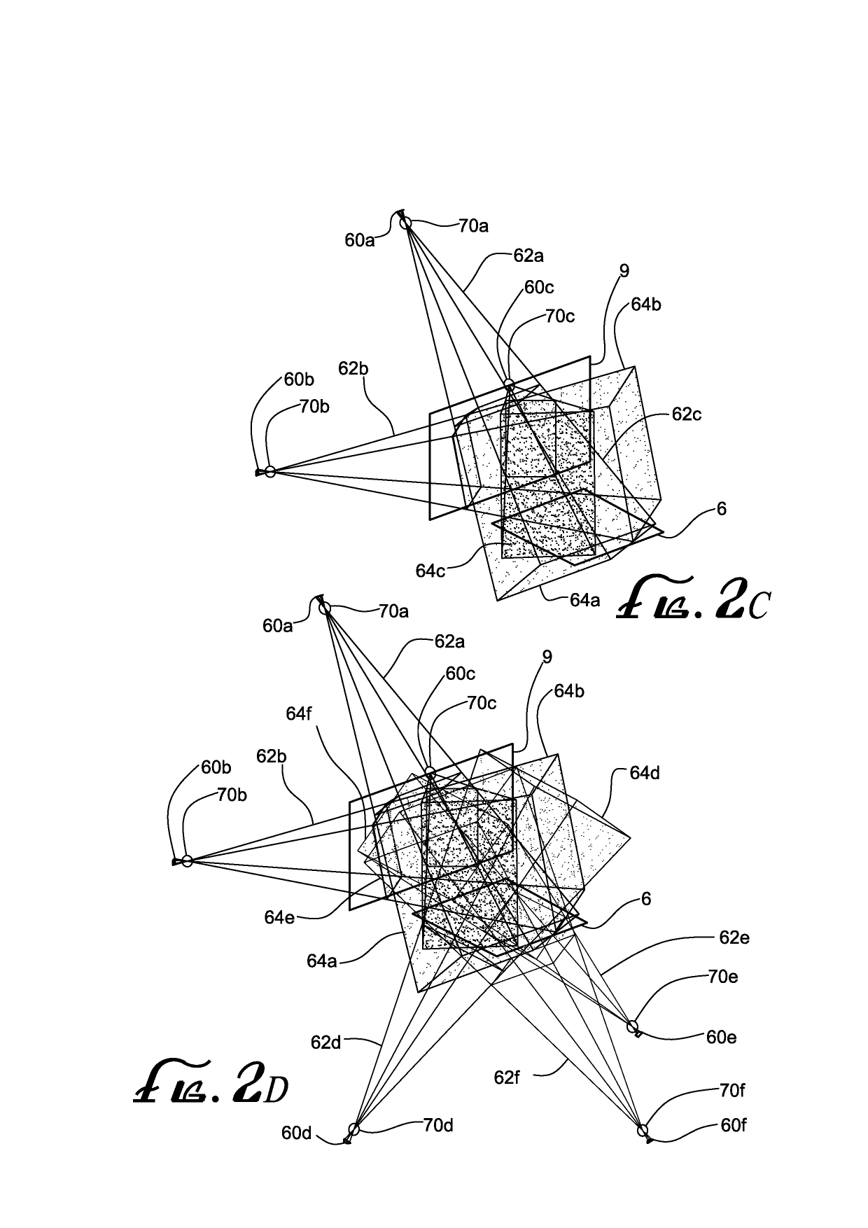

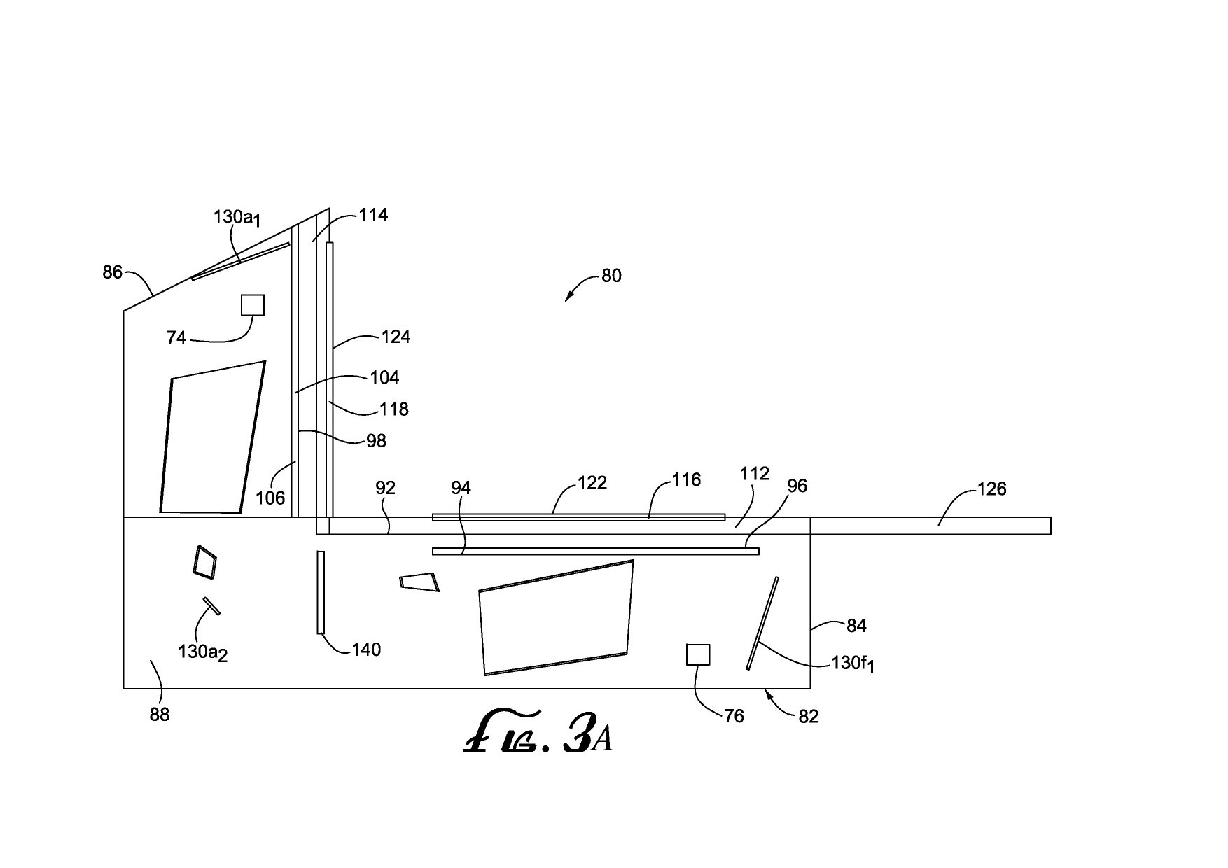

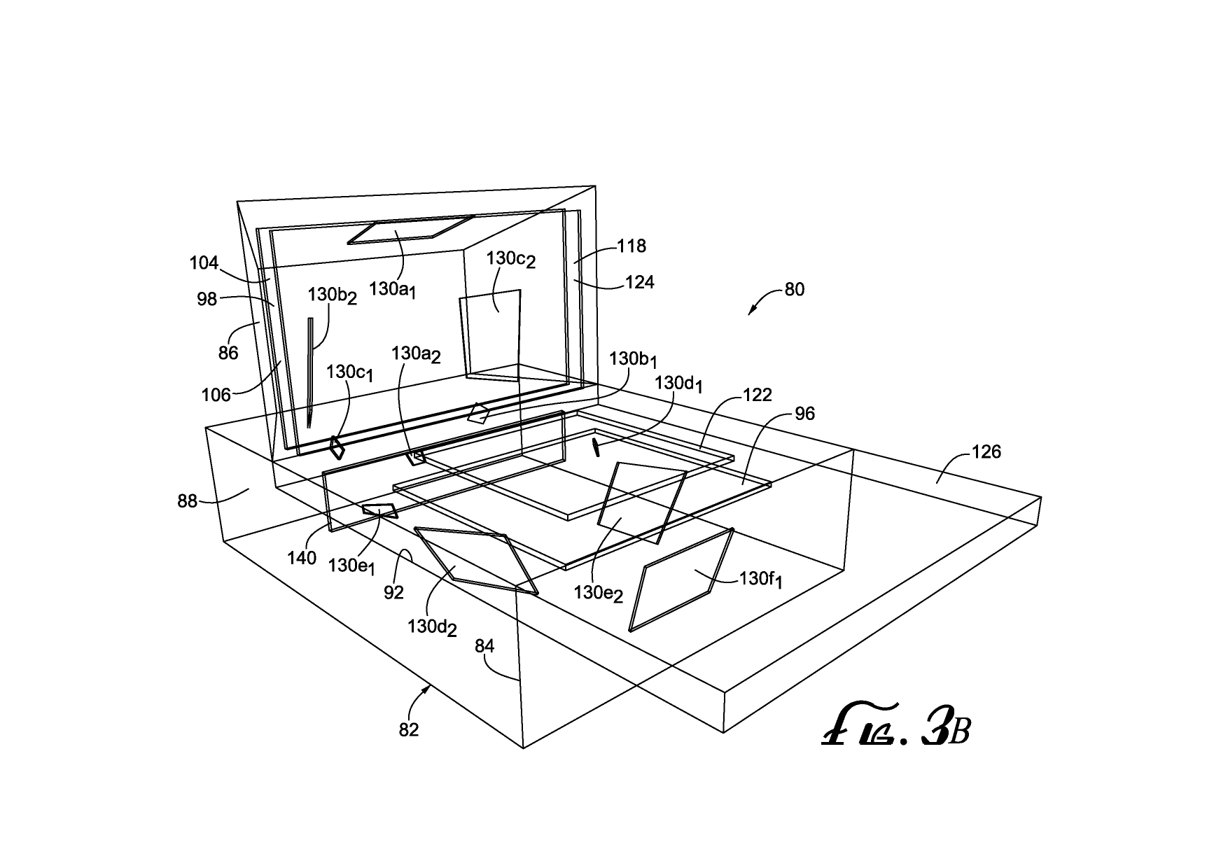

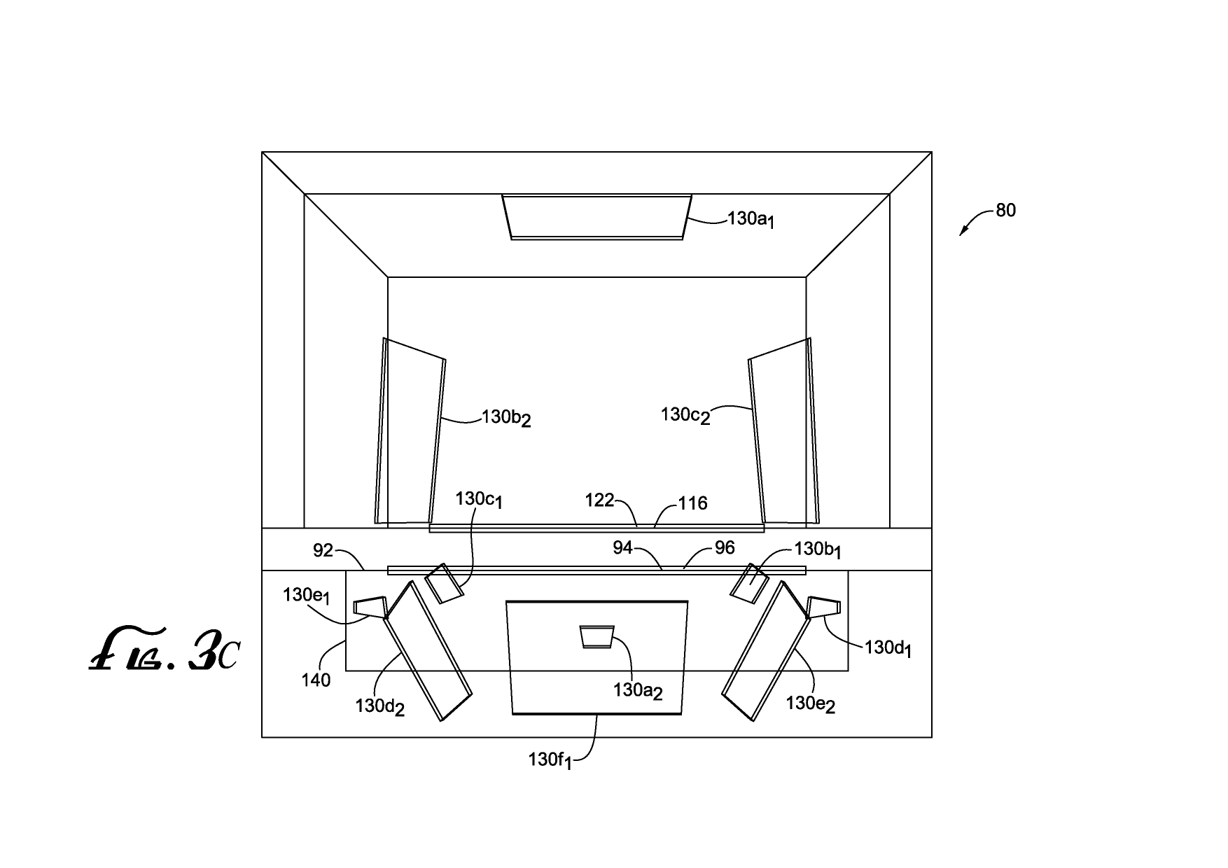

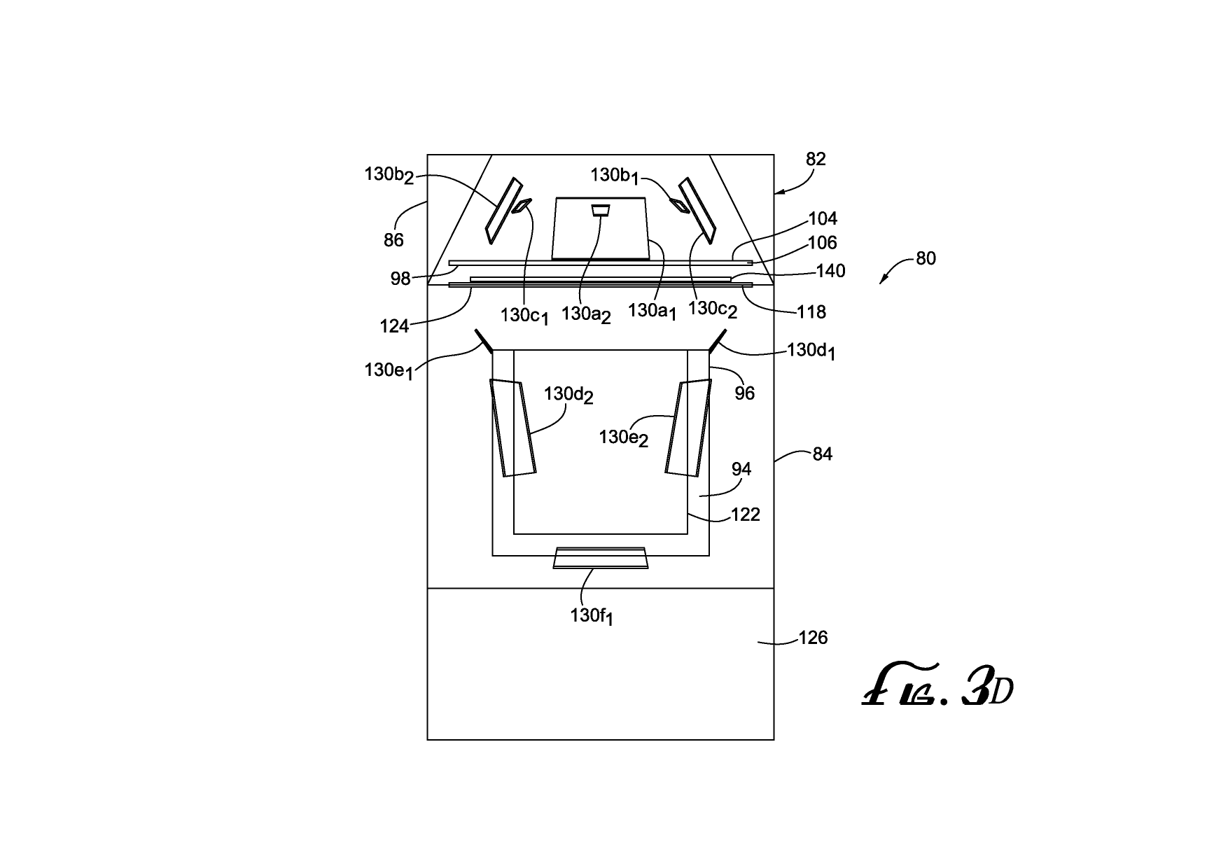

FIGS. 2A-2D are illustrations of imagers 60 (60a, 60b, 60c, 60d, 60e, and 600, such as cameras, positioned to capture direct perspective views of all sides of the object 20 (not shown in FIGS. 2A-2D). The perspective views form respective view volumes 64a, 64b, 64c, 64d, 64e, and 64f, some or all of which may intersect in proximity to the object 20 and the union of which constitute a cumulative view volume 64. Images of the object 20 propagate along corresponding image paths 62 (62a, 62b, 62c, 62d, 62e, 62f) that correspond to the perspective views and are captured by corresponding imagers 60a, 60b, 60c, 60d, 60e, and 60f.

Respective lenses 70 (70a, 70b, 70c, 70d, 70e, and 700 direct light within the view volumes 64 to the imagers 60 along the associated image paths 62. Each imager 60 and lens 70 form an electronic camera, which is a standard configuration in the art of electronic imaging. For ease of understanding, the imagers 60 are depicted capturing the direct perspectives through at least two viewing windows positioned in transverse planes, typically a lower viewing window 66 and an upper viewing window 68. In some preferred embodiments, the lower viewing window 66 and the upper viewing window 68 are positioned in orthogonal planes. In some embodiments, the lower viewing window 66 and the upper viewing window 68 may be transparent plates that may be separated or adjoining.

FIG. 2A shows a top imager 60a capturing a top perspective of the viewing volume 64a along a top image path 62a through the upper viewing window 9. The top perspective may facilitate capture of images of the customer side 36 as well as the top side 26 of the object 20. The top perspective may also facilitate the capture of images of either the leading side 30 or the trailing side 32 depending on the location of the imager 60a and the orientation of the plane of its imaging field.

FIG. 2B shows a left vertical imager 60b capturing a left vertical perspective of the viewing volume 64b along a left vertical image path 62b through the upper viewing window 9. The left vertical perspective may facilitate capture of images of the leading side 30 as well as the customer side 36. The left vertical perspective may also facilitate capture of images of the top side 26 of the object 20 depending on the height of the imager 60b and the orientation of the plane of its imaging field.

FIG. 2C shows the top imager 60a of FIG. 2A, the left vertical imager 60b of FIG. 2B, and a right vertical imager 60c capturing a right vertical perspective of the viewing volume 64c along a right vertical image path 62c through the upper viewing window 68. The right vertical perspective may facilitate capture of images of the trailing side 32 as well as the customer side 36. The right vertical perspective may also facilitate capture of images of the top side 26 of the object 20 depending on the height of the imager 60c and the orientation of the plane of its imaging field.

FIG. 2D shows the imagers 60 of FIG. 2C and also shows a left horizontal imager 60d, a right horizontal imager 60e, and a back imager 60f capturing respectively a left horizontal perspective, a right horizontal perspective, and a back perspective of the respective viewing volumes 64d, 64e, and 64f along respective image paths 62d, 62e, and 62f through the lower viewing window 6. The left horizontal perspective may facilitate capture of images of the leading side 30 as well as the bottom side 28. The left horizontal perspective may also facilitate capture of images of either the checker side 34 or the customer side 36, depending on the location of the imager 60d and the orientation of the plane of its imaging field. The right horizontal perspective may facilitate capture of images of the trailing side 32 as well as the bottom side 28. The right horizontal perspective may also facilitate capture of images of either the customer side 36 or the checker side 34, depending on the location of the imager 60e and the orientation of the plane of its imaging field. The back perspective may facilitate capture of images of the checker side 34 as well as the bottom side 28. The back perspective may also facilitate capture of images of the leading side 30 or the trailing side 32, depending on the location of the imager 62f.

With reference again to FIGS. 2A-2D, an optical code reader employing a plurality of imagers 60, each for capturing a different direct perspective view of the viewing volume 64, could provide excellent performance in terms of a first pass read rate (FPRR) regardless of the placement or orientation of the object 20 relative to such an optical code reader housing the imagers 60. (The FPRR of an optical code reader is the percentage of time that the optical code reader successfully reads the optical code of the object 20, with or without stitching portions of the optical code received from different views together. For example, if an optical code reader has a 90% FPRR, the optical codes on nine out of every ten objects 20 will be read the first time those objects 20 are passed through the viewing volume 64 of the optical code reader. The remaining objects 20 (i.e. one out of every ten items) will not be read on the first pass, in which case the checker will pass the object 20 through the viewing volume 64 one or more additional times until the optical code reader eventually reads the optical code.) Unfortunately, the direct perspective imagers 60 are relatively far away from the object 20 and the viewing windows through which they see the object 20, thus requiring such an optical code reader to have a large optical reader housing, which may be impractical. Furthermore, the direct perspective imagers 60 are dispersed from each other and not readily positionable in or near common planes so as to permit use of common circuit boards to host multiple imagers.

Accordingly, some of the following embodiments employ one or more imagers 60 and sets of fold mirrors. The fold mirrors permit the imager(s) 60 to be closer to each other and permit an optical reader housing to confine them to a smaller housing volume or capacity. In some of such embodiments, the imager(s) 60, may capture perspectives through a common viewing window and may be arranged in a portion of an optical code reader housing that is adjacent to the common viewing window. Some of such embodiments may include a single viewing window or may have at least two transverse oriented viewing windows. In other embodiments, the imager(s) 60, may be arranged in a portion of an optical code reader housing that is distant from, and/or generally transverse to, a common viewing window. In some embodiments including transversely oriented viewing windows, multiple imagers 60, regardless of which of the viewing windows they use to capture perspectives, may be arranged in a common portion of an optical code reader housing. In some of such embodiments, multiple imagers 60 may be in close proximity, may be supported along a common plane, or may be supported by a common circuit board.

In other embodiments, a plurality of sets of fold mirrors can be employed to convey at least a portion of at least two different perspectives of the viewing volume to different regions of an image field of a common imager. In some of such embodiments, the sets of fold mirrors convey perspectives from a common viewing window onto different regions of an image field of a common imager. In some such embodiments, the imager may be located in a portion of an optical code reader housing that is adjacent to the common viewing window or located in a portion of an optical code reader housing that is distant from and/or generally transverse to the common viewing window, e.g., through orthogonal windows of an “L”-shaped bioptic optical code reader. In some embodiments including transversely oriented viewing windows, different regions of an image field of a common imager may capture at least one perspective through each of the viewing windows.

According to one embodiment, for example, a method reads an optical code on an object in a viewing volume bounded on two generally transverse sides by respective first and second viewing surfaces, by use of a number of imagers. The method directs a plurality of views from the viewing volume onto different imager portions of the set of imagers. Each of the plurality of views passes through one of said first and second viewing surfaces. At least one of said views passes through the first viewing surface, and at least one of said views passes through the second viewing surface. The number of views is at least three. At least one of the views is reflected off at least one mirror. The number of views is greater than the number of imagers. The method forms at least one image with said number of imagers. The method processes the optical code based on said at least one image.

According to another embodiment, for example, a method reads an optical code on an object in a viewing volume bounded on two generally transverse sides by respective first and second viewing surfaces, by use of a plurality of imagers. The method directs a plurality of views from the viewing volume onto different imager portions of the set of imagers. Each of the plurality of views passes through one of said first and second viewing surfaces. At least one of said views passes through the first viewing surface, and at least one of said views passes through the second viewing surface. The number of views is at least three. At least one of the views is reflected off at least one mirror. The method forms at least one image with said plurality of imagers, wherein at least a first and second of said plurality of imagers are mounted on opposing surfaces of a common circuit board. The method processes the optical code based on said at least one image.

According to another embodiment, for example, an optical code reader forms images of an optical code on an object. The optical code reader comprises a first viewing surface, a second viewing surface, a set of one or more imagers, and at least one mirror. The second viewing surface is generally transverse to the first viewing surface. The first and second surfaces bound a viewing volume in which the object may be imaged. The set of one or more imagers are positioned on an opposite side of one or more of the first and second viewing surfaces relative to the viewing volume, and oriented and configured to capture images of the object, when the object is in the viewing volume, from at least three different views. Each of the views passes through one of said first and second viewing surfaces. At least one of said views passes through the first viewing surface. At least one of said views passes through the second viewing surface. The number of views is greater than the number of imagers. The at least one mirror is positioned on an opposite side of one or more of the first and second viewing surfaces relative to the viewing volume. At least one of the views is reflected off one or more of said at least one mirror.

According to yet another embodiment, for example, an optical code reader forms images of an optical code on an object. The optical code reader comprises a first viewing surface, a second viewing surface, a set of two or more imagers, a common circuit board, and at least one mirror. The second viewing surface is generally transverse to the first viewing surface. The first and second viewing surfaces bound a viewing volume in which the object may be imaged. The set of two or more imagers are positioned on an opposite side of one or more of the first and second viewing surfaces relative to the viewing volume and oriented and configured to capture images of the object, when the object is in the viewing volume, from at least three different views. Each of the views passes through one of said first and second viewing surfaces. At least one of said views passes through the first viewing surface, and at least one of said views passes through the second viewing surface. The common circuit board has opposing first and second sides. At least some of said imagers are mounted on the first side of the common circuit board, and at least some of said imagers are mounted on the second side of the common circuit board. The at least one mirror is positioned on an opposite side of one or more of the first and second viewing surfaces relative to the viewing volume, wherein at least one of the views is reflected off one or more of said at least one mirror.

Certain embodiments may be capable of achieving certain advantages, including some or all of the following: (1) perspective diversity, including the ability to robustly capture codes at a variety of locations and angular orientations (pitch, roll, and yaw) in the viewing volume, with concomitant advantages in terms of (a) improved usability, (b) improved FPRR, and (c) throughput for repeat-use applications such as retail checkout; (2) use of a single circuit board to mount multiple cameras; (3) improved utilization of space, resulting in a smaller reader. These and other advantages of various embodiments will be apparent upon reading this document.

Additional details concerning the construction and operation of particular embodiments are set forth in the following subsections with reference to the above-listed drawings.

### II. MULTI-IMAGER BI-OPTIC READER INCLUDING MULTIPLE FOLD MIRRORS

A. Multiple Single-Perspective Imagers

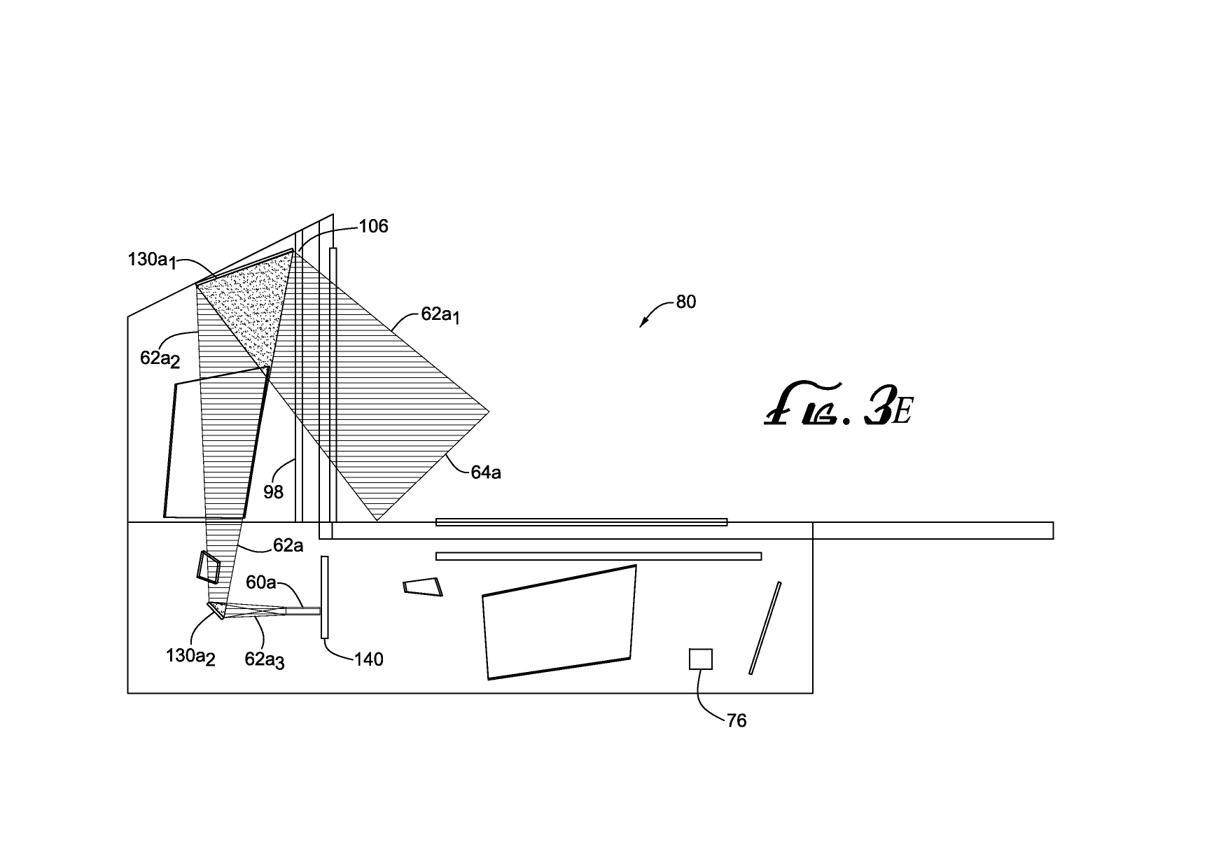

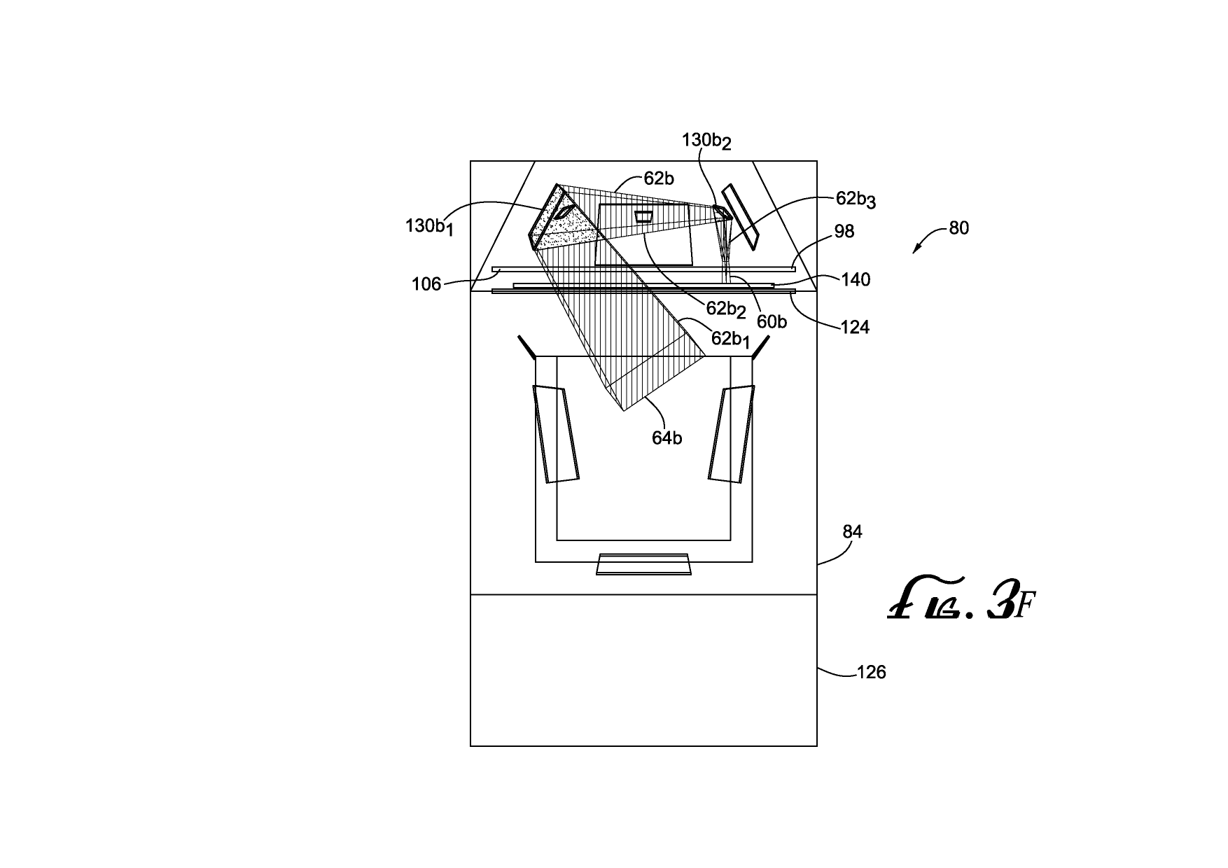

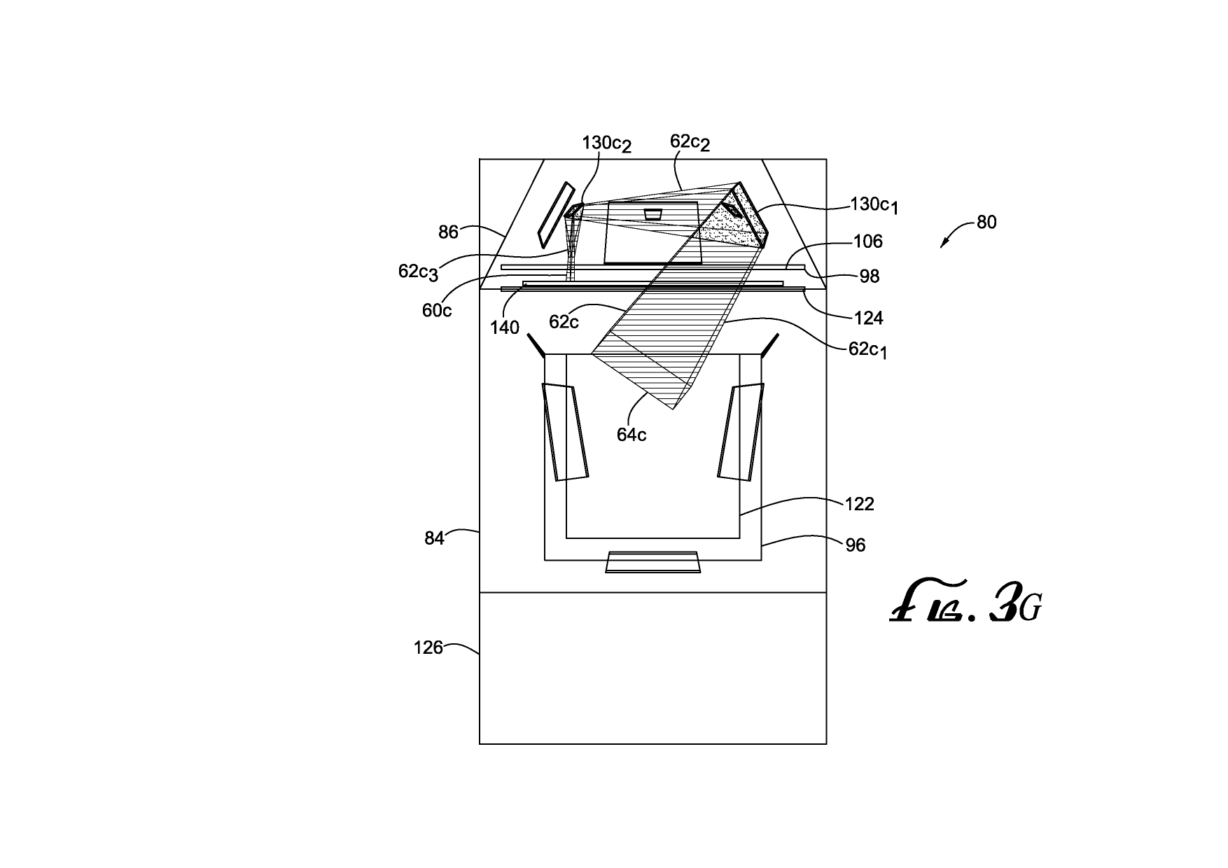

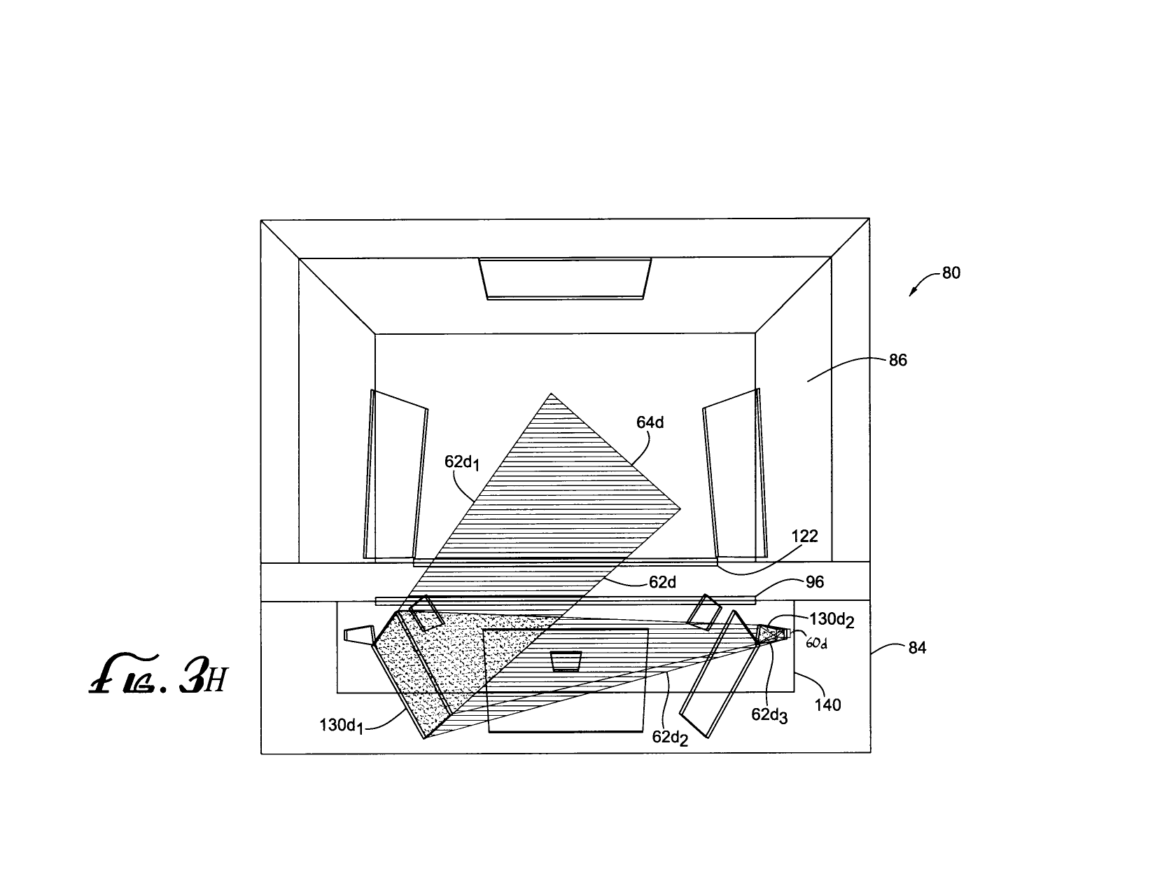

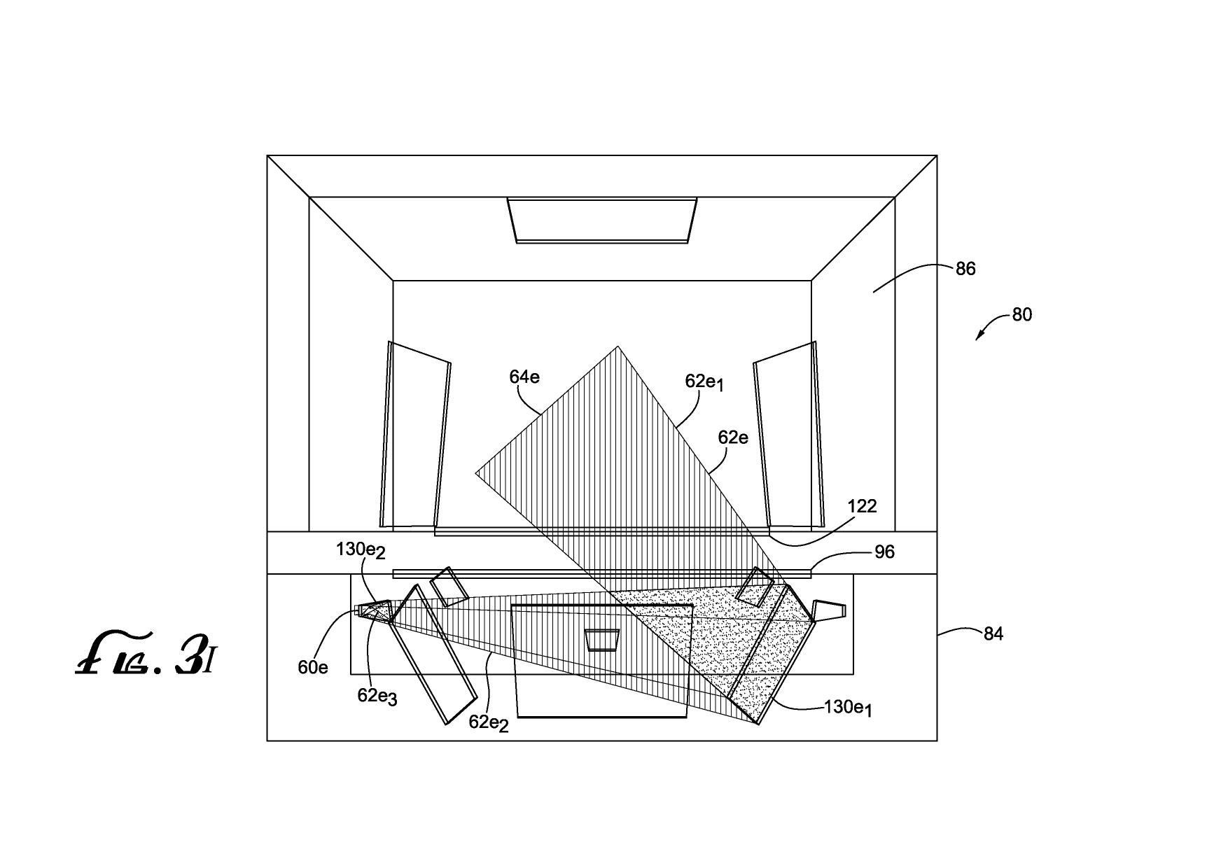

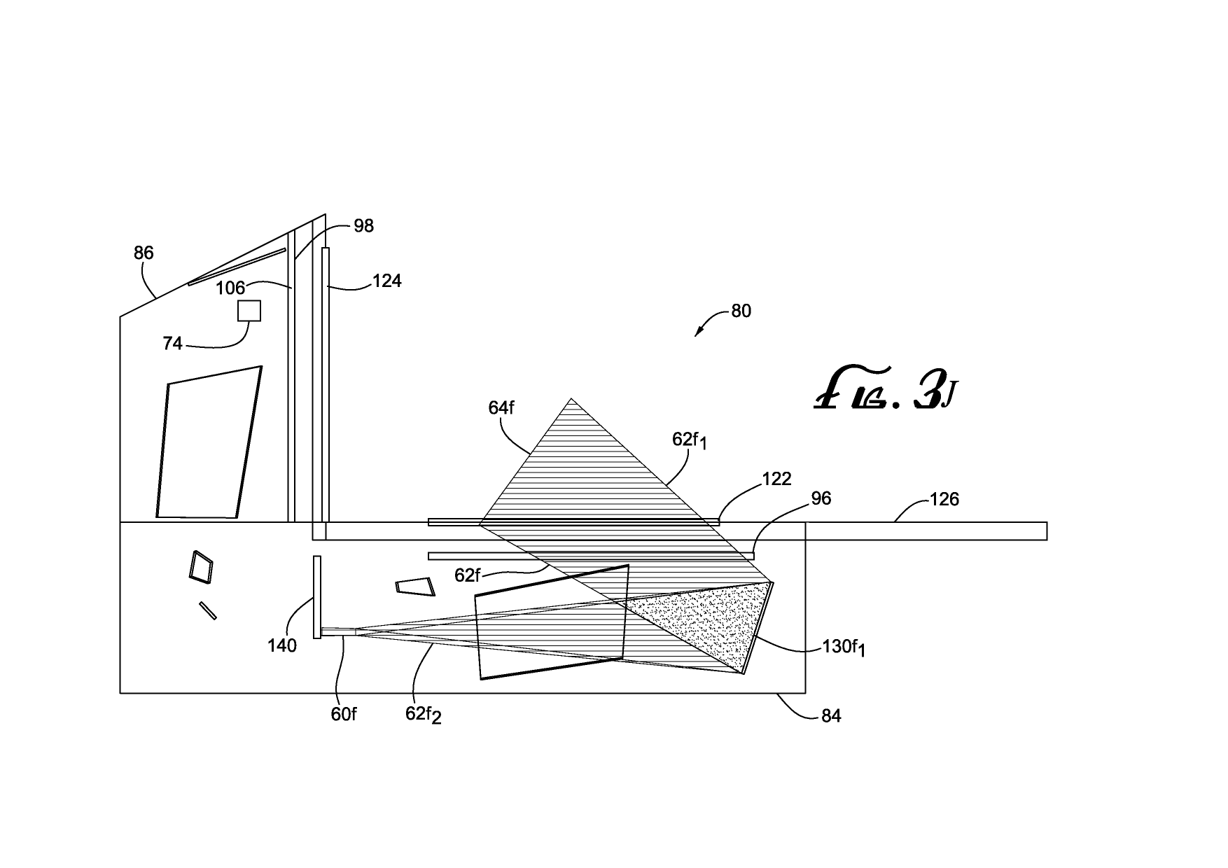

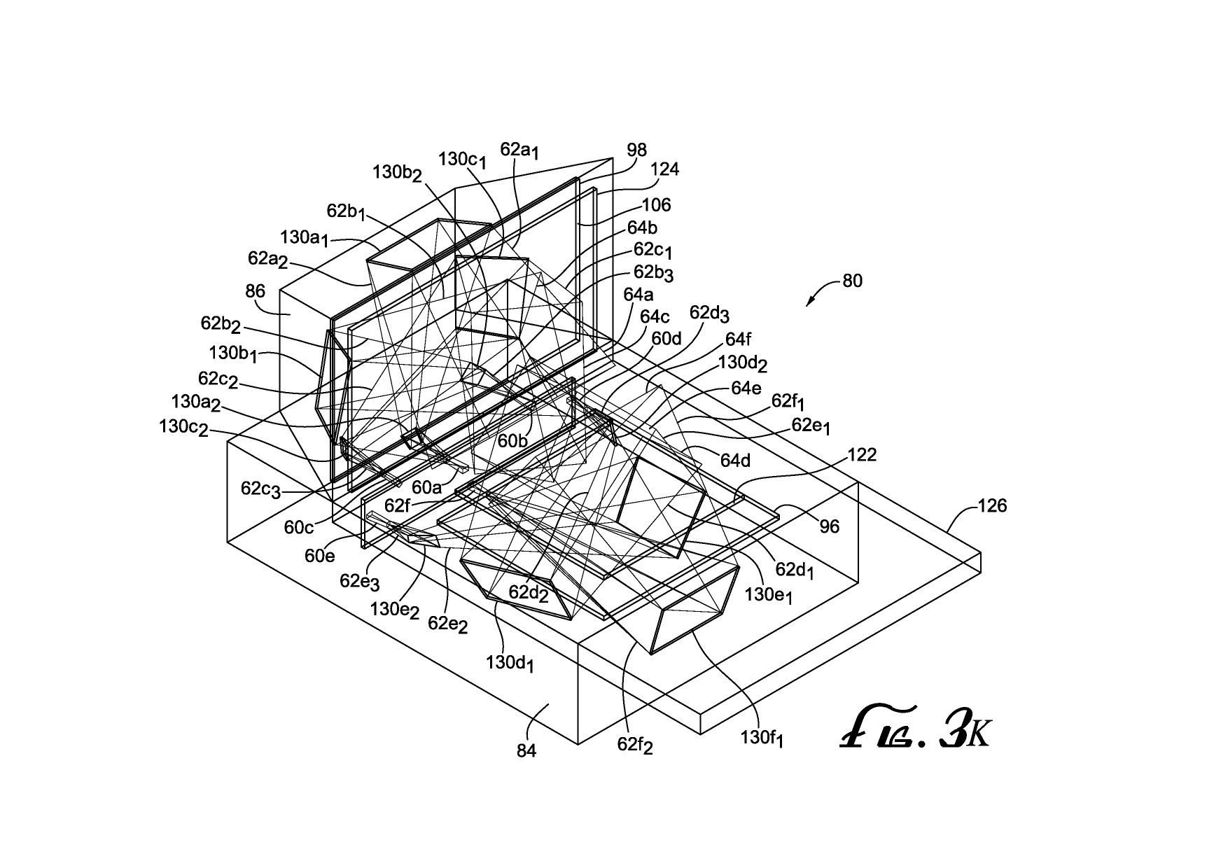

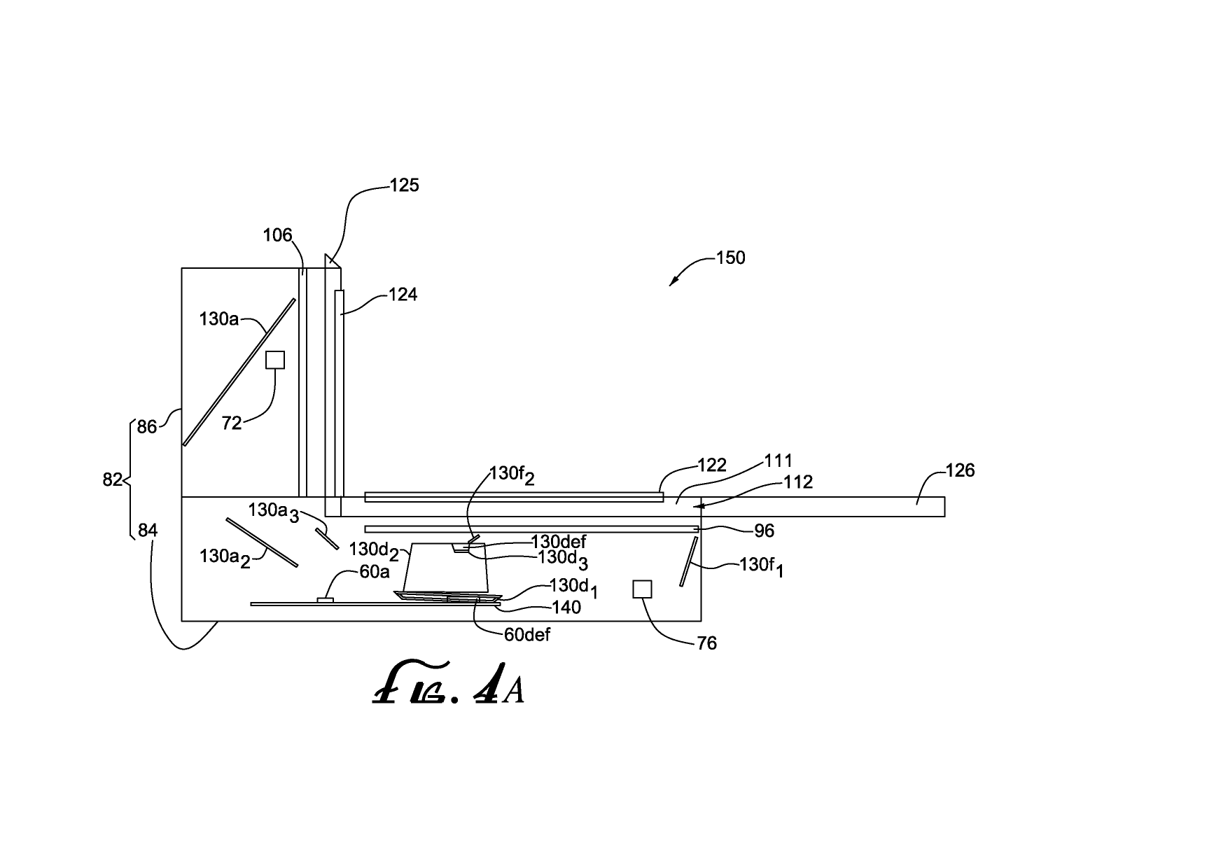

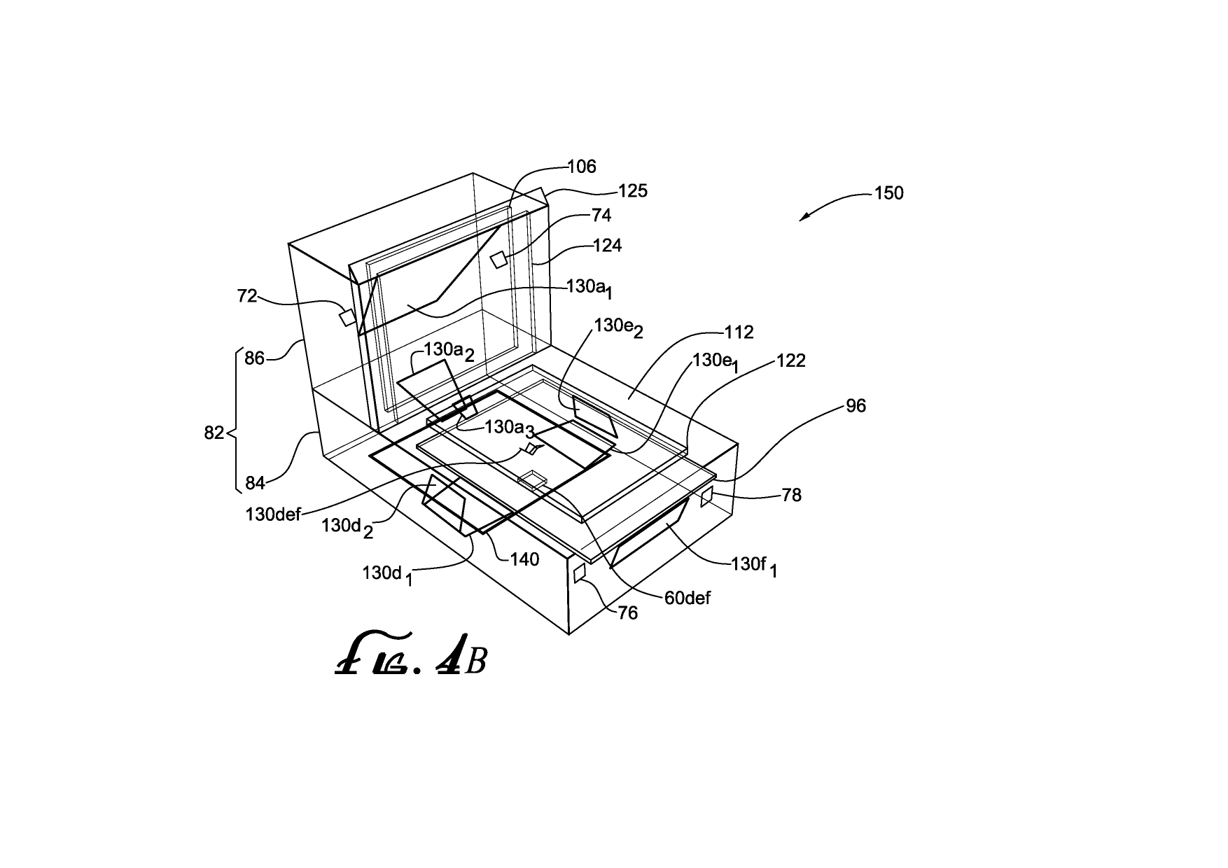

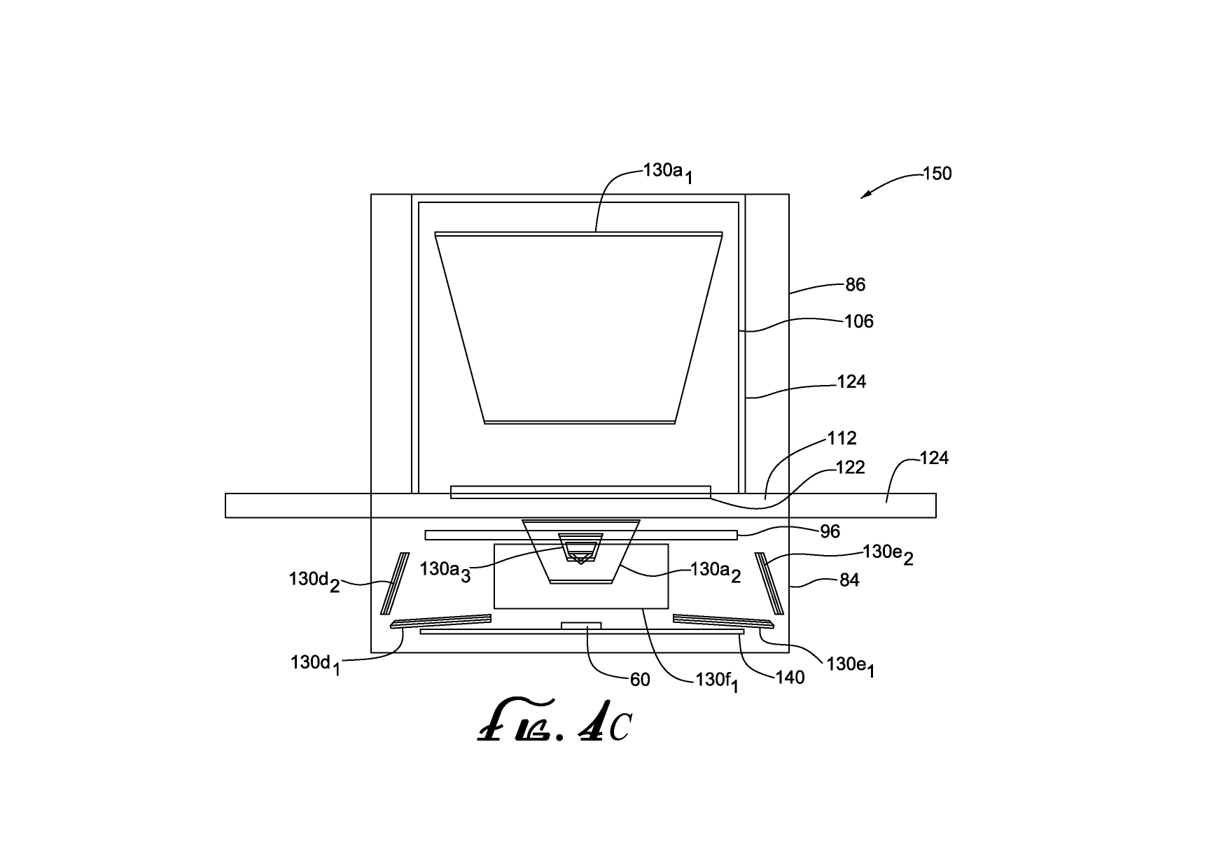

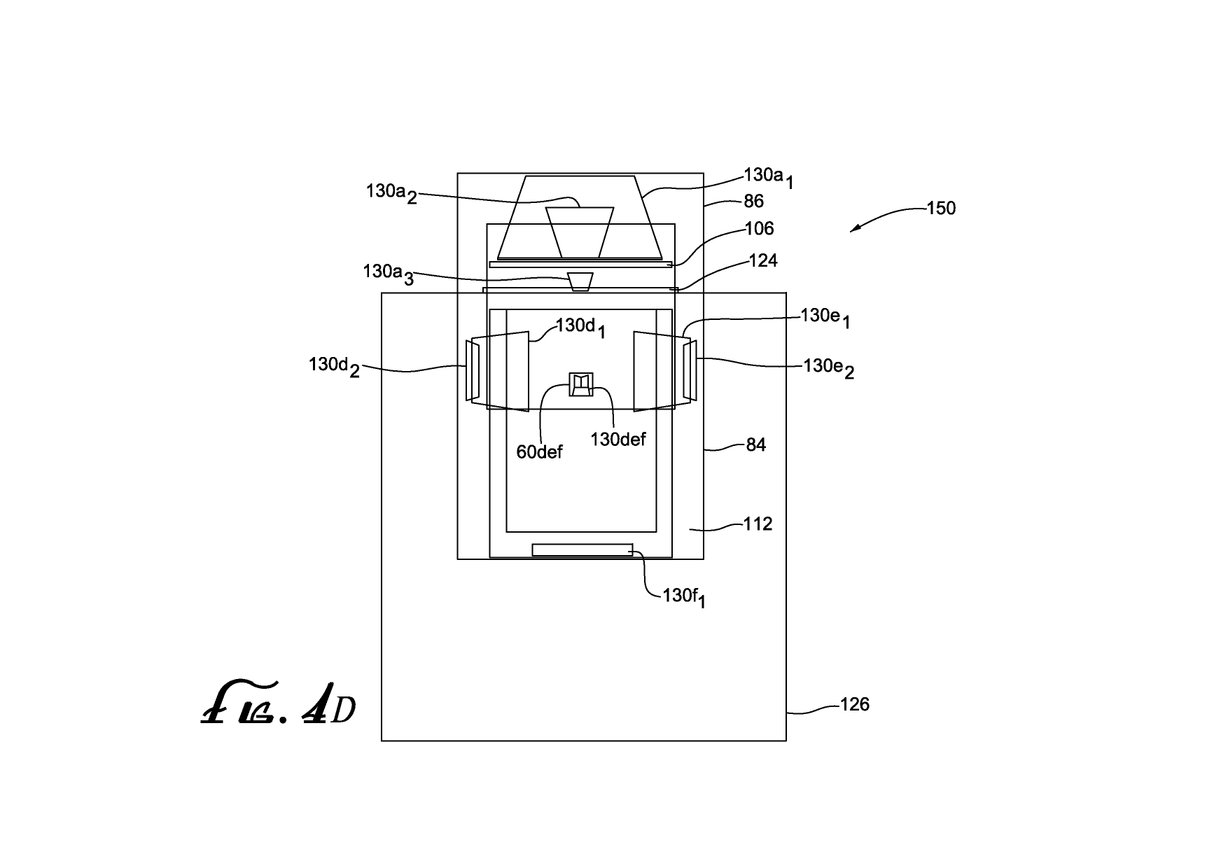

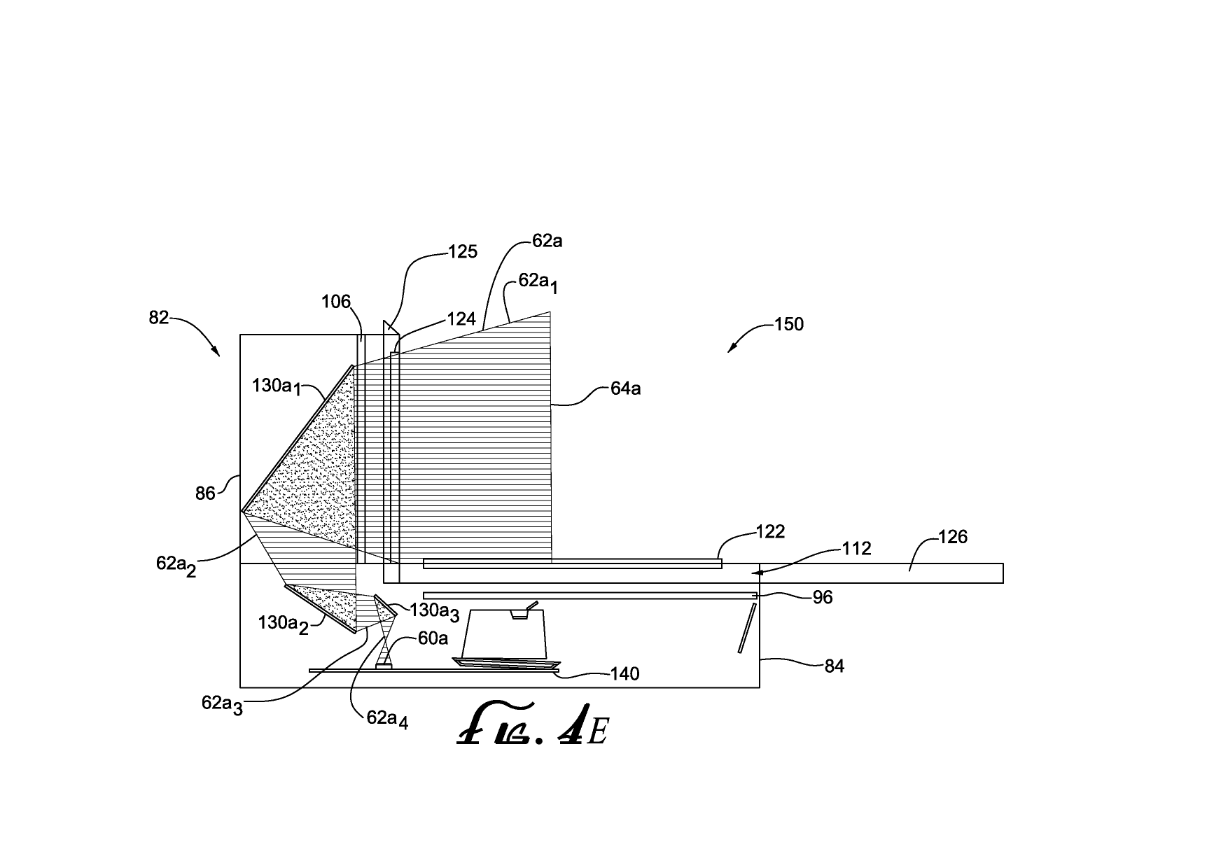

This subsection describes, by way of example, details of one type of embodiment of an imager-based optical code reader 80. FIGS. 3A-3D are respective side, isometric, front, and top views of an optical code reader 80 capable of capturing multiple views of an object 20 (not shown) from different perspectives. With reference to FIGS. 3A-3D, an embodiment of the optical code reader 80 includes a housing 82 having a lower, horizontal, or bottom housing portion 84 that transversely intersects or adjoins an upper, vertical, or side housing portion 86. The lower and upper housing portions 84 and 86 are preferably generally orthogonal, but need not be; and the housing 82 is preferably generally oriented so that the lower housing portion 84 is generally horizontal and the upper housing portion 86 is generally vertical, but they need not be so oriented.

The lower and upper housing portions 84 and 86 may be integrated as a single housing unit or may take the form of separate units that are easily attached wherein the upper housing portion 86 may be supported by the lower housing portion 84 or wherein the upper housing portion 86 is supported next to the lower housing portion 84 and generally includes the cross-sectional dimensions of the lower housing portion 84. The cross-sectional dimensions of the housing portions 84 and 86 may be generally the same or different. The overlap of the cross-sectional dimensions of the lower housing portion 84 and the upper housing portion 86 may generally define an intersecting housing volume 88.

The lower portion 84 of the housing 82 has in its top surface 92 a lower viewing window 94, which may secure or be covered by a lower transparent plate 96 through which “lower” perspectives of the object 20 (not shown in FIG. 3) can be captured. The upper portion 86 has in its front surface 98 an upper viewing window 104 that may secure or be covered by an upper transparent plate 106 through which “upper” perspectives of the object 20 can be captured. Optional lower and upper overlay platters 112 and 114 having their own respective lower and upper overlay viewing windows 116 and 118 and lower and upper overlay transparent plates 122 and 124 may be positioned to cover the top surface 92 and the front surface 98, respectively. The upper transparent plate 124 may be integrated with the upper portion 86 of the housing 82 and may be used absent a platter 114. One or both of the platters 112 and 114 may be integrated with the lower and upper portions 84 and 86 of the housing 82. The viewing windows 94, 104, 116, and 118 or corresponding transparent plates 96, 106, 122, and 124 may be the same different sizes and thus may be generally parallel or may be oriented in transverse planes. In some embodiments, one or both of the overlay viewing windows 116 and 118 are smaller than the respective housing viewing windows 94 and 104; and in other embodiments, one or both of the overlay viewing windows 116 and 118 are larger than the respective housing viewing windows 94 and 104. The lower platter 112 may include or be integrated with a scale and may have an overhanging platform 126 to accommodate large objects 20. The upper and lower platters 112 and 114 are preferably portions of a two-plane weigh scale platter such as the All-Weighs® platter available from Datalogic Scanning, Inc. of Eugene, Oreg., or the two-plane platter described in U.S. Pat. No. RE 40,071.

FIG. 3E is a side view of a first set of mirrors 130a (mirrors 130a₁ and 130a₂) reflecting a top upper perspective of a view volume 64a along an image path 62a to an imager 60a of the optical code reader 80. With reference to FIG. 3E, an image of the object 20 in the view volume 64a, captured from the upper top perspective and propagated generally upward and horizontally through the upper transparent plate 106 along an image path segment 62a₁, is reflected downward by a primary mirror 130a₁ along an image path segment 62a₂ to secondary mirror 130a₂ which reflects the image horizontally toward the checker side along an image path segment 62a₃ to the imager 60a, which may be supported on a printed circuit board (PCB) 140 located in the lower housing portion 84 of the housing 82.

FIG. 3F is a top view of a second set of mirrors 130b (mirrors 130b₁ and 130b₂) reflecting a left upper perspective of a view volume 64b along an image path 62b to an imager 60b of the optical code reader 80. With reference to FIG. 3F, an image of the object 20 (not shown) in the view volume 64b, captured from the left upper perspective and propagated through the upper transparent plate 106 along an image path segment 62b₁, is reflected rightward and downward by a primary mirror 130b₁ along an image path segment 62b₂ to secondary mirror 130b₂ which reflects the image horizontally toward the checker side along an image path segment 62b₃ to the imager 60b, which may be supported on or integrated with the PCB 140.

FIG. 3G is a top view of a third set of mirrors 130c (mirrors 130c₁ and 130c₂) reflecting a right upper perspective of a view volume 64c along an image path 62c to an imager 60c of the optical code reader 80. With reference to FIG. 3G, an image of the object 20 (not shown) in the view volume 64c, captured from the right upper perspective and propagated through the upper transparent plate 106 along an image path segment 62c₁, is reflected leftward and downward by a primary mirror 130c₁ along an image path segment 62c₂ to secondary mirror 130c₂ which reflects the image horizontally toward the checker side along an image path segment 62c₃ to the imager 60c, which may be supported on or integrated with the PCB 140.

FIG. 3H is a front view of a fourth set of mirrors 130d (mirrors 130d₁ and 130d₂) reflecting a left lower perspective of a view volume 64d along an image path 62d to an imager 60d of the optical code reader 80. With reference to FIG. 3H, an image of the object 20 (not shown) in the view volume 64d, captured from the left lower perspective and propagated through the lower transparent plate 96 generally downward and sideward along an image path segment 62d₁, is reflected sideward by a primary mirror 130d₁ along an image path segment 62d₂ to secondary mirror 130d₂ which reflects the image horizontally away from the checker side along an image path segment 62d₃ to the imager 60d, which may be supported on or integrated with the PCB 140.

FIG. 3I is a front view of a fifth set of mirrors 130e (mirrors 130e₁ and 130e₂) reflecting a right lower perspective of a view volume 64e along an image path 62e to an imager 60e of the optical code reader 80. With reference to FIG. 3I, an image of the object 20 (not shown) in the view volume 64e, captured from the right lower perspective and propagated through the lower transparent plate 96 generally downward and sideward along an image path segment 62e₁, is reflected sideward by a primary mirror 130e₁ along an image path segment 62e₂ to secondary mirror 130e₂ which reflects horizontally away from the checker side the image along an image path segment 62e₃ to the imager 60e, which may be supported on or integrated with the PCB 140.

FIG. 3J is a side view of a sixth set of mirrors 130f (mirror 130f₁) reflecting a back lower perspective of a view volume 64f along an image path 62f to an imager 60f of the optical code reader 80. With reference to FIG. 3J, an image of the object 20 (not shown) in the view volume 64f, captured from the back lower perspective and propagated through the lower transparent plate 96 generally downward and sideward along an image path segment 62f₁, is reflected by a primary mirror 130f₁ horizontally away from the checker side along an image path segment 62f₂ to the imager 60f, which may be supported on or integrated with the PCB 140.

The view volumes 64 illustrated in the preceding FIGS. 3E-3J and in subsequent figures for other embodiments are shown with a definite distal planar boundary for the sake of better illustrating the shapes, perspectives and relative positions of the view volumes 64. However, the view volumes 64 typically begin and end other than as shown, and what is illustrated as a definite distal planar boundary may, in fact, represent a focal plane. For example, in the preceding FIGS. 3E-3J, the mirrors 130 may be appropriately spaced or positioned to provide desired focal path lengths and the depth of field of their respective imagers 60. The depths of field expand outwardly from their respective focal planes located at the focal path lengths along their respective image paths. The focal planes are shown to be planar but may actually be curved, depending on the properties of the lens(es), mirrors 130 and possibly other optical components in the image paths. The depths of field may be generally optically centered around their respective focal planes. In some embodiments, the depths of field may be used to define the dimensions of the respective view volumes, which dimension may be approximately indicated by proximal range planes and distal range planes. In some embodiments, about one half of the depth of field is positioned between the focal plane and the proximal range plane, and about one half of the depth of field is positioned between the focal plane and the distal range plane. Other proximal and distal depth of field ratios are possible and may depend on the type of lens(es), the focal path length, and other optical factors. For example, it may be desirable in some circumstances that the focal plane of a view volume extending up from the lower viewing window 94 be at or near the window 94, to enable reading of an optical code on or near the lower viewing window 94, whereas it may be desirable in some circumstances that the focal plane of a view volume extending out from the upper viewing window 104 be farther away from the upper viewing window 104, where it is more likely that an optical code will be away from that window. The proximal and distal boundaries of a view volume may not be planes and typically are not sharp transitions from viewability to sudden unviewability. Typically, focus deteriorates gradually and continuously as the distance from the focal surface increases. In general, a view volume is a volume of space in which there is a high probability that an optical code can be successfully read.

Different imagers in the same reader may have different focal lengths and depths of field, and different image paths may have different lengths, different segment lengths, different numbers of mirrors, and different numbers of path segments. The use of common reference numbering patterns in the Figures should not be interpreted as implying that different elements with similar numbers necessarily have the same or similar properties.

FIG. 3K is an isometric view of mirrors 130a-f and image paths 62a-f reflecting all of the aforementioned perspectives of a cumulative view volume 64g to the respective imager 60a-f. The various perspective views in FIG. 3K or any of the following figures are labeled similarly to the perspective views 62 appearing in FIGS. 2A-2D to enhance comprehension; however, skilled persons will appreciate that the various perspective views 62 of the different embodiments need not be the same.

As can be seen in FIG. 3K and later figures for other embodiments, the component view volumes generally overlap. However, in some embodiments, component view volumes are adapted and/or positioned to avoid overlap. Dimension of overlapping view volume regions may be chosen to have dimensions, given the narrowest and/or widest optical code intended for viewing, so that stitching together portions of an optical code can be either avoided or facilitated.

With reference to FIGS. 3A-K (collectively FIG. 3), one or more lenses may be positioned within one or more of the image paths 62. The mirrors 130 preferably have planar reflecting surfaces. In some embodiments, however, one or more curved mirrors or focusing mirrors could be employed in one or more of the imaging paths 62 provided that appropriate lenses or image manipulating software is employed. In some embodiments, one or more of the mirrors 130 may be a dichroic mirror to provide for selective reflection of images under different illumination wavelengths as is later described in greater detail.

The mirrors 130 may have quadrilateral profiles, but may have profiles of other polygons. In some preferred embodiments, one or more of the mirrors 130 have trapezoidal profiles. In some alternative embodiments, one or more of the mirrors 130 may have a circular or oval profile. The mirrors 130 may have dimensions sufficient for their respective locations to propagate an image large enough to occupy an entire image field of an imager 60. The mirrors 130 are also positioned and have dimensions sufficiently small so that the mirrors do not occlude images being propagated along any of the other image paths 62.

The mirrors 130 may be appropriately spaced to account for the depth of field of the respective imagers 60. The imagers 60 may have different depths of field, and the image paths 62 may have different lengths, different segment lengths, and different numbers of mirrors 130. In some embodiments, the numbers of mirrors 130 in any image path 62 is selected to provide the fewest number of mirrors 130 in a housing of given dimensions. The image paths 62 may also or alternatively be modified to introduce additional mirrors 130 to select whether an actual image or whether a reverse image (enantiomorphic image) of the object will be received by any given imager 60. Moreover, the same enantiomorphic image of the object 20 from the different perspectives of the object 20 may reach the imagers 60, or different enantiomorphic images of the object 20 may reach the imagers 60. Exemplary imagers 60 that may be used for this embodiment include wide VGA imagers with a resolution of 752×480 pixels. One preferred VGA imager is the model MT9V022 available from Aptina Imaging of Corvallis, Oreg. or San Jose, Calif.; however, any other suitable type of imager 60 of various resolutions may be employed.

The mirrors 130 not only facilitate capture of many different perspectives of an object 20, but also help to reduce the dimensions of a housing 82 needed to house all the imagers 60. For example, the image paths 62 from the imagers into the viewing volume 64 via the sets of mirrors 130 associated with the respective perspectives permits either or both of the lower and upper housing portions 84 and 86 to have at least one housing dimension that is smaller than a direct-perspective dimension for viewing the viewing volume from the same perspective directly.

In some embodiments, the imagers 60 may all be supported by or integrated with a common PCB 140 such as shown in FIG. 3. In some embodiments, such common PCB 140 may be located in the lower housing portion 84 or the upper housing portion 86; or, in cases where the lower and upper housing portions 84 and 86 form an integrated housing unit, the common PCB 140 may be located in the intersecting portion 88 of the housing 82.

In some embodiments, the imagers 60 may be located on opposing sides of the common PCB 140. In some embodiments, the same number of imagers 60 is located on each opposing side of the PCB 140; however, other embodiments may employ different numbers of imagers 60 on the opposing sides of the PCB 140. In other embodiments, the imagers 60 may all be located on the same side of the PCB 140. In some embodiments, the common PCB 140 is a flexible circuit board with portions that can be selectively angled to orient some or all of the imagers 60 to facilitate arrangements of image paths 62 utilizing noncollinear axes for the image fields of the imagers 60.

The imagers 60 may be arranged in close proximity or in the same housing portion regardless of whether they are supported by a common PCB 140 to facilitate mounting and wiring in a manner that avoids occlusion of image paths 62. In some embodiments, multiple imagers 60 may be within an inch of each other. In some embodiments, the imagers 60 may be within about 1/10 of an inch apart. In some embodiments, the imagers 60 may be supported on separate PCBs 140 or may be grouped onto 2-6 PCBs 140 in any combination. The 2-6 PCBs 140 may be located in the same housing portion or in placed in different housing portions in any suitable combination. For example, the upper perspective imagers 60 may be supported on one PCB 140 located in the upper housing portion 86 and the lower perspective imagers 60 may be supported on a second PCB 140 located in the lower housing portion 84, and, in some embodiments, these two PCBs 140 may be located in the opposite housing portions.

Multiple sets of mirrors 130 could be used to construct a monoptic (single window) optical code reader capable of viewing multiple perspectives through a single viewing window 94 or 104. Furthermore, the optical code reader 80 need not have six views or perspectives of an object 20 passing through the view volume. Additional views and corresponding imagers 60 could be added. Alternatively, fewer views could be captured and the number of imagers 60 could be decreased to reduce costs.

B1. Single Horizontal Imager Split into Three Perspectives and Separate Unsplit Vertical Imager

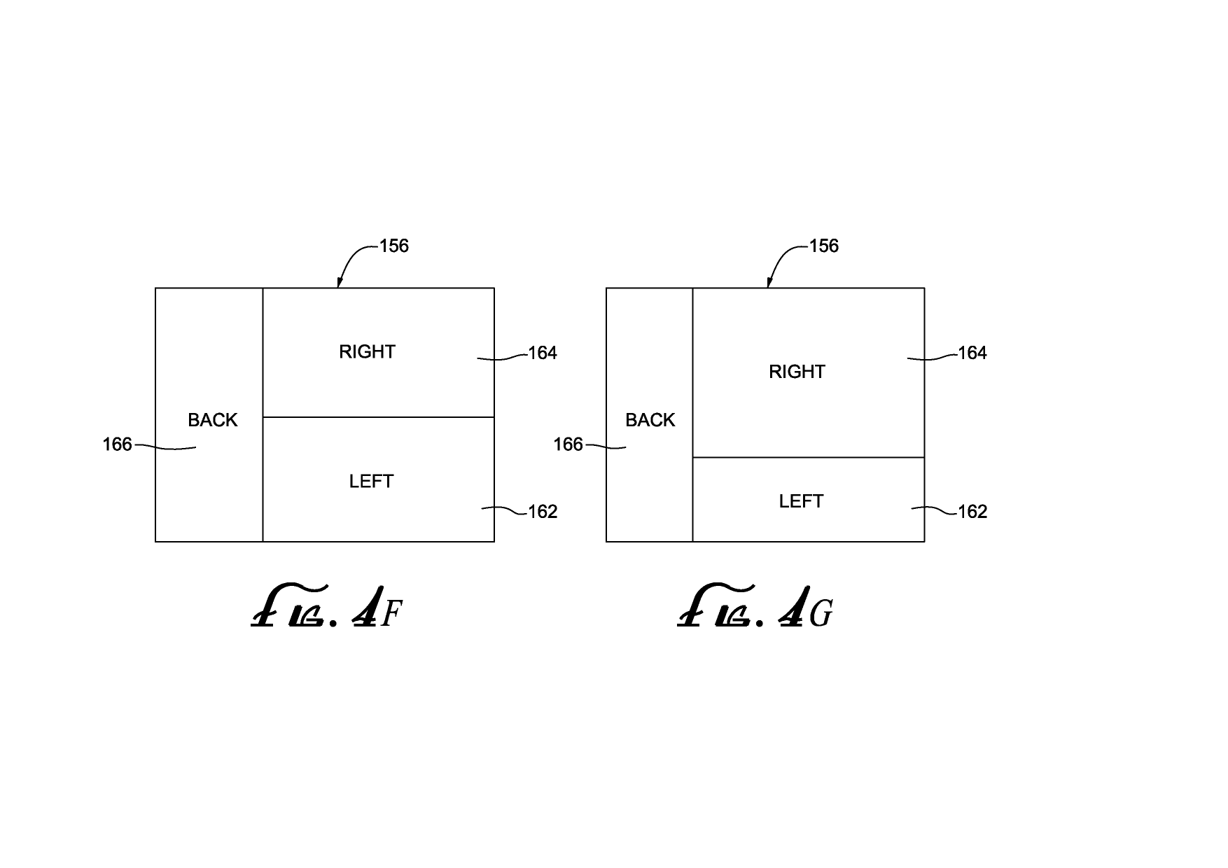

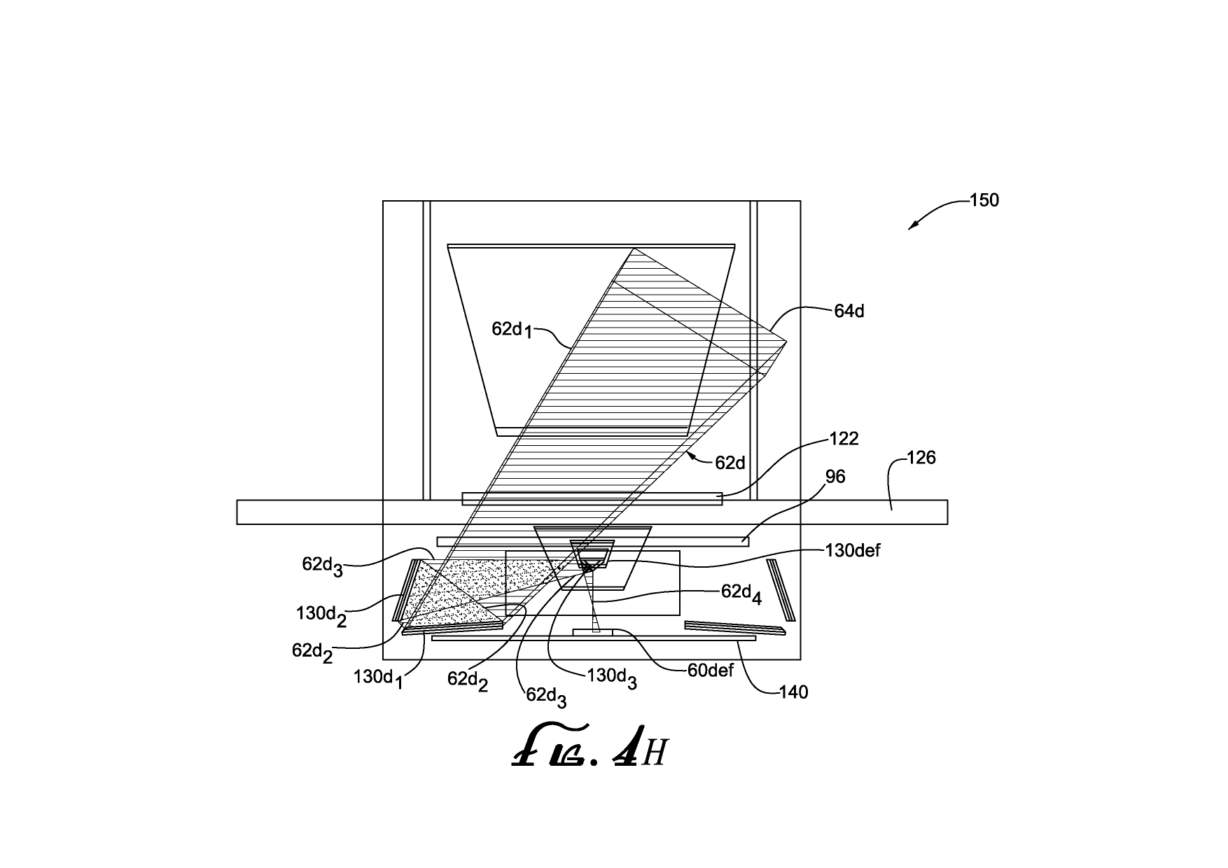

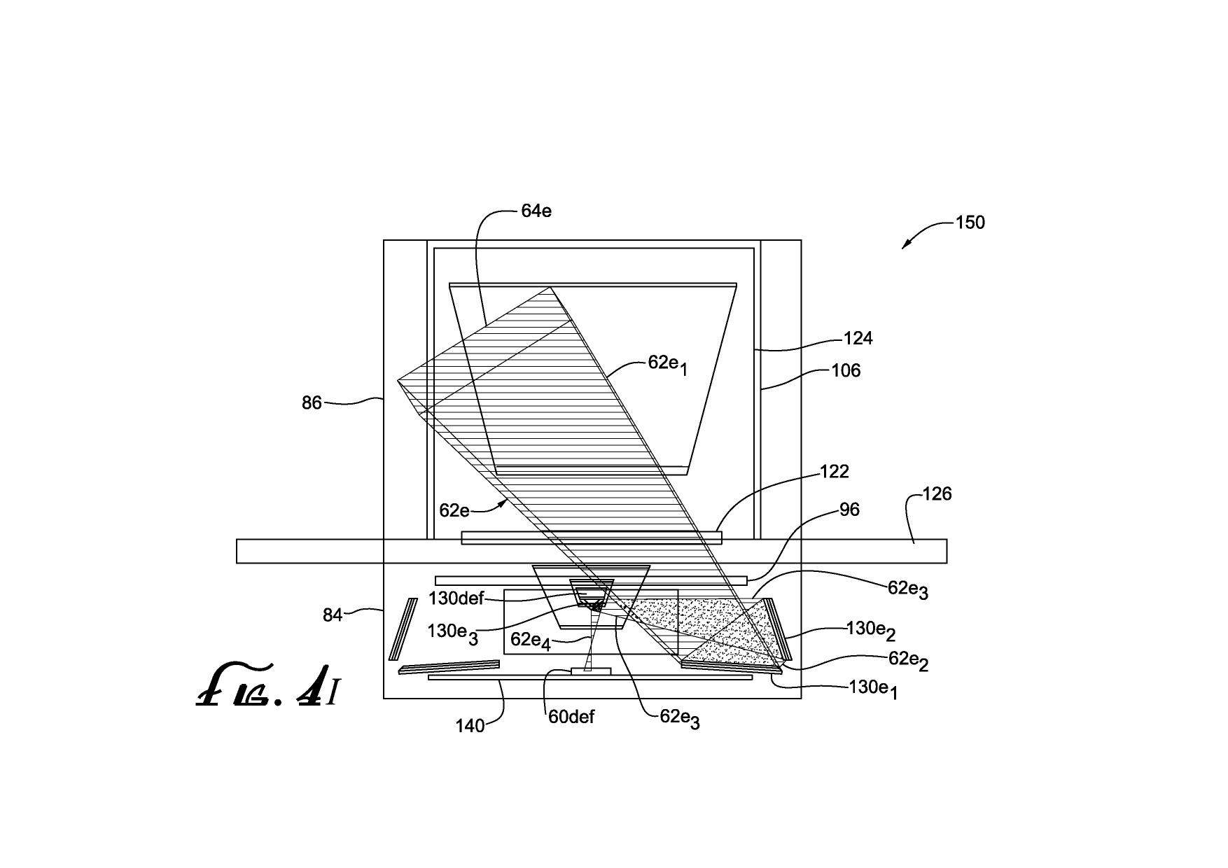

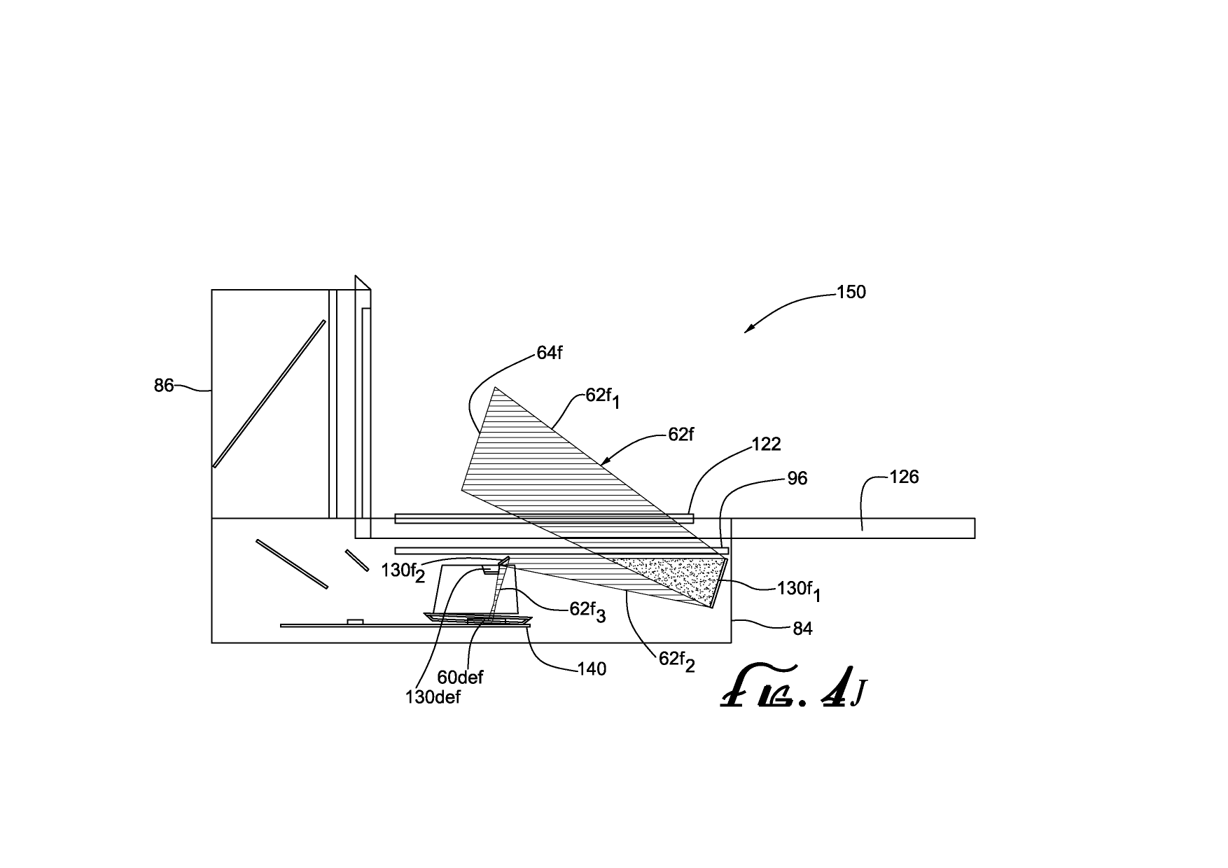

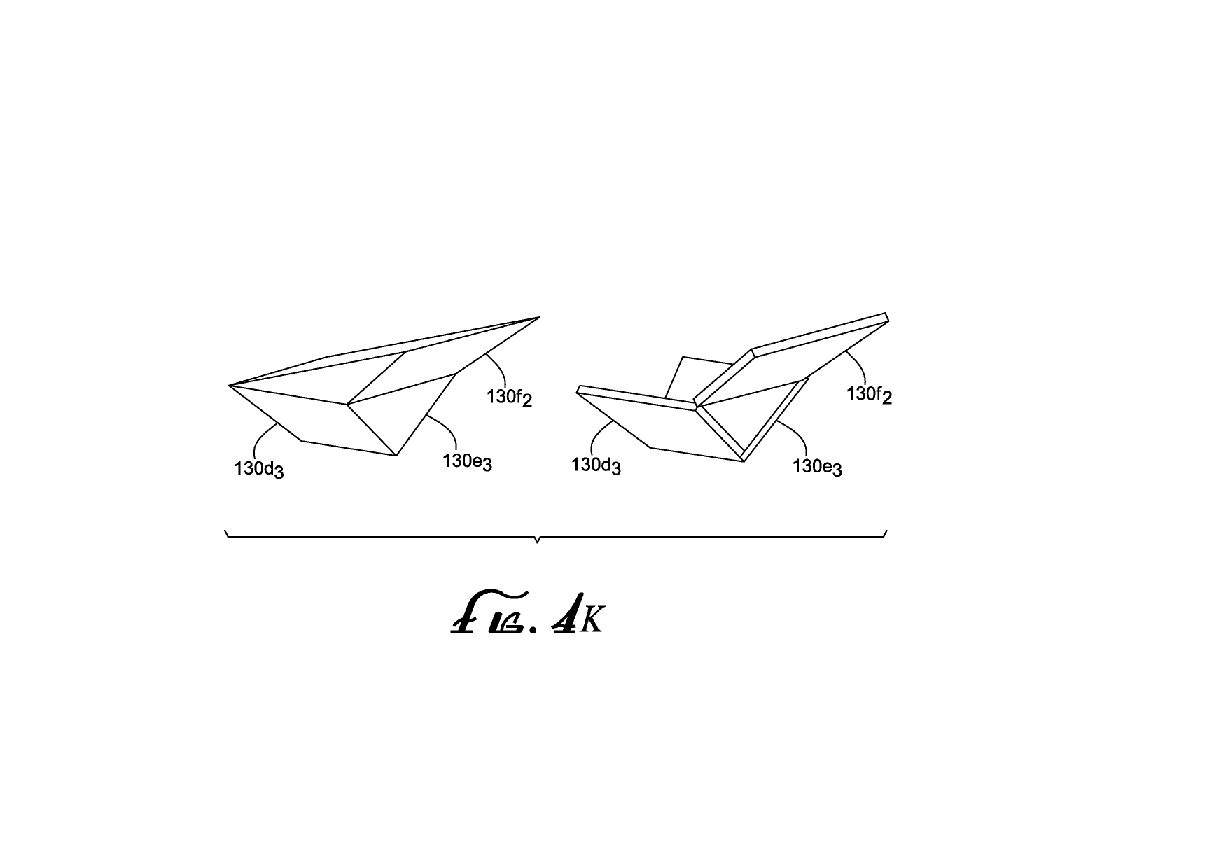

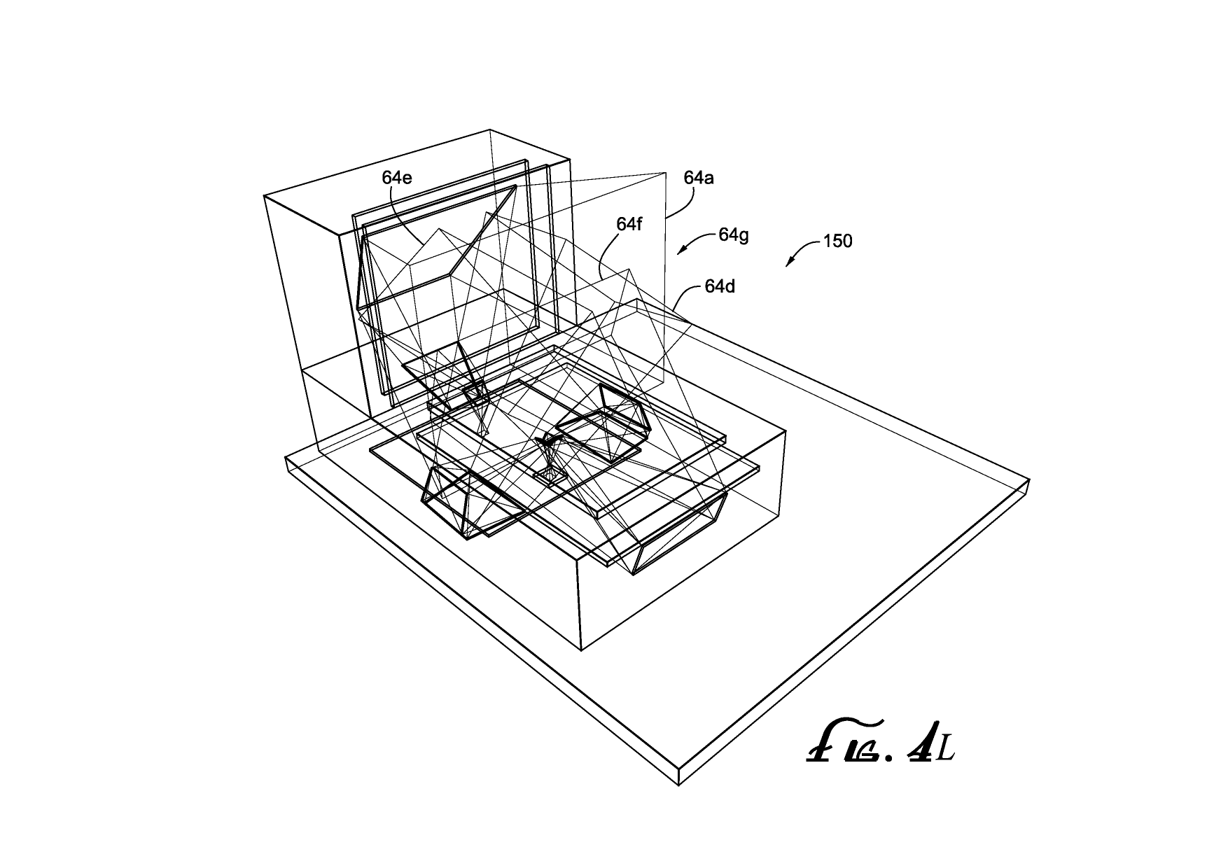

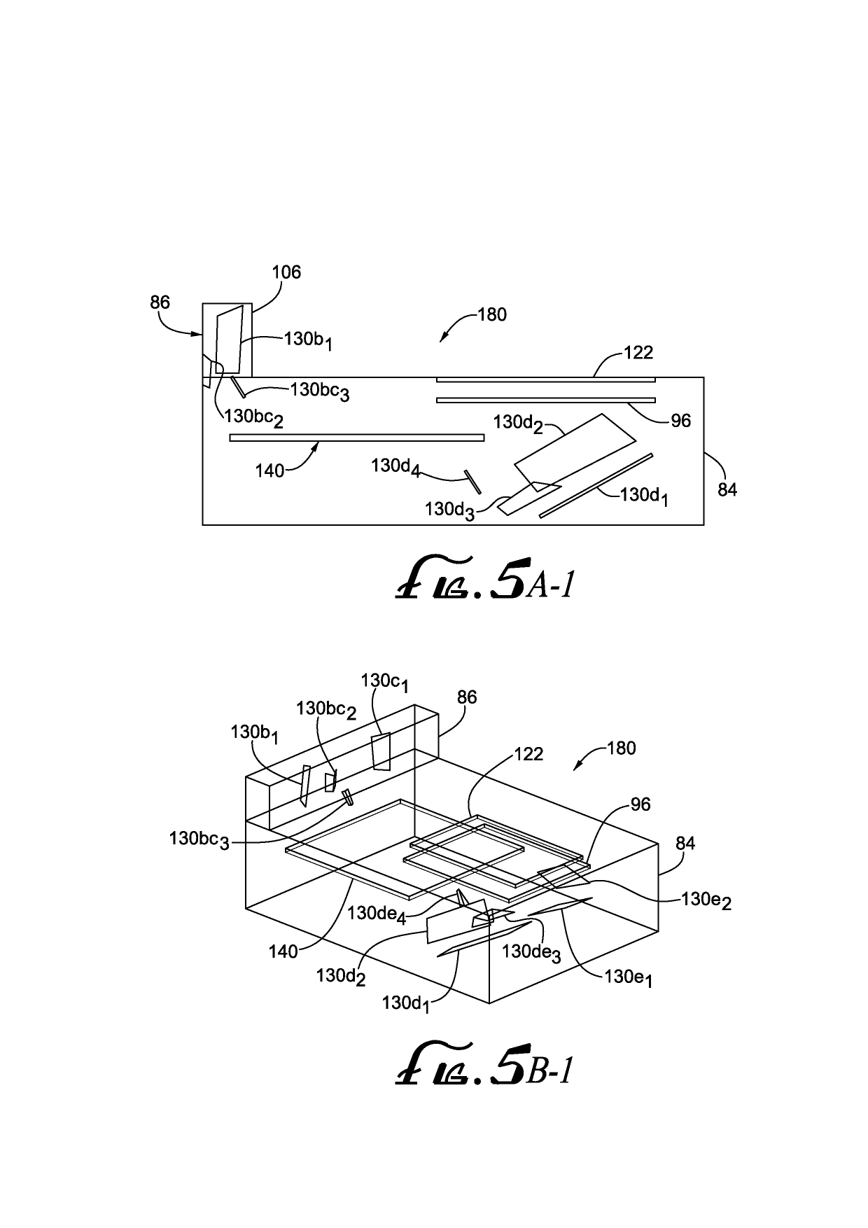

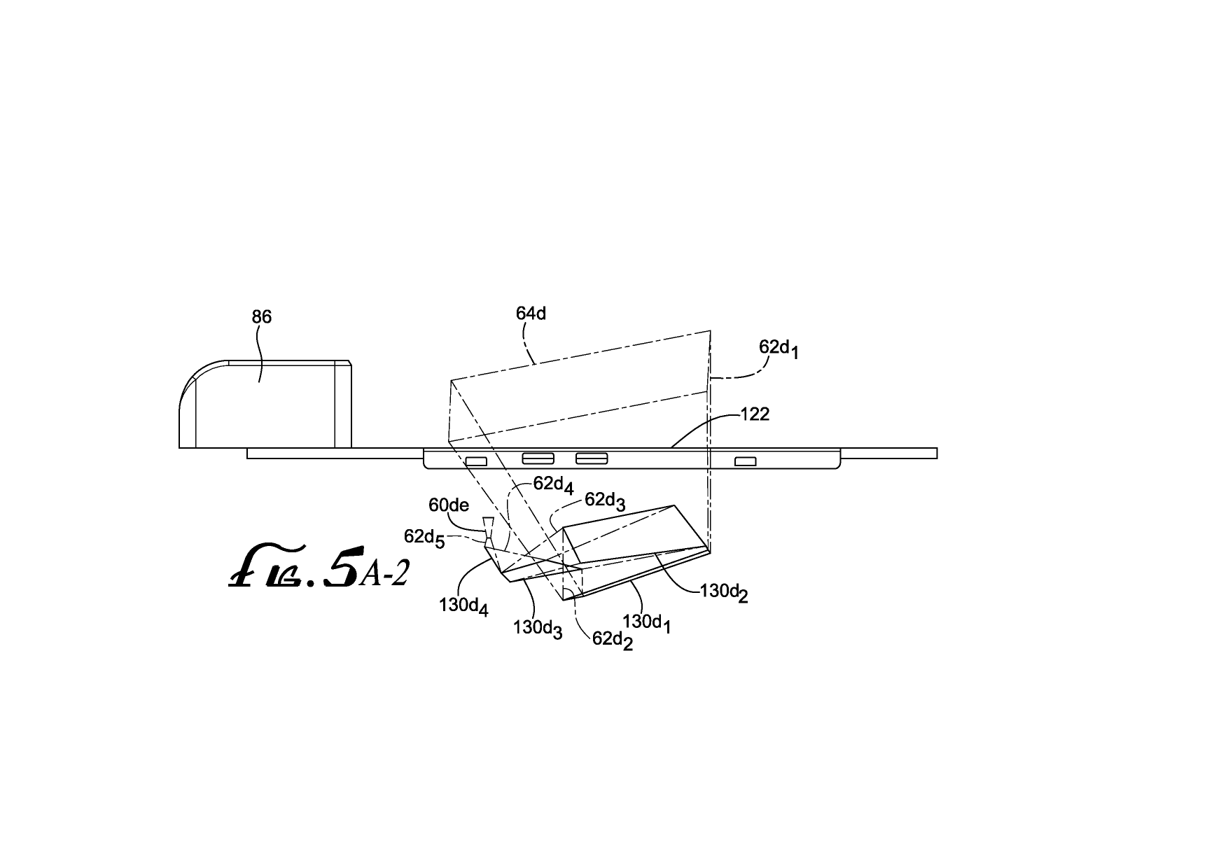

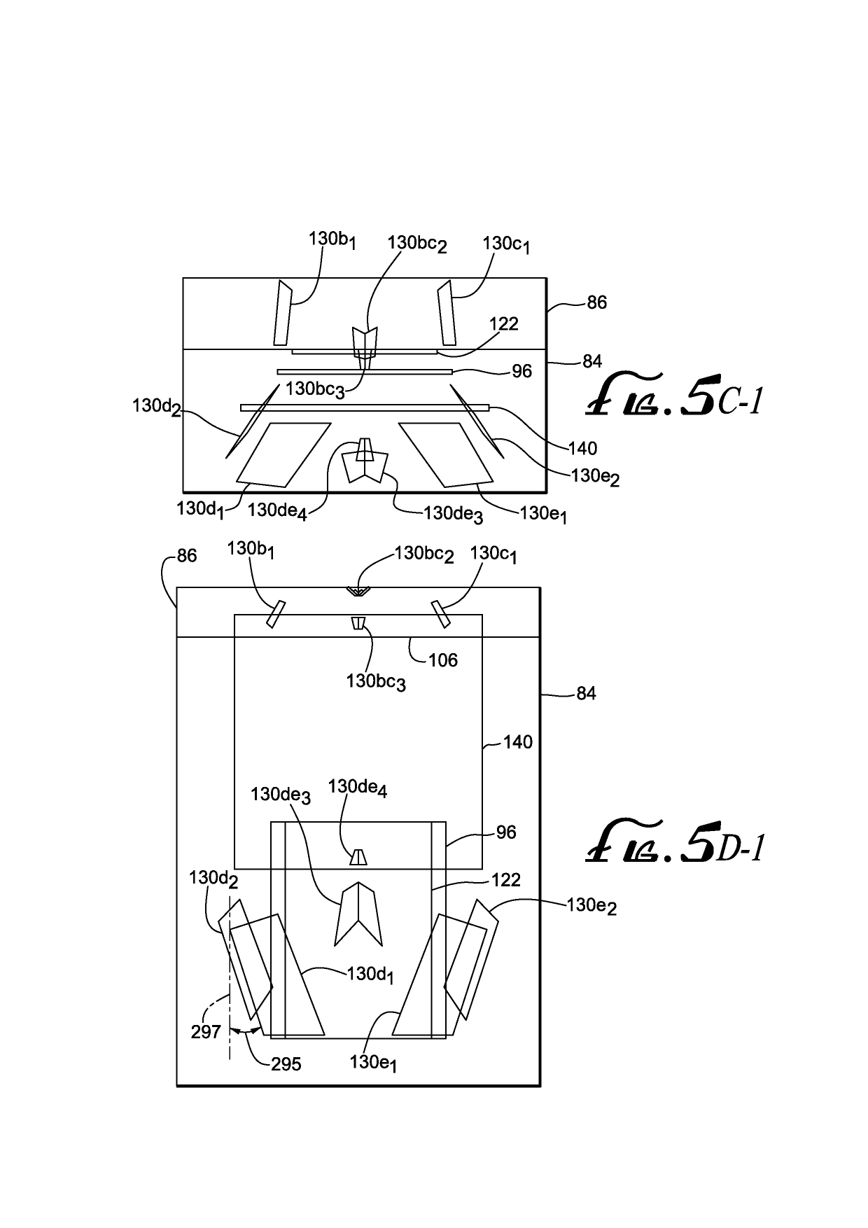

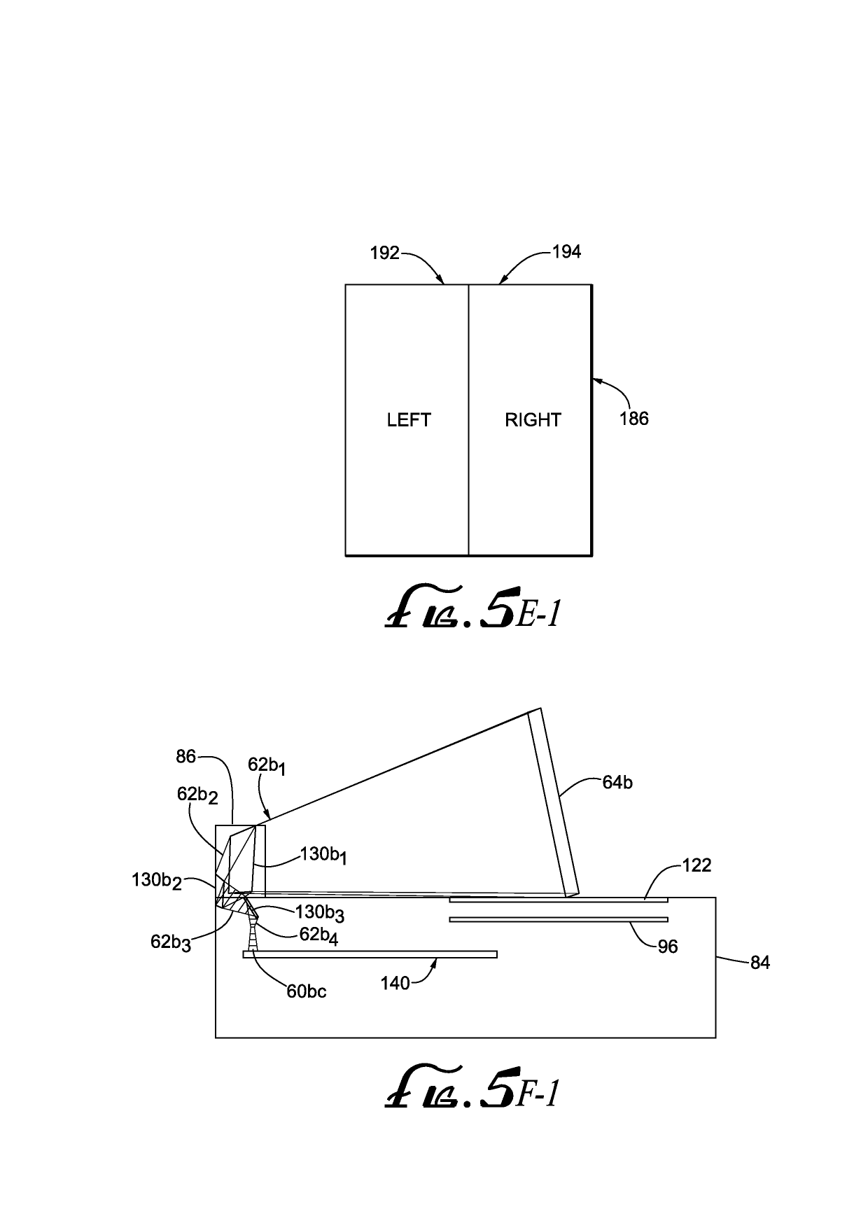

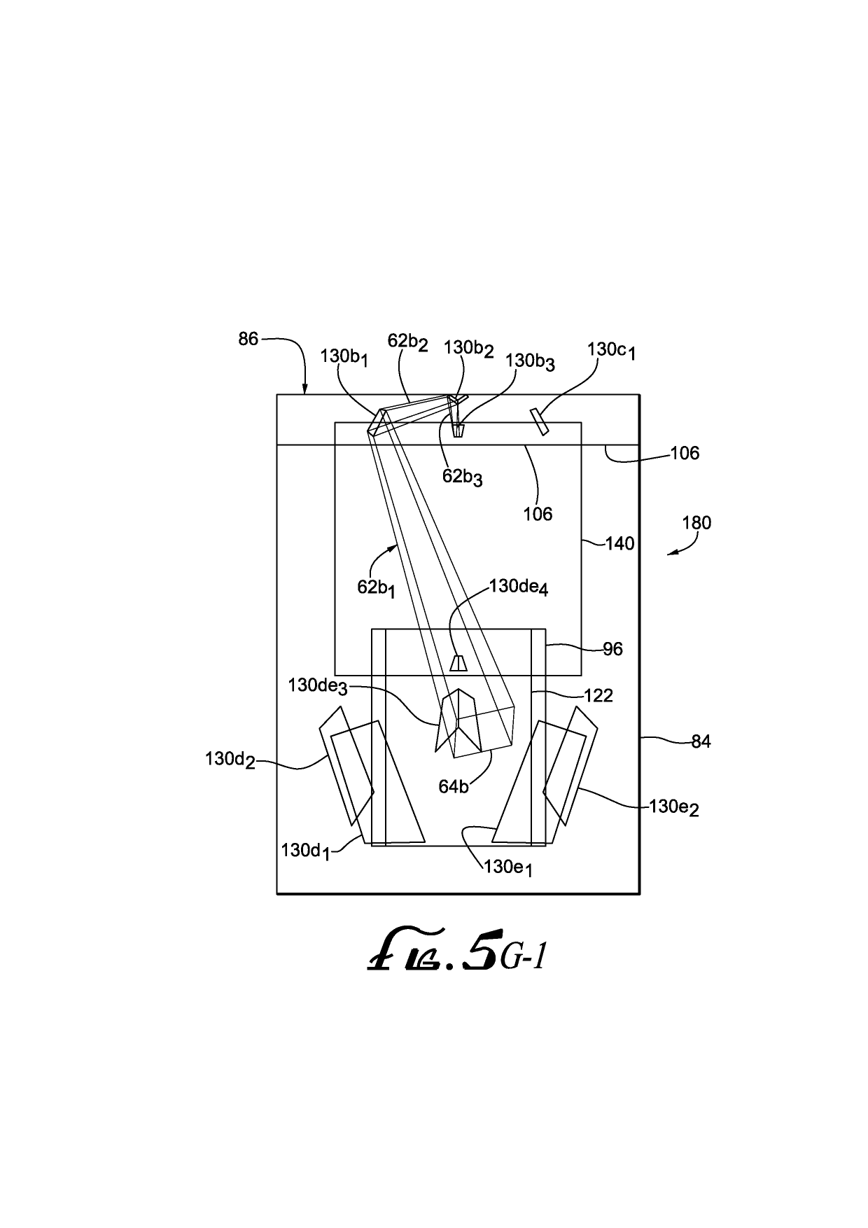

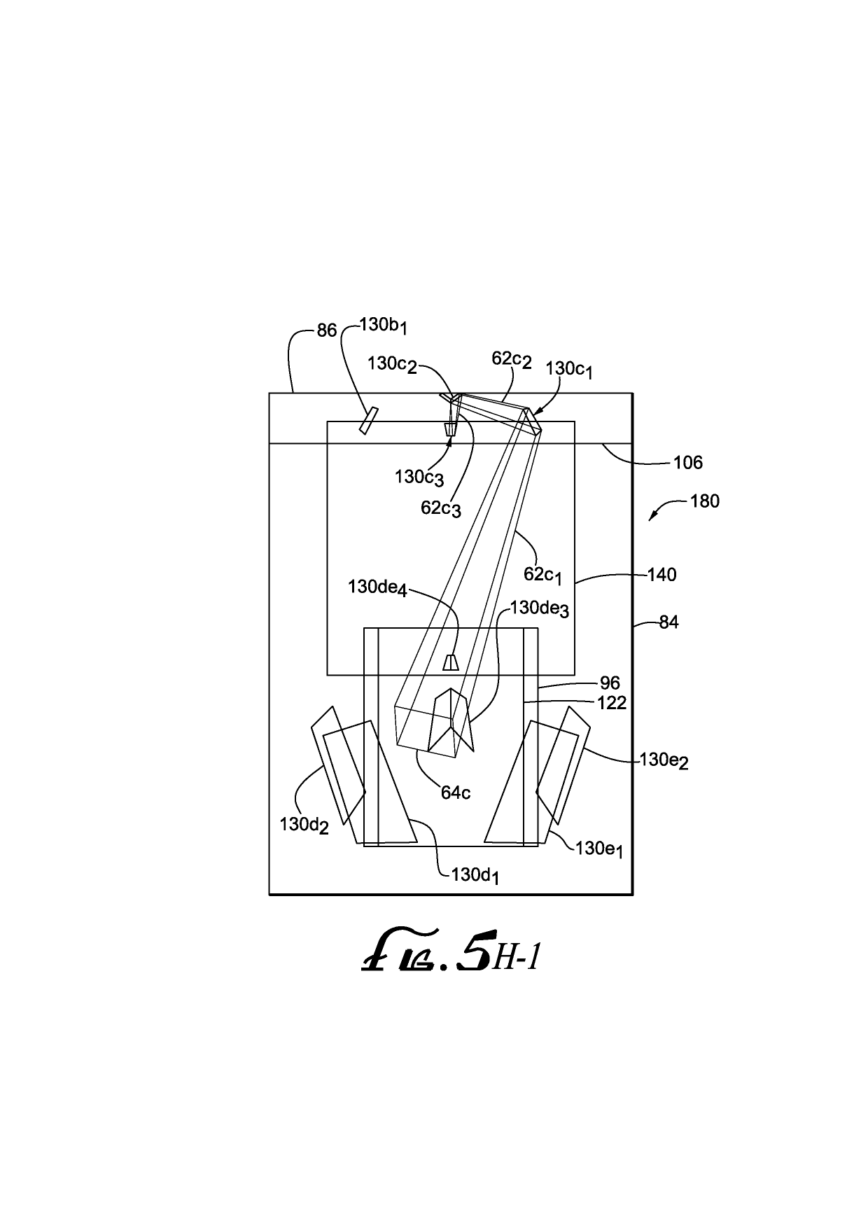

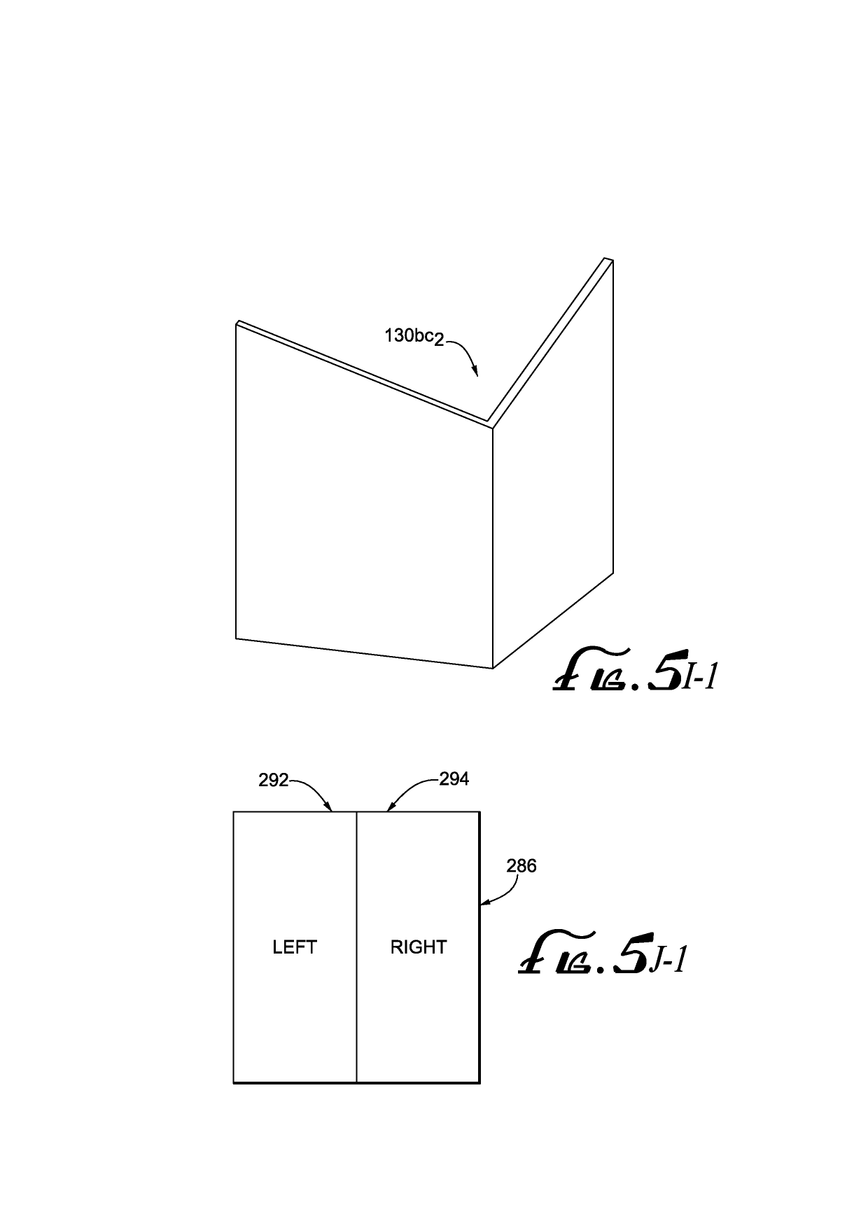

This subsection describes, by way of example, details of one type of embodiment of an imager-based optical code reader 150. FIGS. 4A-4D are respective side, isometric, front, and top views of an optical code reader 150 capable of capturing multiple views of an object 20 (not shown) from different perspectives. For convenience, the optical code reader 150 will be described to a large extent using similar reference numerals to those used to describe FIG. 3 even though the dimensions of the housing 82, viewing windows, and/or transparent plates may be different; the perspectives, orientations, and/or sizes of the mirrors 130 may be different; the image paths 62 may have different angles; and/or the positioning, orientation, and/or dimensions of other components may be different. For example, the upper housing portion 86 of optical code reader 150 may have a rectangular profile from a top view while the embodiment shown in FIG. 3 may have a trapezoidal profile from the top view.

With reference to FIGS. 4A-4D, the optical code reader 150 includes two imagers 60a and 60def that capture one view and three views respectively. FIG. 4E is a side view of a first set of mirrors 130a (mirrors 130a₁, 130a₂ and 130a₃) reflecting an upper perspective of the view volume 64a along the image path 62a to the imager 60a of the optical code reader 150, showing the image path 62a and the view volume 64a with shading lines. With reference to FIG. 4E, an image of the object 20 (not shown in FIG. 4E) in the view volume 64a, captured from the upper perspective and propagated horizontally through the upper transparent plate 106 along the image path segment 62a₁, is reflected downward by the primary mirror 130a₁ along the image path segment 62a₂ to the secondary mirror 130a₂ which reflects the image horizontally toward the checker side along the image path segment 62a₃ to a tertiary mirror 130a₃ which reflects the image downward along an image path segment 62a₃ to the imager 60a, which may be supported on the PCB 140 located in the lower housing portion 84 of the housing 82.

The perspective associated with the image path 62a in FIG. 4E may be oriented to view downwardly in similar fashion to the perspective associated with the image path 62a in FIGS. 3A-3K, or the perspective associated with the image path 62a may be oriented to view more horizontally, such as depicted in FIG. 4E.

FIG. 4F is a map of an image field 156 of a split-view or multi-region imager 60def divided into three regions to capture separate views, and FIG. 4G shows an alternative division of the image field 156 into three alternative regions to capture the separate views, to demonstrate that the left and right views need not be symmetrical. In general, the sizes of the different regions can be set by the designer subject to constraints such as possible mirror placement and form factors for the reader 150.

FIG. 4H is a front view of a second set of mirrors 130d (mirrors 130d₁, 130d₂ and 130d₃) reflecting a left lower perspective of a view volume 64d along an image path 62d to an imager 60d of the optical code reader 150. With reference to FIG. 4H, an image of the object 20 in the view volume 64d, captured from the left lower perspective and propagated through the lower transparent plate 96 along the image path segment 62d₁, is reflected upward and outward away from the center of the reader 150 by the primary mirror 130d₁ along the image path segment 62d₂ to the secondary mirror 130d₂ which reflects the image sideward toward the center of the reader 150 along the image path segment 62d₃ to a tertiary mirror 130d₃ on a split mirror 130def which reflects the image downward along an image path segment 62d₃ to the imager 60def that may be supported on the PCB 140 located in the lower housing portion 84 of the housing 82. The image path segments 62d₁, 62d₂ and 62d₃ overlap spatially in a volume between the mirrors 130d₁ and 130d₂. The perspective associated with the image path 62d in FIG. 4 may be oriented similarly to or differently from the perspective associated with the image path 62d in FIG. 3.

The mirrors 130d₁ and 130d₂ may be separated as shown, or they may be abutting, or they may be integrated into a single split mirror or other monolithic mirror structure, with or without nonreflective regions in proximity to their intersection. The mirrors 130d₁ and 130d₂ lie in respective planes that intersect one another at an acute angle.

FIG. 4I is a front view of a third set of mirrors 130e (mirrors 130e₁, 130e₂ and 130e₃) reflecting a right lower perspective of the view volume 64e along the image path 62e to the imager 60def of the optical code reader 150. With reference to FIG. 4I, an image of the object 20 in the view volume 64e, captured from the right lower perspective and propagated through the lower transparent plate 96 along the image path segment 62e₁, is reflected upward and outward away from the center of the reader 150 by the primary mirror 130e₁ along the image path segment 62e₂ to the secondary mirror 130e₂ which reflects the image sideward toward the center of the reader 150 along the image path segment 62e₃ to a tertiary mirror 130e₃ on the split mirror 130def which reflects the image downward along an image path segment 62e₃ to the imager 60def, which may be supported on the PCB 140. The image path segments 62e₁, 62e₂ and 62e₃ overlap spatially in a volume between the mirrors 130e₁ and 130e₂.

The mirrors 130e₁ and 130e₂ may be separated as shown, or they may be abutting, or they may be integrated into a single split mirror or other monolithic mirror structure, with or without nonreflective regions in proximity to their intersection.

The perspective associated with the image path 62e in FIG. 4 may be oriented similarly to or differently from the perspective associated with the image path 62e in FIG. 3. In addition, the image path 62e may be arranged so that it is bilaterally symmetrical with the image path 62d. However, in some embodiments, the image path 62e may be arranged to be asymmetrical with the image path 62d.

FIG. 4J is a side view of a fourth set of mirrors 130f (mirrors 130f₁ and 130f₂) reflecting a back lower perspective of a view volume 64f along an image path 62f to an imager 60def of the optical code reader 150. With reference to FIG. 4J, an image of the object 20 in the view volume 64f, captured from the back lower perspective and propagated generally downward and horizontally through the lower transparent plate 96 along an image path segment 62f₁, is reflected generally horizontally away from the checker side by a primary mirror 130f₁ along an image path segment 62f₂ to a secondary mirror 130f₂, which reflects the image generally downward along an image path segment 62f₃ to the imager 60def. The perspective associated with the image path 62f in FIG. 4 may be oriented similarly to or differently from the perspective associated with the image path 62f in FIG. 3.

FIG. 4K is an isometric view of different embodiments of the mirror 130def used with the horizontal imager in the optical code reader of FIGS. 4A-4D. The mirror 130def is preferably an integrated, monolithic, or single-piece split mirror or compound mirror that includes mirror components 130d₃, 130e₃, and 130f₂ of the respective image paths 62d, 62e, and 62f. The mirror components 130d₃, 130e₃, and 130f₂ of the split mirror 130def may be arranged at different angles with respect to the horizontal or vertical planes (and with respect to each other) to accommodate the orientations of the different image paths 62d, 62e, and 62f. The mirror components 130d₃, 130e₃, and 130f₂ may employ any of the variations used for any of the mirrors 130 as previously described. The mirror 130def may be formed by molding, bending, and/or welding a single monolithic piece or substrate, such as a metal or plastic, and then applying reflective coatings. Any desired nonreflective regions could be covered in advance by masking or subsequently covered by a nonreflective coating. Alternatively, the mirror 130def may be assembled from separate mirrored components. In some embodiments, the mirror components 130d₃, 130e₃, and 130f₂ may have nonreflective regions in proximity to their intersections. In some embodiments, some image processing advantages may be gained by not capturing images reflected from near the intersection of the mirror components 130d₃, 130e₃, and 130f₂ of the split mirror 130def. In some alternative embodiments, the mirror components 130d₃, 130e₃, and 130f₂ may be separated into two or three separate mirrors. In some embodiments, the mirror components 130d₃, 130e₃, and 130f₂ direct the respective image paths 62 to separate imagers 60 that may be closely spaced.

With reference to FIG. 4F or 4G, the image field 156 of the imager 60def may be split into three image field regions, such as a left region 162, a right region 164, and a back region 166, that may be adapted to capture images from the corresponding left lower perspective, right lower perspective, and back lower perspective, respectively. Thus, the mirror component 130d₃ reflects the image along the image path 62d₄ onto the left region 162 of the image field 156 of the imager 130def; the mirror component 130e₃ reflects the image along the image path 62e₄ onto the right region 164 of the image field 156 of the imager 130def; and the mirror component 130f₂ reflects the image along the image path 62f₃ onto the back region 166 of the image field 156 of the imager 130def. Exemplary imagers 60 that may be used for this embodiment include wide VGA imagers (CMOS or CCD) with a resolution of 752×480 pixels for the imager 60a and megapixel imagers with a resolution of 1280×1024 pixels for the imager 60def. One preferred megapixel imager is the model EV76C560 1.3 MP CMOS image sensor available from e2V of Essex, England and Saint-Egrève, France. One preferred VGA imager is the model MT9V022 available from Aptina Imaging of Corvallis, Oreg. or San Jose, Calif. These imagers may be applicable to the data reader of any of the embodiments herein, however, any other suitable type of imager 60 of various resolutions may be employed.

The image field 156 need not be square or rectangular and may, for example, be circular or have a profile of any suitable geometric shape. Similarly, the image field regions need not be square or rectangular and may, for example, have one or more curved edges. The image field regions may have the same or different sizes. For example, all three regions 162, 164, and 166 may have the same areas and perhaps even the same dimensions. In some embodiments, the left region 162 and right region 164 have the same areas dimensions, and the back region 166 has different dimensions (with the same area or different area) such as shown in FIG. 4F. In some embodiments, all three regions 162, 164, and 166 may have the different areas and different dimensions such as shown, by way of example and not limitation, in FIG. 4G.

The image captured by the image field 156 may be processed as a single image; preferably however, the image captured by each image field region is processed independently. The images from the different perspectives of the object 20 may reach the image field regions with the object being in the same orientation or in different orientations. Furthermore, the same enantiomorphic image of the object 20 from the different perspectives of the object 20 may reach the different image field regions or different enantiomorphic images of the object 20 may reach the different image fields. The different image field regions may have the same photosensitivities or be receptive to different intensities or wavelengths of light.

FIG. 4L is an isometric view of multiple image paths 62 and respective multiple perspective view volumes 64 that form a cumulative view volume 64g of the optical code reader 150, showing the image paths 62 and view volumes 64 without shading lines.

As with the previous embodiments and figures, the same or different filters, lenses, or other optical components may be optionally placed in some or all of the image paths 62. In some embodiments, the image reflected by each mirror component can be captured by the entire image field 156 when pulsed lighting and/or different wavelengths are used to separate the images obtained by the different perspectives. Depending on the layout of the reader, the environment, or the store/checkout stand arrangement, ambient lighting may be sufficient to provide adequate performance. In some embodiments, additional light sources may be added. For example, referring to FIGS. 4A-4B, light sources may comprise any suitable light source such as a row or array of LEDs (light emitting diodes) 72 and 74 mounted in/on the upper housing section 86 and a row/array of LEDs 76 and 78 mounted in/on the lower housing section pointed into the view volume 64 and positioned to illuminate an object 20 with respect to one or more perspectives. The LEDs 72-78 may be disposed on the housing structure or may be mounted internally behind windows 106, 96. The arrays 72-78 are shown only diagrammatically. The LEDs 72-74 are positioned behind window 106 and proximate to and on opposite lateral sides of mirror 130a₁. LEDs 76-78 are positioned below window 96 and proximate to and on opposite lateral sides of mirror 130f₁. Though two LED arrays are shown in each housing section, fewer or more arrays may be employed. In some embodiments, different wavelengths of light are directed to illuminate different regions of an object for different perspectives. In some embodiments, the one or more of the light sources may be operated in a pulsed mode, the pulsing synchronized with the imager frame rate. In one example, the imagers may be selected with a frame rate of 30 Hz and one or more of the light sources used to illuminate the read region are pulsed at 60 Hz. Examples of light source pulsing is described in U.S. Pat. No. 7,234,641, the disclosure of which is hereby incorporated by reference.

In an alternative embodiment, the upper perspective and the back lower perspective may be reflected to a common imager, and the left and right perspectives may be reflected to a common imager. These common imagers may have split imaging fields divided equally. These imagers 60 may be located where the imagers 60a and 60def are located or they may be located differently with additional mirrors as warranted. These imagers may be located in the same housing portion or different housing portions, and they may share a common PCB 140 or be supported by different PCBs 140. The mirrors 130 used for reflecting images onto these imagers may be split mirrors or independent mirrors.

B2. Single Horizontal Imager Split into Two Perspectives and Separate Vertical Imager Split or Unsplit

This subsection describes, by way of example, details of one type of embodiment of an imager-based optical code reader 180. FIGS. 5A-1 through 5D-1 are respective side, isometric, front, and top views of an optical code reader 180 configured for capturing multiple views of the object 20 (not shown in FIGS. 5A-1 through 5O-1; see FIG. 1) from different perspectives. For convenience, the optical code reader 180 will be described to a large extent using similar reference numerals to those used to describe FIGS. 3 and 4 (and 5) even though the dimensions of the housing 82, viewing windows, and/or transparent plates may be different; the perspectives, orientations, and/or sizes of the mirrors 130 may be different; the image paths 62 may have different angles; and/or the positioning, orientation, and/or dimensions of other components may be different.

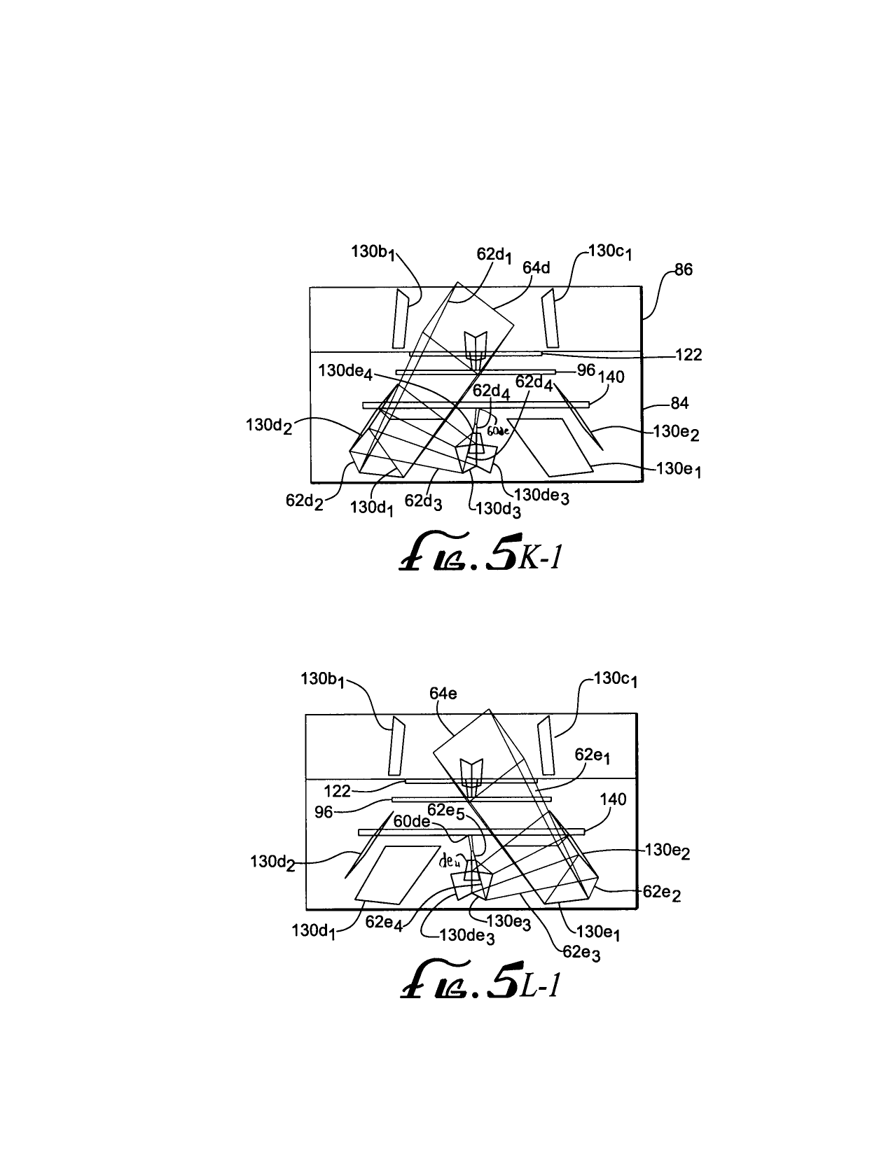

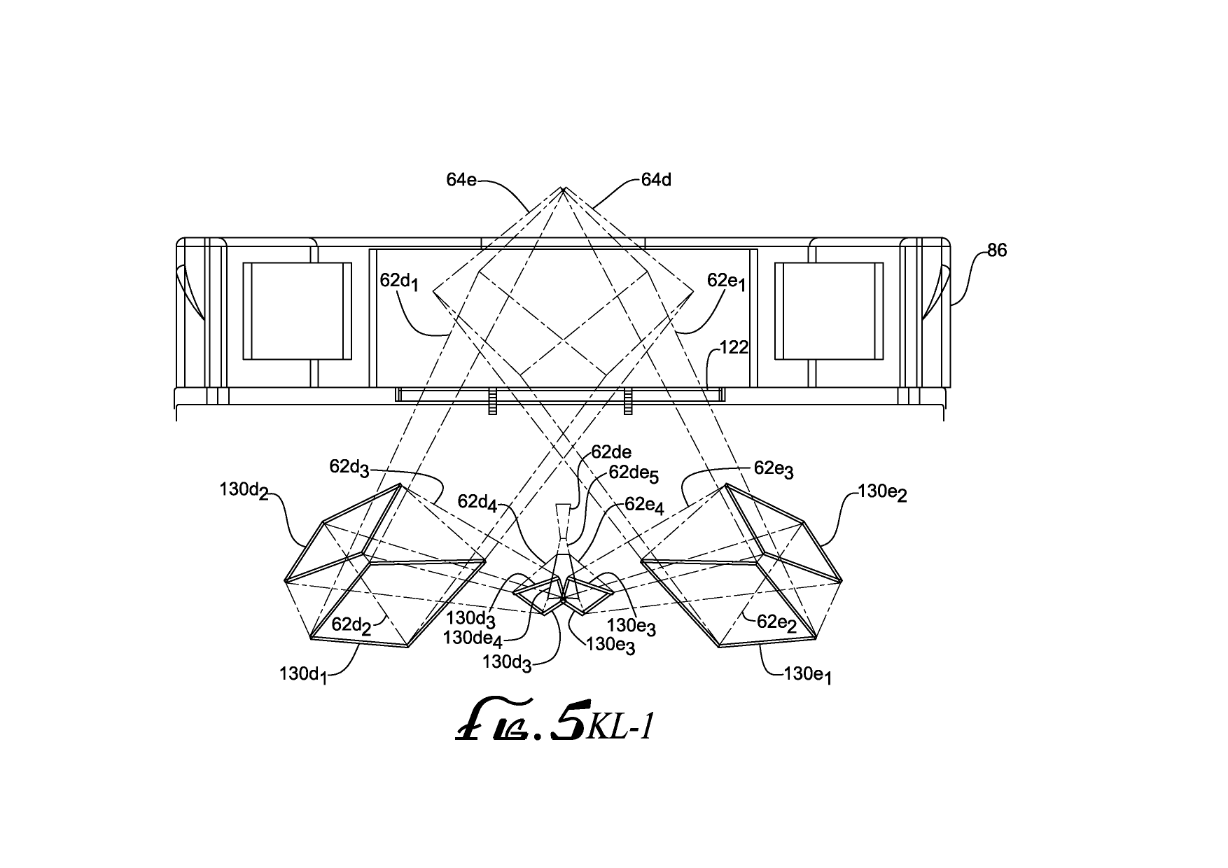

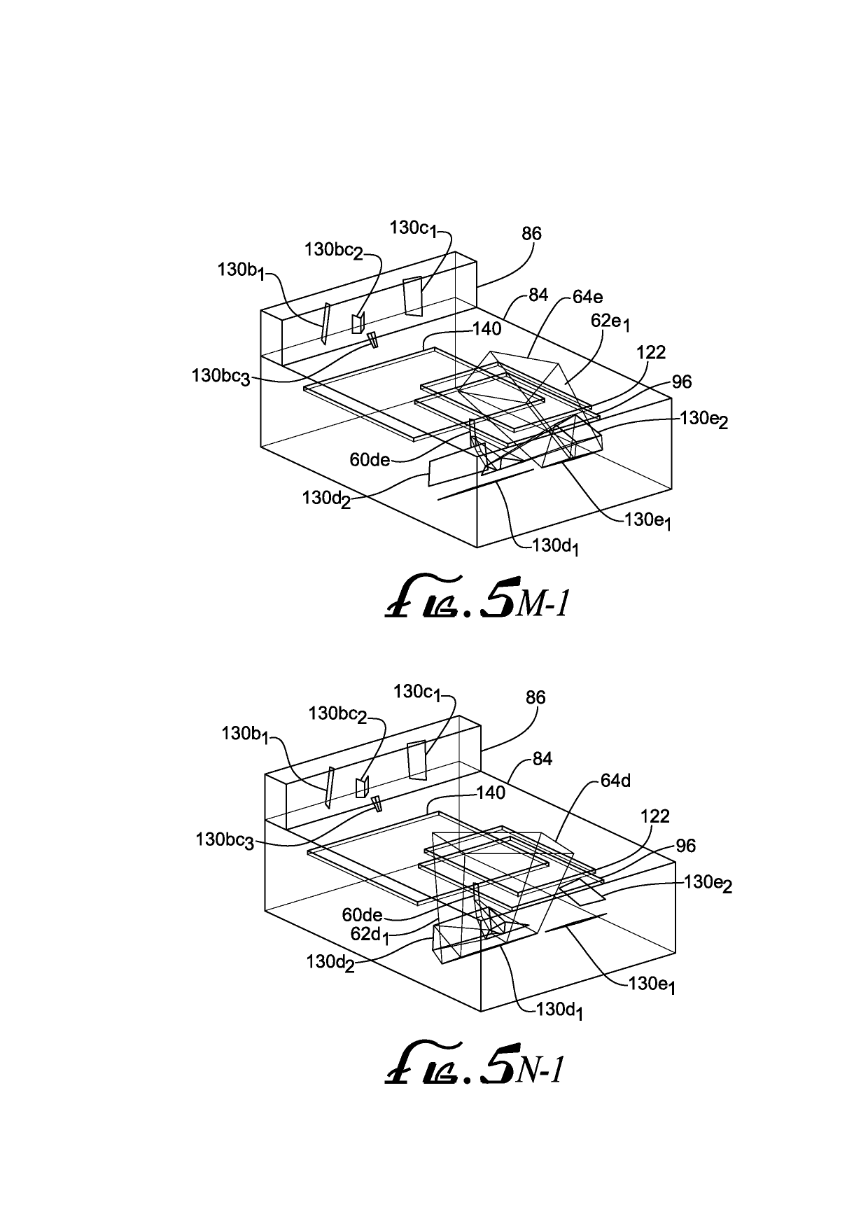

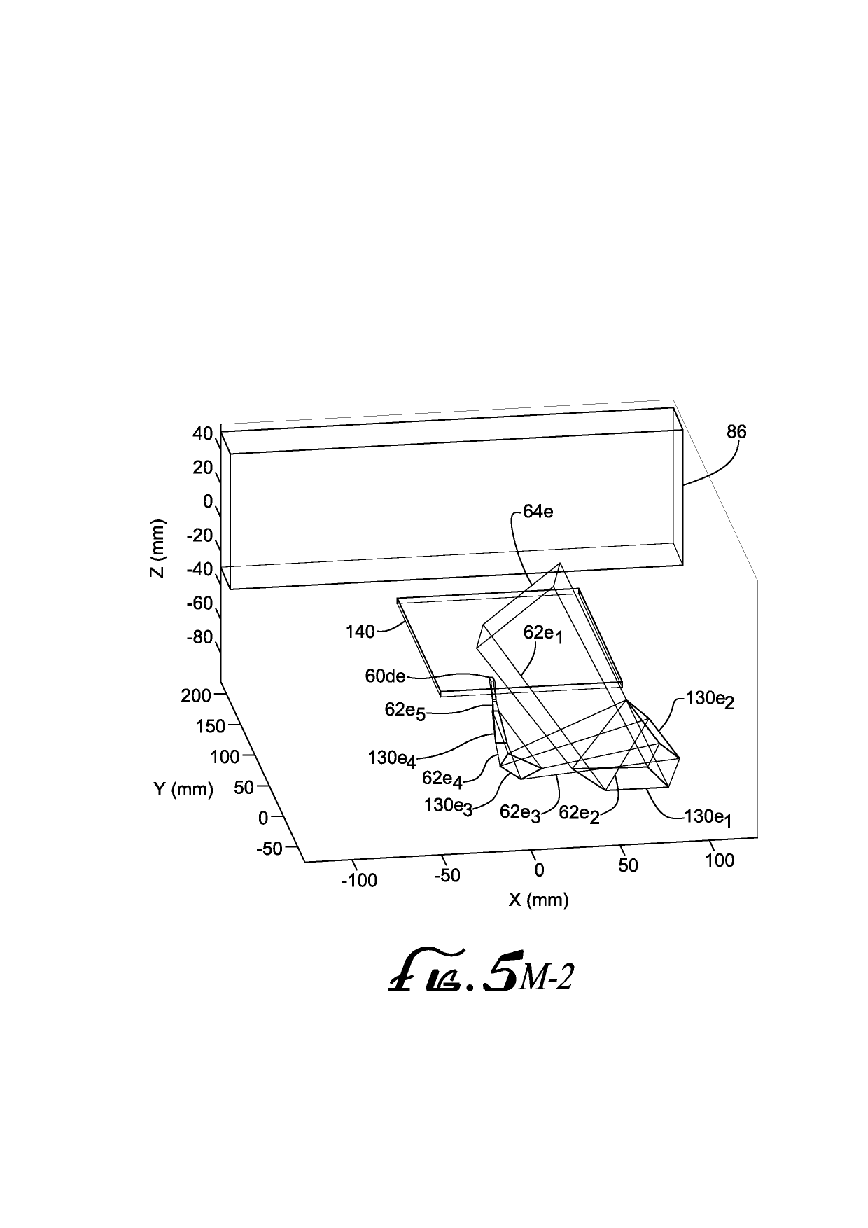

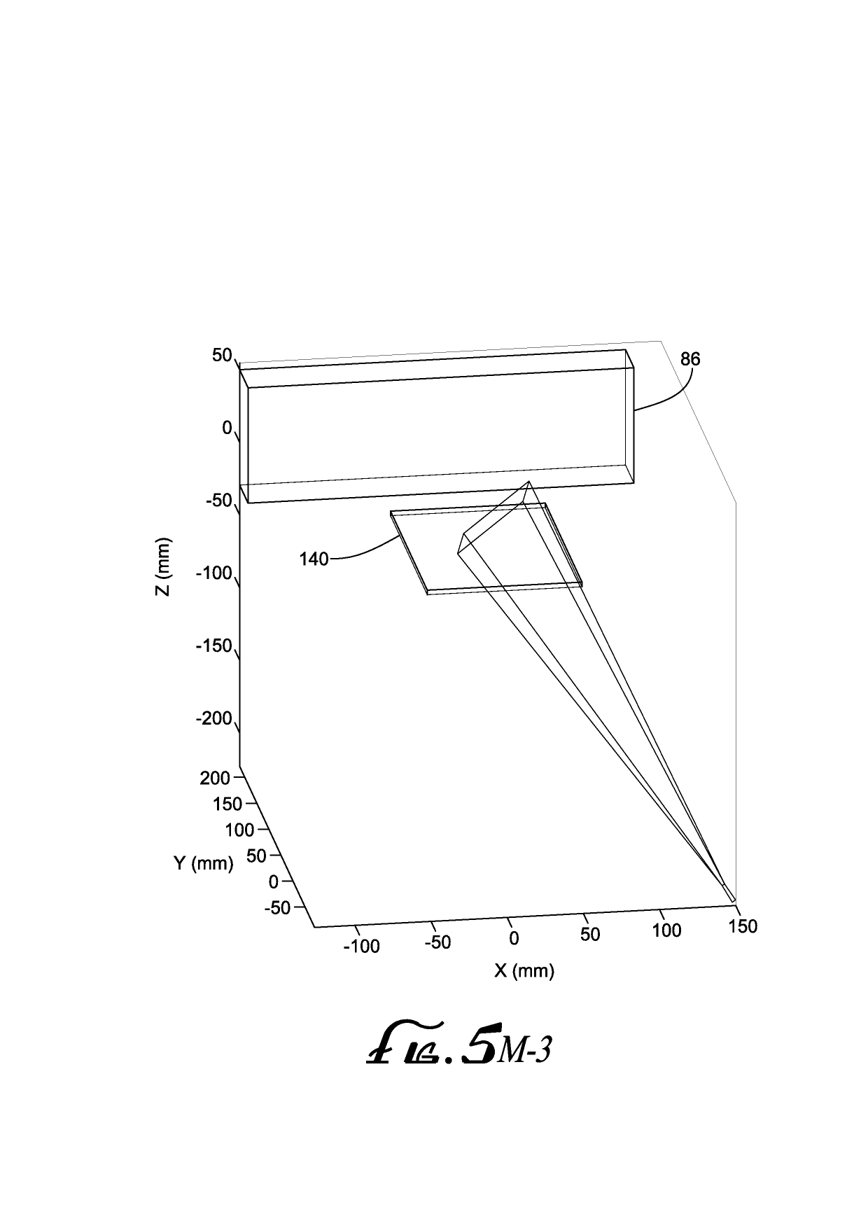

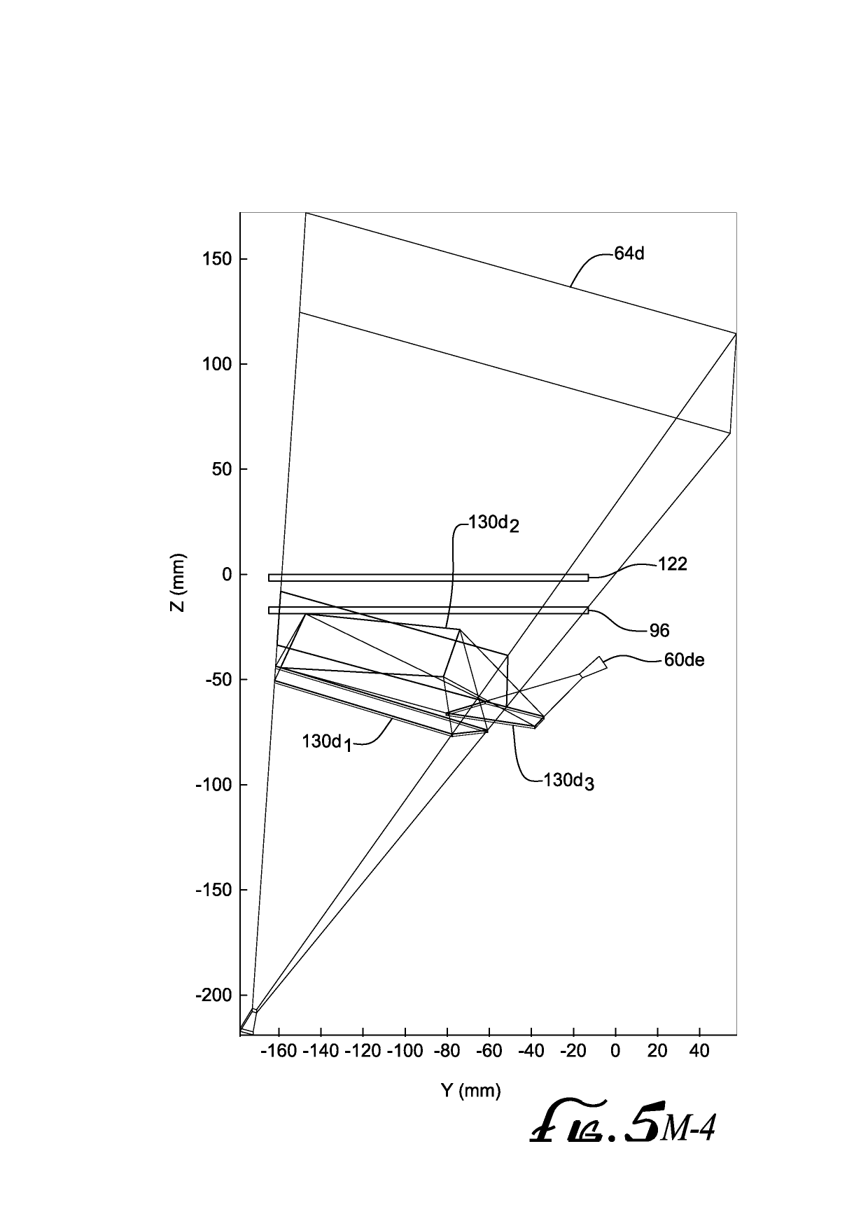

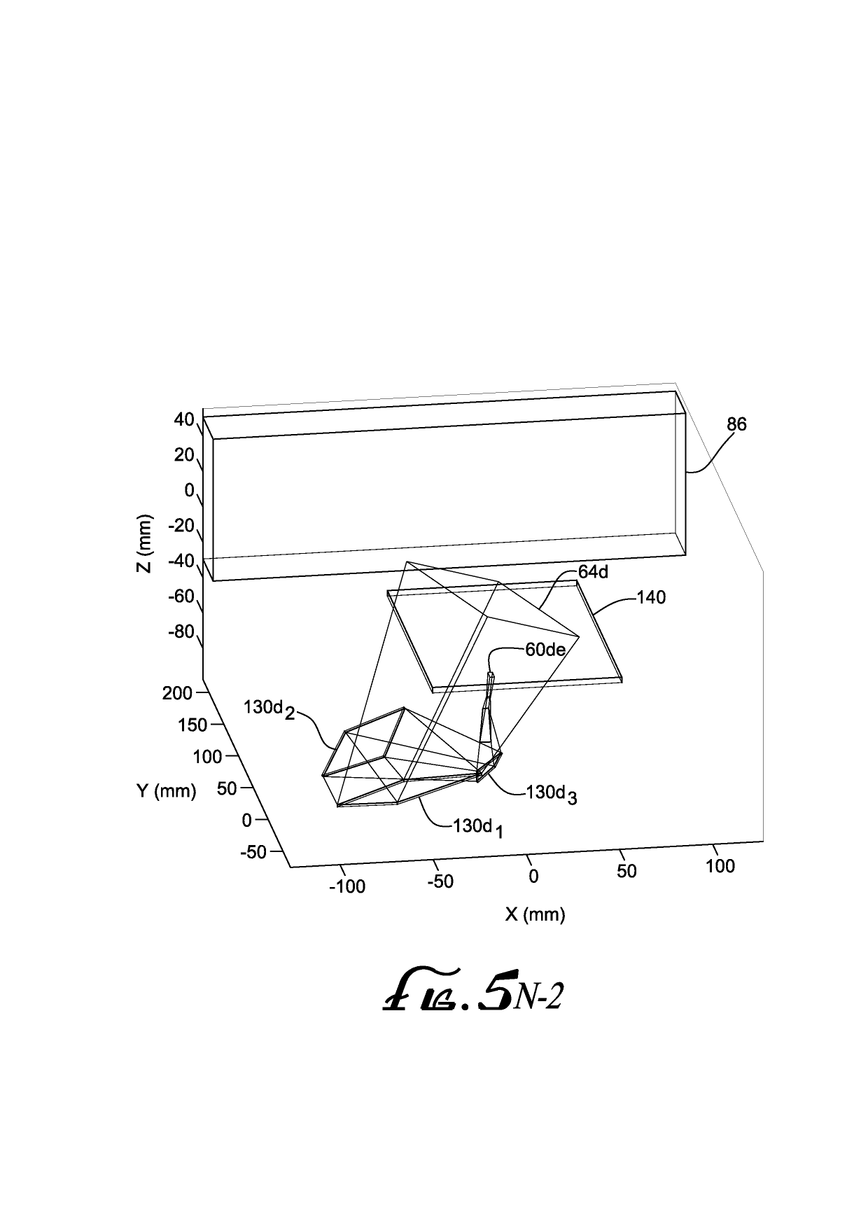

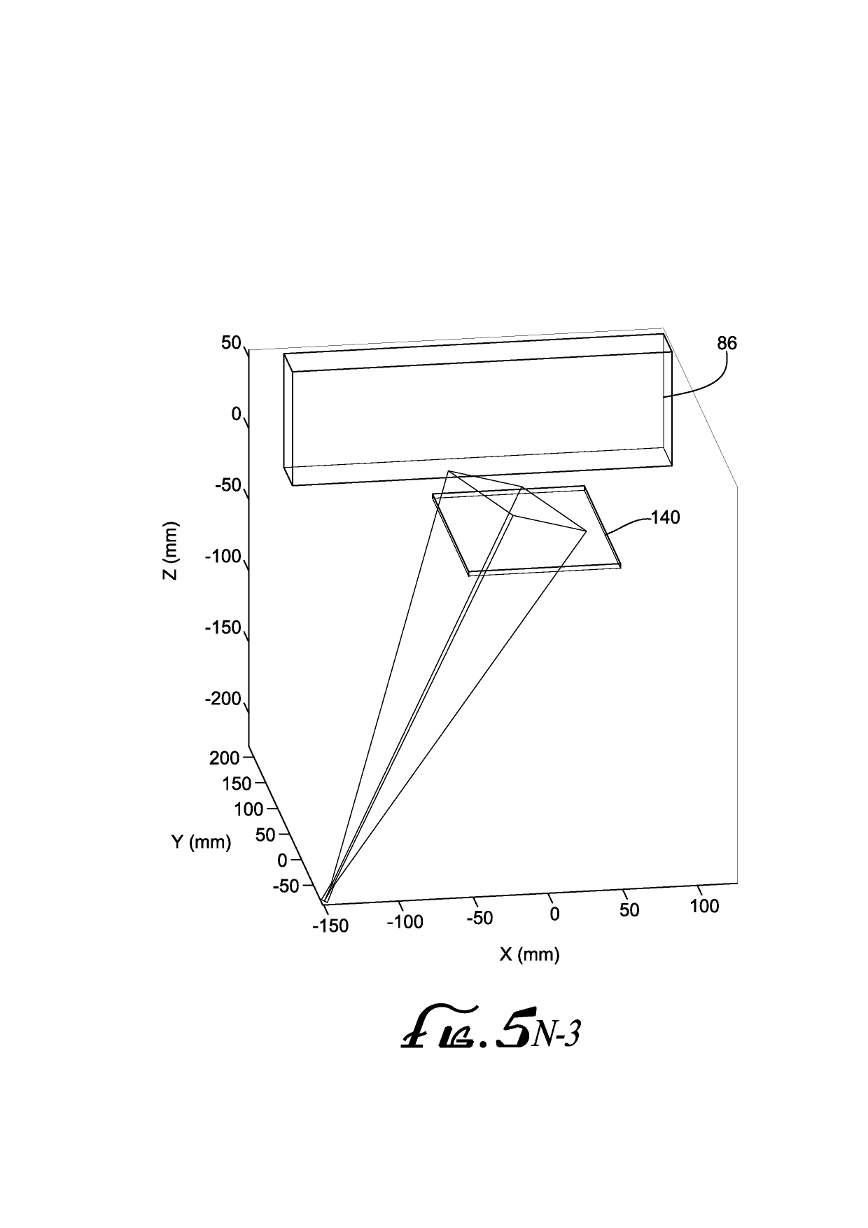

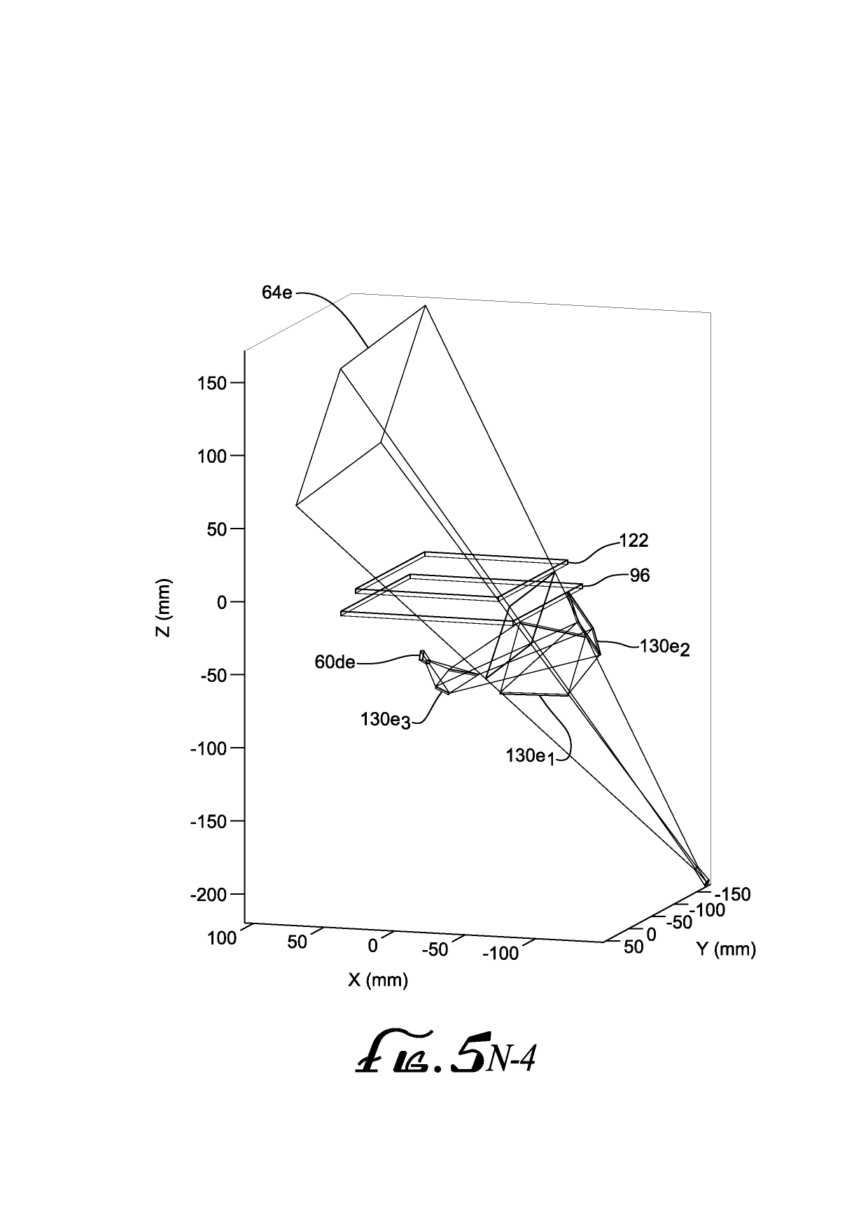

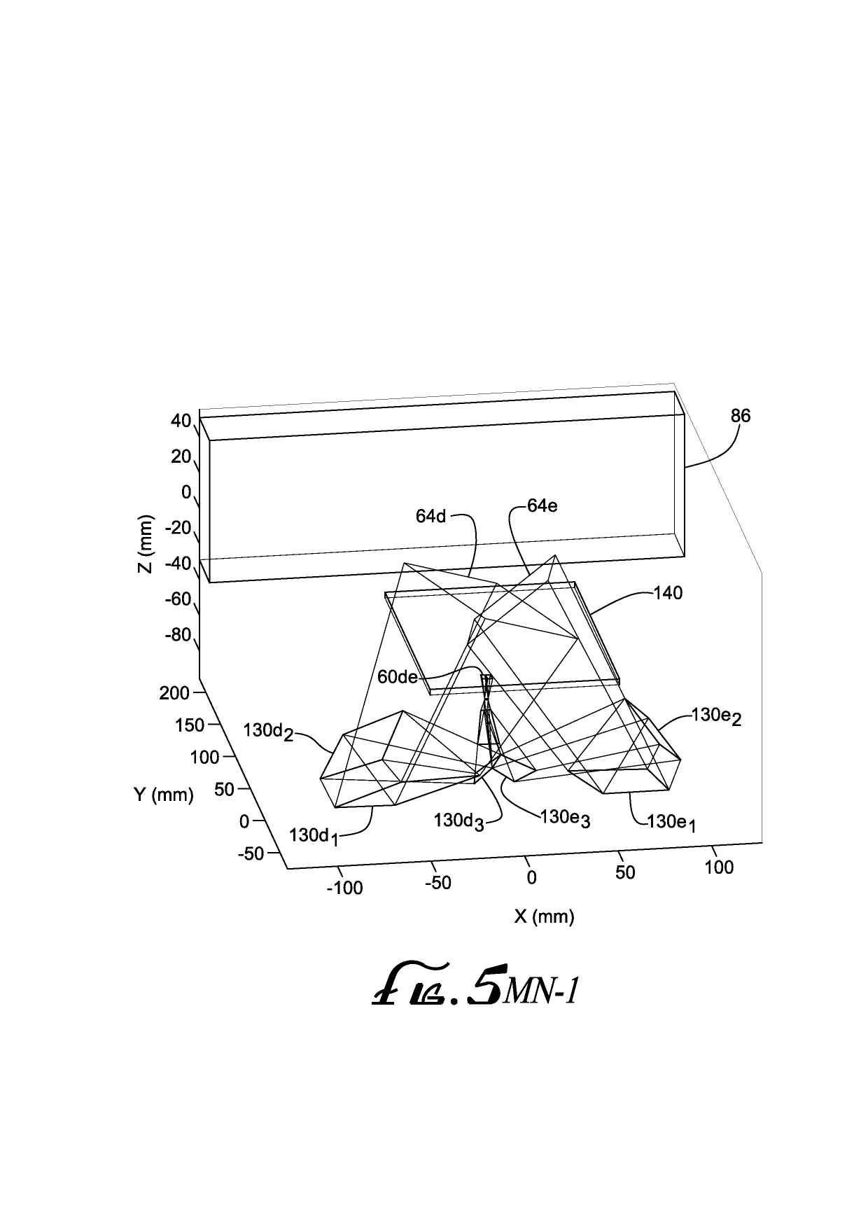

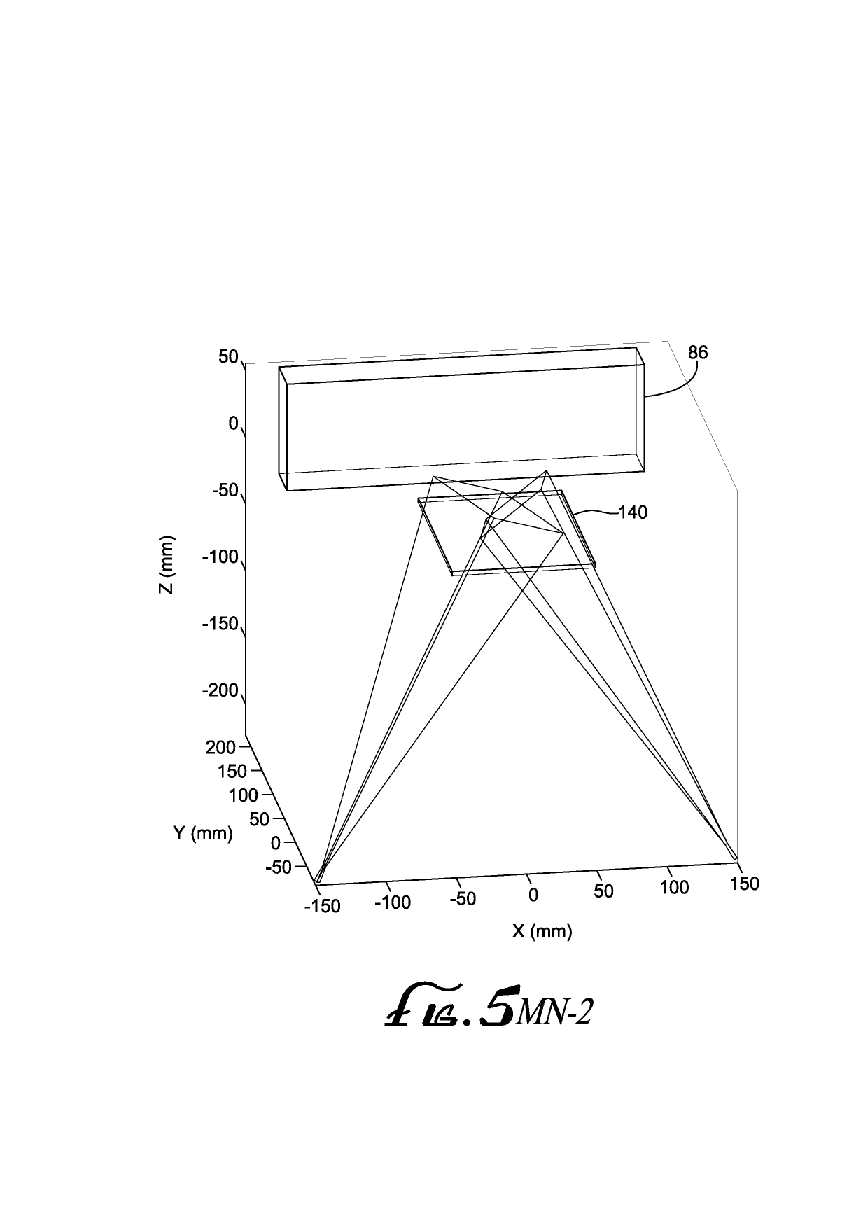

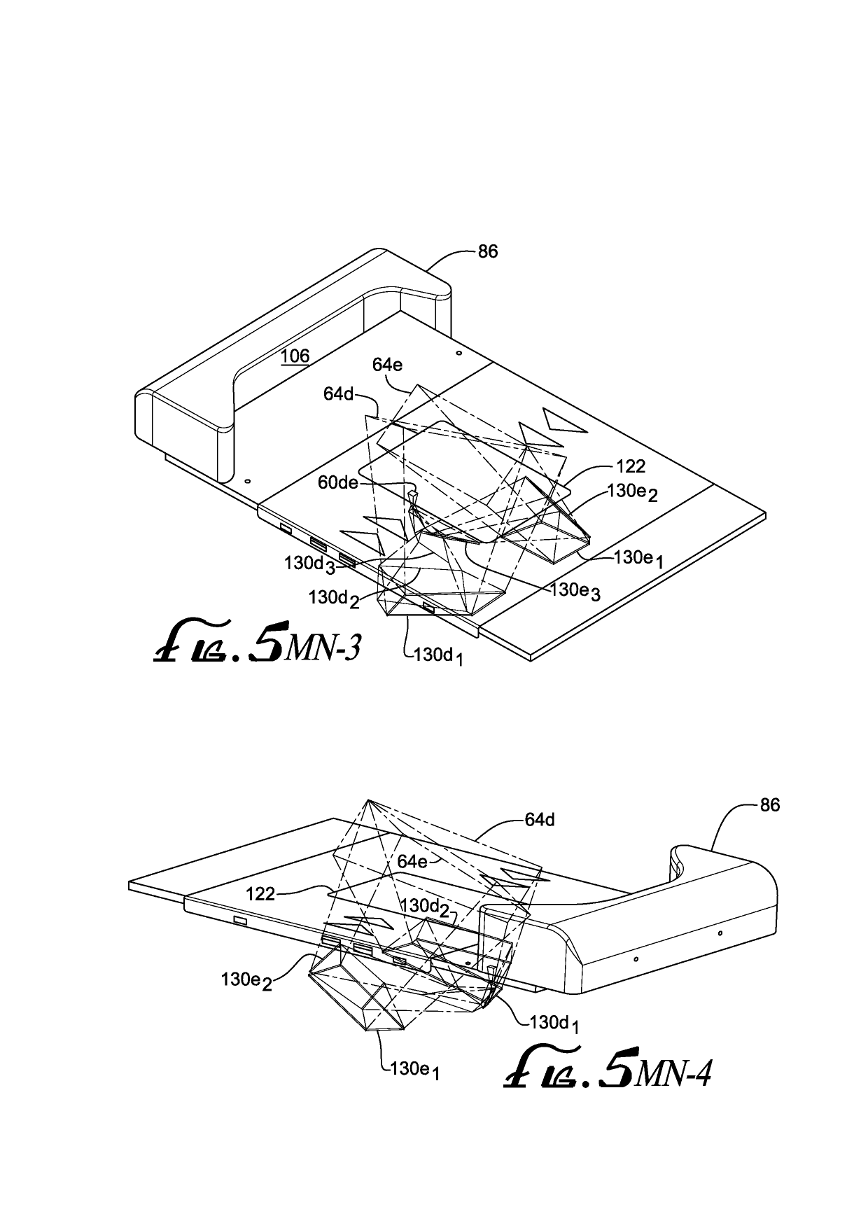

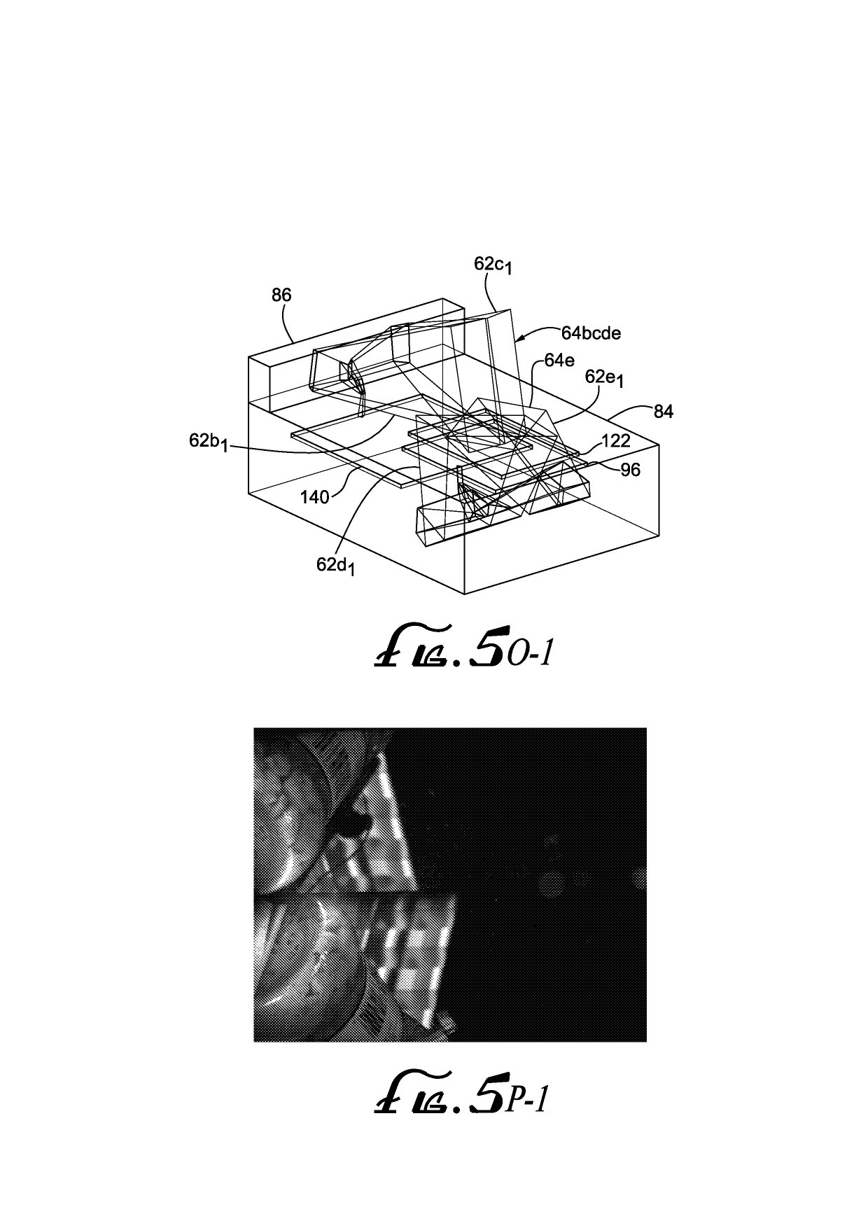

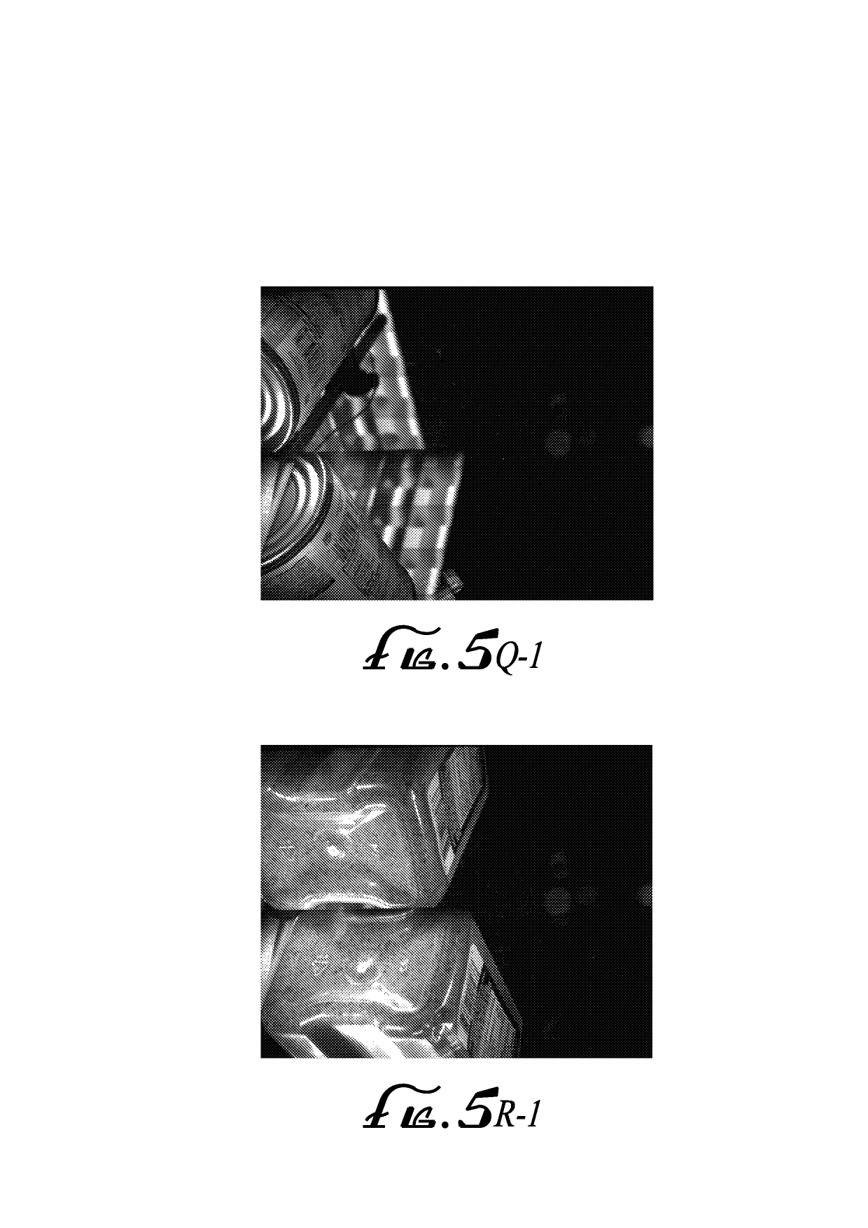

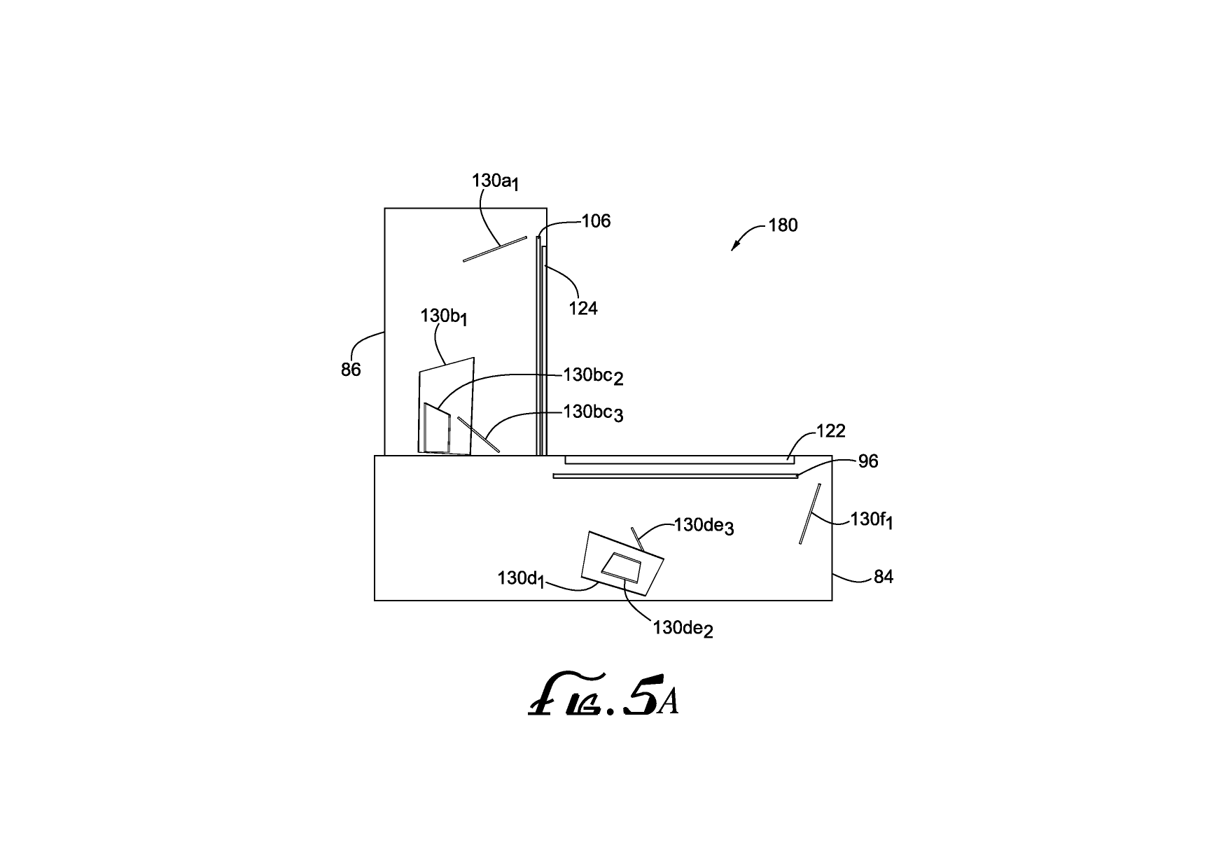

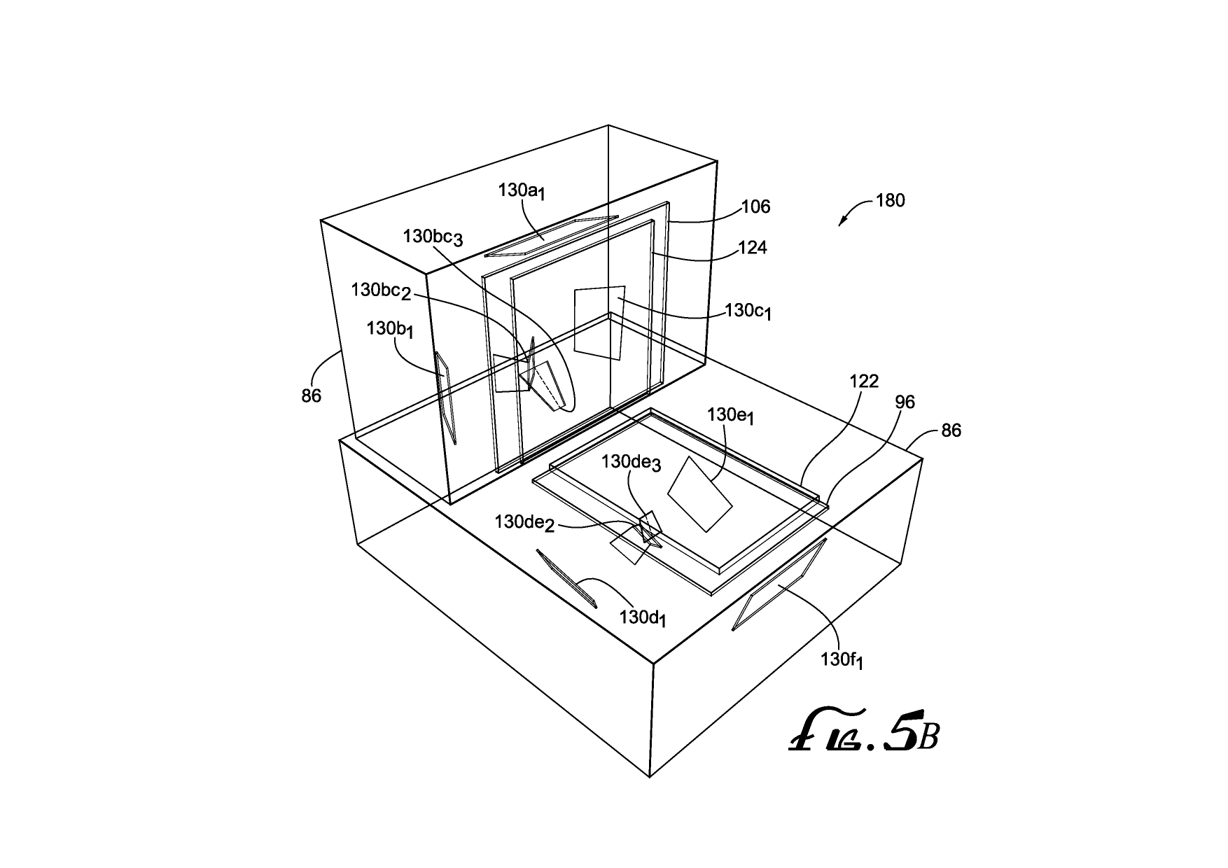

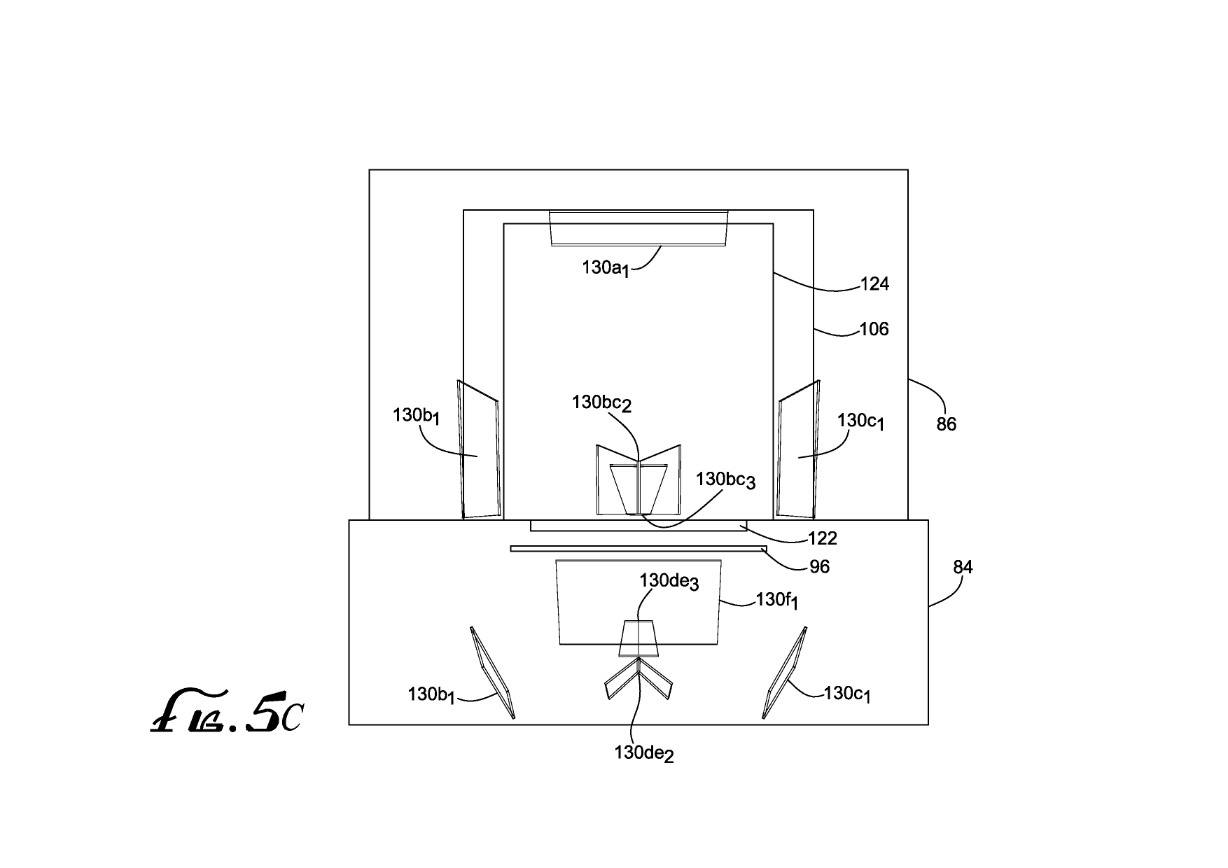

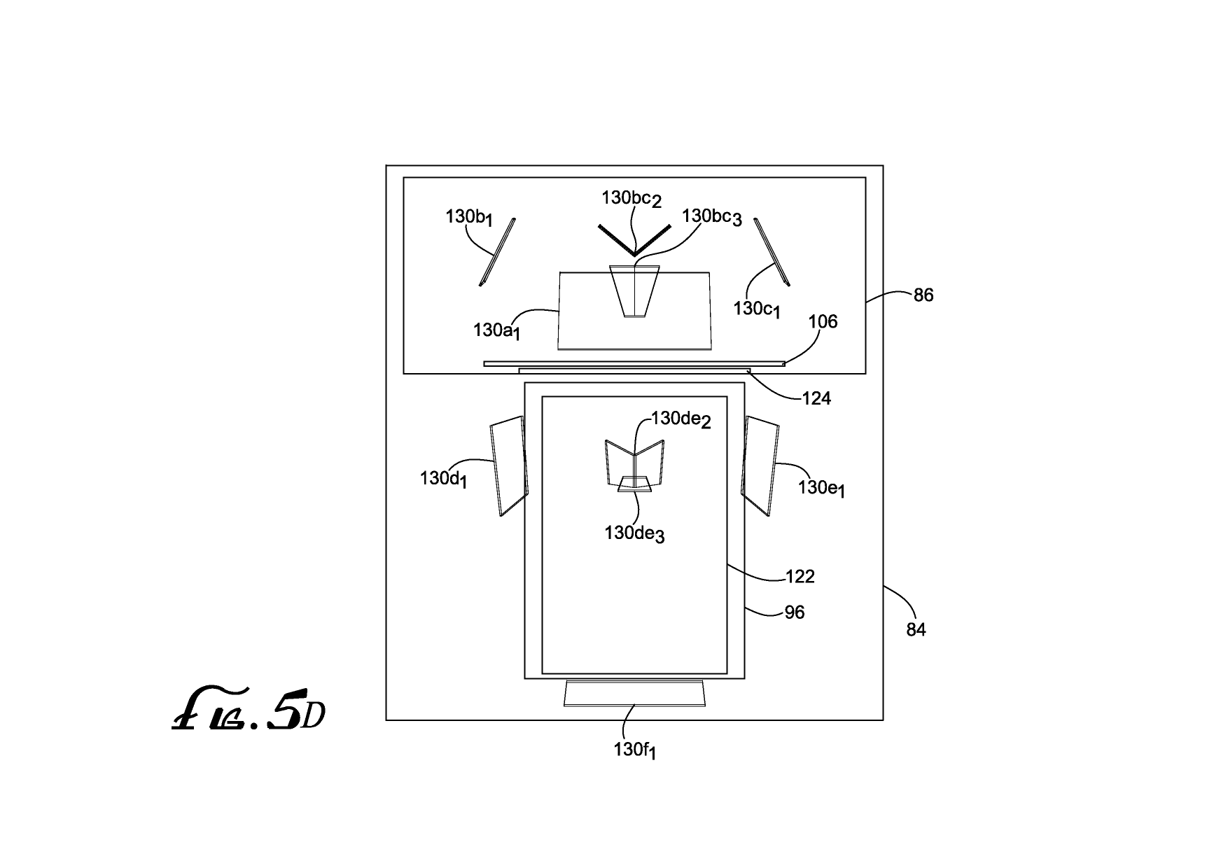

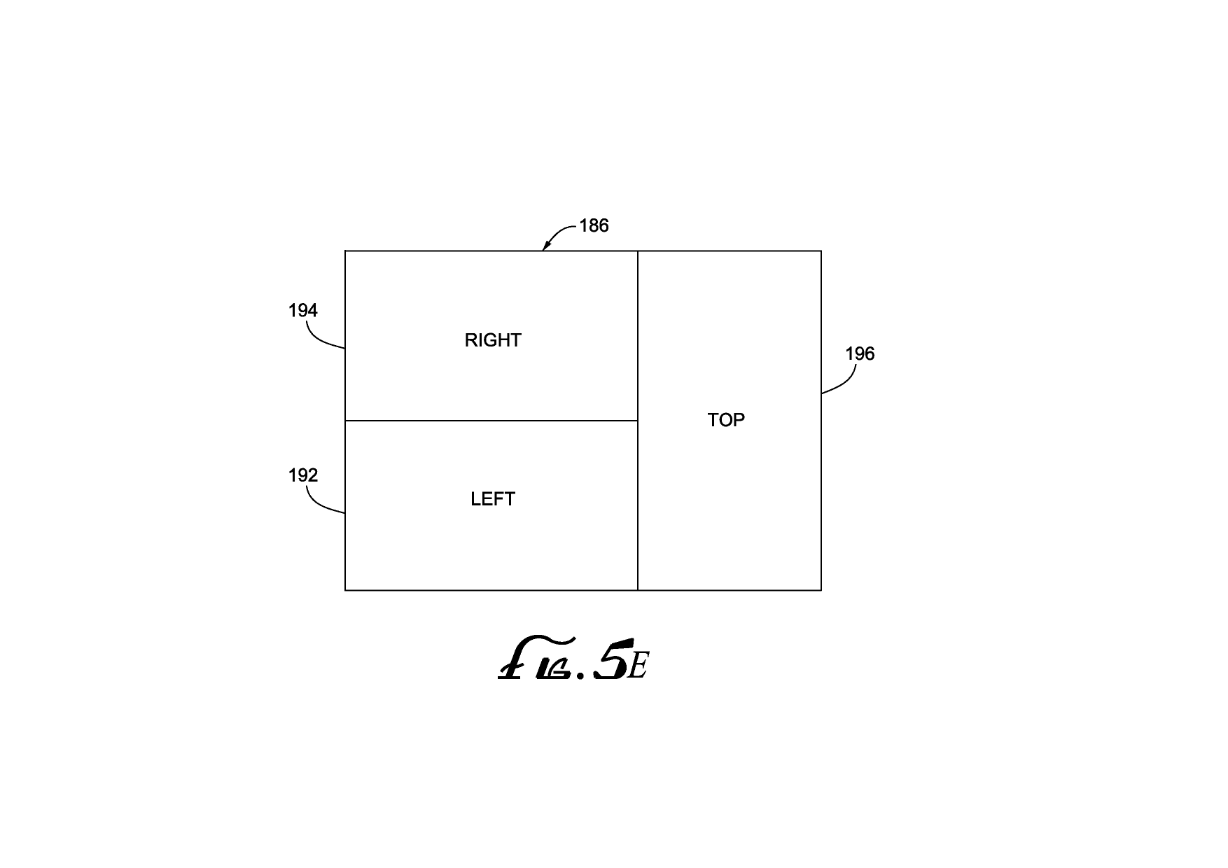

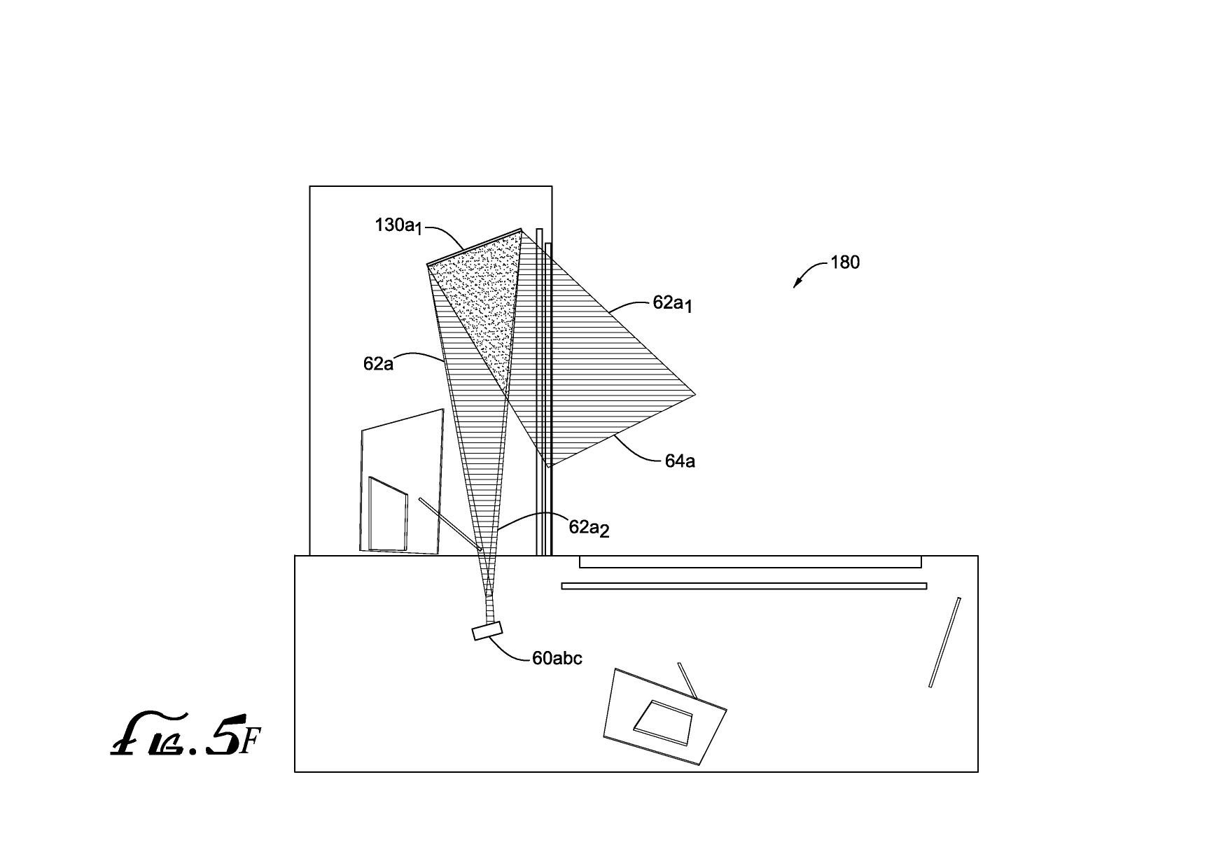

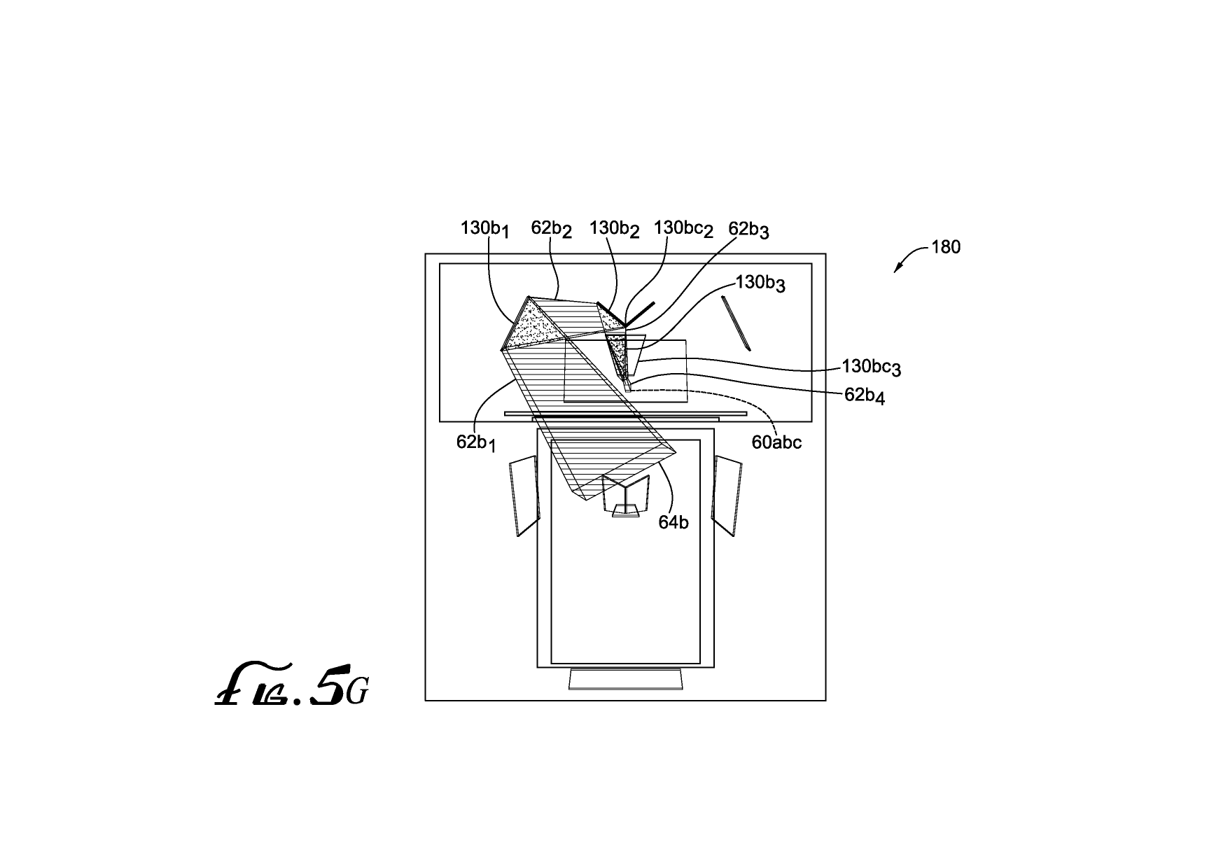

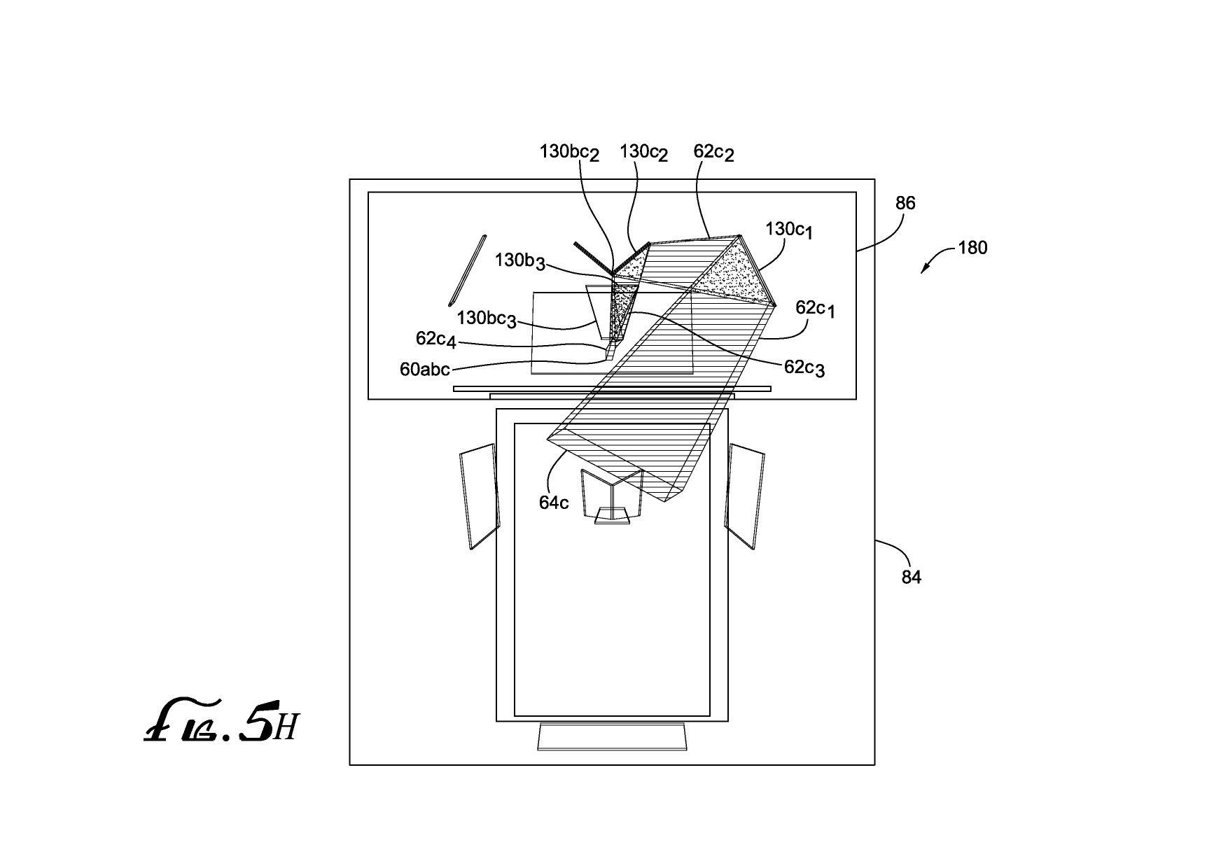

The optical code reader 180 of FIGS. 5A-1 through 5O-1 may employ a two imager system with two imagers 60bc and 60de, each capturing two views. Alternatively, the optical code reader may employ a two imager system with an imager 60a (similar to the configuration shown in FIG. 4K) and the imager 60de, wherein the imager 60a captures a single view, and the imager 60de captures two views. The imager 60bc captures two views through the upper transparent plate 106 in the vertical housing portion 86 (see FIG. 5F-1). Those two views are from upper left and upper right perspectives, as described in greater detail below. The imager 60de captures two views through the lower viewing window 96 in the horizontal housing portion 84 (see FIG. 5A-2. Those two views are from lower left and lower right perspectives, as described in greater detail below. In some embodiments, the two imagers are distinct as shown in the figures. However, the two imagers may be placed on opposite sides of a PCB 140 that extends between imagers 60bc and 60de in their locations as shown. Alternatively, the two imagers may be placed on opposite sides of a PCB 140 in either one of the locations of the imagers 60bc and 60de. For example, an additional fold mirror may be located in the former position of one of the imagers 60bc and 60de to reflect the image path from the opposite side of the PCB 140, with a lens or other optical component added or adjusted to compensate for any undesirable change in focal path length or depth of field. Alternatively, the PCB 140 with the imagers 60bc and 60de on opposite sides may be located at a location entirely different than that of either of the original locations of the imagers 60bc and 60de, with an additional fold mirror located at each of the original locations of the imagers 60bc and 60de.

FIG. 5E-1 is a map of an image field 186 of split-view or multi-region imager divided into two regions to capture separate views at the imager 60bc. With reference to FIGS. 5F-1 through 5G-1 (described in greater detail below), the image field 186 of the imager 60bc may be split into two image field regions, such as a left region 192, a right region 194 that may be adapted to capture images from the corresponding left upper perspective, and right upper perspective respectively. Thus, the mirror component 130b₂ reflects the image along the image path segment 62b₃ onto the left region 192 of the image field 186 of the imager 60bc; the mirror component 130c₂ reflects the image along the image path segment 62c₃ onto the right region 164 of the image field 186 of the imager 60bc. One or more of image field variations previously discussed with respect to the image field 156 of FIG. 4 may be optionally employed in any suitable combination with respect to the image field 186.

FIG. 5G-1 is a top view of a second set of mirrors 130b (mirrors 130b₁, 130b₂ and 130b₃) reflecting a left upper perspective of the view volume 64b along the image path 62b to the imager 60bc of the optical code reader 180. With reference to FIG. 5G-1, an image of the object 20 in the view volume 64b, captured from the left upper perspective and propagated through the upper transparent plate 106 along the image path segment 62b₁, is reflected sideward toward the center of the reader 180 by the primary mirror 130b₁ along the image path segment 62b₂ to a secondary mirror 130b₂ in the mirror structure 130bc₂ which reflects the image along the image path segment 62b₃ to a tertiary mirror 130b₃ in the split mirror 130bc₃ which reflects the image downward along the image path segment 62b₄ to the imager 60bc. The image path segments 62b₁ and 62b₂ have respective lengthwise axes that intersect one another at an acute angle.

FIG. 5H-1 is a top view of a third set of mirrors 130c (mirrors 130c₁, 130c₂ and 130c₃) reflecting a right upper perspective of the view volume 64c along the image path 62c to the imager 60bc of the optical code reader 180. With reference to FIG. 5H1, an image of the object 20 in the view volume 64c, captured from the right upper perspective and propagated through the upper transparent plate 106 along the image path segment 62c₁, is reflected sideward toward the center of the reader 180 by the primary mirror 130c₁ along the image path segment 62c₂ to a secondary mirror 130c₂ in the mirror structure 130bc₂ which reflects the image along the image path segment 62c₃ to a tertiary mirror 130c₃ in the split mirror 130bc₃ which reflects the image downward along the image path segment 62c₄ to the imager 60bc. The image path segments 62c₁ and 62c₂ have respective lengthwise axes that intersect one another at an acute angle.

The mirror structure 130bc₂ is preferably a split or compound mirror that includes multiple mirror components or surfaces 130b₂ and 130c₂ of the respective image paths 62b and 62c, and the mirror 130bc₃ is preferably a single planar mirror surface that has two sections 130b₃ and 130c₃ in the respective image paths 62b and 62c. The mirror components 130b₂ and 130c₂ and 130b₃ and 130c₃ of the respective split mirrors 130bc₂ and 130bc₂ may be arranged at different angles with respect to the horizontal or vertical planes (and with respect to each other) to accommodate the orientations of the different image paths 62b and 62c. The compound mirror structure 130bc₂ and its mirror components 130b₂ and 130c₂ may employ any of the variations discussed with respect to any of the other compound mirror structures and parts thereof described herein. In some embodiments, the mirror components 130b₂ and 130c₂ may have nonreflective regions in proximity to their intersections. FIG. 5I-1 illustrates an example embodiment of the compound mirror structures 130bc₂.

FIG. 5J-1 is a map of an image field 286 of a split-view or multi-region imager divided into two regions to capture separate views at the imager 60de. With reference to FIGS. 5K-1 and 5L-1 (described in greater detail below), the image field 286 of the imager 60de may be split into two image field regions, such as a left region 292, a right region 294 that may be adapted to capture images from the corresponding left lower perspective and right lower perspective, respectively. Thus, the mirror component 130d₃ reflects the image along the image path segment 62d₄ onto the left region 292 of the image field 286 of the imager 60de; and the mirror component 130e₂ reflects the image along the image path segment 62e₄ onto the right region 294 of the image field 286 of the imager 60de. One or more of image field variations previously discussed with respect to the image field 156 of FIG. 4 may be optionally employed in any combination with respect to the image field 286 except where such combinations are mutually exclusive.

FIG. 5K-1 is a front view of a fourth set of mirrors 130d (mirrors 130d₁, 130d₂, 130de₃ and 130de₄) reflecting a left lower perspective of the view volume 64d along the image path 62d to an imager 60de of the optical code reader 180. With reference to FIG. 1 and FIGS. 5A-1 through 5O-1, particularly FIG. 5K-1, an image of the object 20 in the view volume 64d, captured from the left lower perspective and propagated through the lower transparent plate 96 along the image path segment 62d₁, is reflected sideward and backward toward the center of the imager by the primary mirror 130d₁ along an image path segment 62d₂ to a secondary mirror 130d₂ which reflects the image along an image path segment 62d₃ to a tertiary mirror 130d₃ in a mirror structure 130de₃ which reflects the image along an image path segment 62d₄ to a quaternary mirror 130d₄ in a mirror structure 130de₄ which reflects the image along an image path segment 62d₄ to the imager 60de, which may be supported on a PCB 140. As noted previously, the imager 60de is supported on the opposite side of the same PCB 140 than the one that may be used to support the imager 60bc. The image path segments 62d₁ and 62d₂ have respective lengthwise axes that intersect one another at an acute angle.

FIG. 5L-1 is a front view of a fifth set of mirrors 130e (mirrors 130e₁, 130e₂ and 130de₃, 130de₄) reflecting a right lower perspective of the view volume 64e along an image path 62e to the imager 60de of the optical code reader 180. With reference to FIG. 5L-1, an image of the object 20 in the view volume 64e, captured from the right lower perspective and propagated through the lower transparent plate 96 along an image path segment 62e₁, is reflected sideward and backward toward the center of the imager by a primary mirror 130e₁ along an image path segment 62e₂ to the secondary mirror 130e₂ which reflects the image along an image path segment 62e₃ to the tertiary mirror 130e₃ in the mirror structure 130de₃ which reflects the image along an image path segment 62e₄ to a quaternary mirror 130e₄ in the mirror structure 130de₄ which reflects the image along an image path segment 62d₄ to the imager 60de, which may be supported on the PCB 140 as previously described. The image path segments 62e₁ and 62e₂ have respective lengthwise axes that intersect one another at an acute angle. FIG. 5KL-1 is a front view of mirrors reflecting right and left lower perspectives, showing a combination of the image paths and view volumes of FIGS. 5K-1 and 5L-1.

FIGS. 5M-1 through 5M-4 and 5N-1 through 5N-4 are isometric views of multiple image paths 62d and 62e that form a cumulative view volume on the horizontal portion of the optical code reader 180. An advantage of this embodiment is that one imager 60de can capture four views from different perspectives. The image paths 62 can be alternatively arranged so that the imagers 60bc and 60de can be located in different housing portions or so that they can be supported by the same PCB 140. As with the previous embodiments and figures, any previously discussed variations or combinations thereof that are not mutually exclusive may be employed.

The image paths 62d and 62e are arranged to view the length of the horizontal window 122 and skewed slightly to aim towards the vertical window. By maximizing the view area, the opportunity to capture an image of a moving object which may contain a barcode can be increased. In this way the first pass read rate (FPRR) is increased, compared to an imager with a smaller window area. FPRR is dependent upon factors including the object speed, imager frame rate, exposure time, label size, and view area. By skewing or slanting the image view towards the vertical window, the perspective on a rear or back side of the moving object 20 may be increased. Each of image views 62d and 62e can see the rear or back side of the object. Even though the view from these two perspectives are skewed with respect to the leading and trailing sides of the object 20, the small amount of skew still allows the capture of a good image, especially in cooperation with the larger imager region. In some implementations, the window size is about 4″ wide by 6″ long, for a window of this size the view can be skewed 0 degrees to 35 degrees, for example. In some implementations, the optical code reader is designed based on a goal of decoding 13 mil labels that are moving at 100 inches per second (IPS) with a suitable imager running at 40 frames per second without label stitching. Changing any one of the parameters may change the FPRR or single pass success rate (SPSR) as later described.

FIG. 5O-1 is an isometric view of multiple image paths 62 (as labeled in other members of the set of FIGS. 5A-1 through 5O-1) and respective multiple perspective view volumes 64 that form a cumulative view volume 64g of the optical code reader 180. An advantage of this embodiment is that two imagers 60 can capture six views from different perspectives. The image paths 62 can be alternatively arranged so that the imagers 60bc and 60de can be located in different housing portions or so that they can be supported by the same PCB 140. As with the previous embodiments and figures, any previously discussed variations or combinations thereof that are suitable with the embodiments presented in FIGS. 5A-1 through 5O-1 may be employed.

In some embodiments, the imager 60bc is mounted on the upwardly-facing side of the PCB 140 and the imager 60de is mounted on the downwardly-facing side of the PCB 140 as shown in FIG. 5O-1. Alternatively, the imager 60bc can be mounted on the downwardly-facing side of the PCB 140 and the imager 60de is mounted on the upwardly-facing side of the PCB 140. In some embodiments, both sides of the PCB 140 have identical component configurations rotated 180 degrees with respect to the positions on the opposite side, such that regardless of which side of PCB 140 faces upwardly, the positions of the imagers 60bc and 60de are predetermined to function in either set of image paths.

In some embodiments, the imager 60bc is mounted closer to the vertical window 118 than is the imager 60de. Alternatively, the imager 60bc can be mounted farther from the vertical window 118 than is the imager 60de. In some embodiments, the imager 60bc and the imager 60de are separated by a distance of at least 7.5 cm. Alternatively, they may be separated by a distance greater than 10 cm, greater than 12.5 cm, or greater than 15 cm. However, the imager 60bc and the imager 60de can also be mounted within 7.5 cm of each other or within 3 cm of each other. Moreover, the imager 60bc and the imager 60de may be mounted to be directly opposite each other.

With reference again to FIGS. 5A-1 through 5O-1, the mirror structure 130de₃ is preferably a compound or split mirror that includes mirror surfaces or components 130d₃ and 130e₃ of the respective image paths 62d and 62e, and the mirror 130de₄ is preferably a single planar mirror that includes mirror components or sections 130d₄ and 130e₄ in the respective image paths 62d and 62e. The mirror components 130d₃ and 130e₃ and 130d₄ and 130e₄ of the respective split mirrors 130de₃ and 130de₄ may be arranged at different angles with respect to the horizontal or vertical planes (and with respect to each other) to accommodate the orientations of the different image paths 62d and 62e. The compound mirror structures 130de₃ and its components 130d₃ and 130e₃ may employ any of the variations discussed with respect to any of the other compound mirror structures and parts thereof described herein. In some embodiments, the mirror components 130d₃ and 130e₃ may have nonreflective regions in proximity to their intersections.

With reference to FIGS. 4 and 5A-1 through 5O-1, the image paths 62d, 62e, and 62f may reflect the images of the object 20 onto a split field imager 156, such as described in connection with FIG. 4. Exemplary imagers 60 that may be used for these FIGS. 5A-1 through 5O-1 embodiments include megapixel imagers with a resolution of 1280×1024 pixels for the imagers 60bc and 60de. One preferred megapixel imager is the model EV76C560 1.3 MP CMOS image sensor available from e2V of Essex, England and Saint-Egrève, France. However, any other suitable type of imager 60 of various resolutions may be employed.

The upper housing portion 86 and the lower housing portion 84 can be manufactured and shipped separately or they can be manufactured and shipped as a single integrated optical code reader 180, especially in implementations in which the imagers 60bc and 60de are mounted to the same PCB 140. As noted earlier, the upper housing portion 86 has the sidewardly-facing vertical window 118, and the lower housing portion 84 has the upwardly-facing horizontal window 116.

When a six-sided box-shaped object 20 having an upwardly-facing top side 26, a downwardly-facing bottom side 28, and four sidewardly facing lateral sides including a left side 30, a right side 32, a front side 36, and a rear or back side 34 is passed through the viewing volume 64 (64bcdf) and oriented with its front side 36 facing the vertical window 118 and its bottom side 28 facing the horizontal window 116, the lower left perspective view (view volume 64d) captures a leading perspective of the left side 30 of the object 20, a first far side perspective of the rear or back side 34 of the object 20, and a first bottom perspective of the bottom side 28 of the object 20, and the lower right perspective view (view volume 64e) captures a trailing perspective of the right side 32 of the object 20, a second far side perspective of the rear or back side 34 of the object, and a second bottom perspective of the bottom side of the object 20.

Similarly, the upper left perspective view (view volume 64b) captures a leading perspective of the left side 30 of the object 20, a first near side perspective of the front side 36 of the object 20, and a first top perspective of the top side 26 of the object 20, and the upper right perspective view (view volume 64c) captures a trailing perspective of the right side 32 of the object 20, a second near side perspective of the front side 36 of the object, and a second top perspective of the top side 26 of the object 20.

Depending on the position of the object 20 and the speed at which it is passed through the view volume 64, the perspective views may capture one, more than one, or all of the specified sides of the object 20 in a single frame or image. For example, the lower right perspective view may first capture a primary frame or image of the object 20 that depicts only the left side 30 or depicts the left side 30 and the rear or back side 34. A secondary time-displaced frame or image may capture the left side 30, the rear or back side 34, and the bottom side 28. A tertiary time-displaced frame or image may capture the rear or back side 34 and the bottom side 28. A quaternary time-displaced frame or image may capture only the bottom side 28.

One advantage of dividing the imagers 60bc and 60de into only two image fields (rather than three as later described) is that the resulting larger image field regions of the imager facilitate capture of a larger surface area of the object 20, particularly on the left and right sides 30 and 32 of the object 20. The capture of a larger surface area of the object 20 increases the opportunity to capture an entire label (and the code it contains) in a single frame or image. In some implementations, each of the image field regions utilize greater than 40% of the surface area of the imager. In some implementations, each of the image field regions utilize greater than 45% of the surface area of the imager. In some implementations, each of the image field regions utilize an equal amount of the surface area of the imager. In some implementations, the image field region capturing the leading side 30 of an object 20 utilizes a greater amount of the surface area of the imager than does the image field region capturing the trailing side 32 of the object 20. In some implementations, each of the image field regions utilize about as much as 50% of the surface area of the imager.

In the embodiments with respect to FIGS. 5A-1 through 5O-1, the split field imager provides an image field region with a greater than 60% single pass success rate (SPSR) for capturing an entire optical code on the leading side 30 in a single frame or image during a single pass of the object 20 through the viewing volume 64 (64d) when the object 20 is oriented with its front side 36 facing the vertical window 118 and its bottom side 28 facing the horizontal window 116. This SPSR is a subset of the FPRR and indicates the capability of a particular view of reading a particular side in a single pass without stitching of frames from the same or different imager regions. In some implementations, this leading side SPSR is greater than 75%. In some implementations, this success rate is greater than 90%. In some implementations, this success rate is greater than 95%. Similarly, these same success rates apply to capturing an entire optical code on the trailing side 32 during a single pass of the object 20 through the viewing volume 64 (64e). These same success rates also apply to capturing the leading side 30 and the trailing side 32 with the upper perspective views (view volumes 64b and 64c).

Furthermore, even though the embodiments with respect to FIGS. 5A-1 through 5O-1 do not provide for a separate split of the image field and associated mirrors and image paths to capture the rear or back side 34 of the object 20, such as described with respect to later embodiments, the embodiments described with respect to FIG. 5₁ are able to capture images of the rear or back side 34 due to the skew of the primary image path mirrors 130d₁ and 130e₁. The surface area of rear or back side 34 of the object 20 captured by each image field region and the SPSR for a single pass rear or back side read of an optical code are partly dependent on the horizontal skew angle 295 of the image path intersecting the rear or back side 34 of the object 20.

The horizontal skew angle 295 is shown in FIG. 5D-1 with respect to a vertical plane 297. The vertical plane 297 is transverse (and preferably perpendicular) to the horizontal window (either or both of the lower viewing windows 94 or 116), and/or either or both of the lower transparent plates 96 or 122, and/or the top surface 92. The vertical plane 297 is also transverse (and preferably perpendicular) to the plane of the vertical window 118 (either or both of the upper viewing windows 104 or 118), and/or transparent plate 106, and/or front surface 98.

The horizontal skew angle 295 represents the angle between the vertical plane 297 and either a lower edge or upper edge of the primary image path mirror 130d₁ (or the angle between the vertical plane 297 and the mirror plane between the lower and upper edges) of the image path from the view volume to the imager.

In some implementations, the horizontal skew angle 295 is between 5 degrees and 75 degrees. In some implementations, the horizontal skew angle 295 is between 5 degrees and 60 degrees. In some implementations, the horizontal skew angle 295 is between 10 degrees and 50 degrees. In some implementations, the horizontal skew angle 295 is between 10 degrees and 30 degrees. In some implementations, the horizontal skew angle 295 is between 15 degrees and 25 degrees. In some implementations, the horizontal skew angle 295 is between 17 degrees and 23 degrees. In some implementations, the horizontal skew angle 295 is about 20 degrees.

It will be appreciated that the skew angle 295 with respect to both of the lower left and lower right perspectives is preferably symmetrical even though they may be different.

In some embodiments, the horizontal skew angle 295 is adapted to facilitate a greater than 60% SPSR for capturing enough portions of the optical code on the rear or back side 34 in a single frame or image of each region of the split imager during a single pass of the object 20 through the viewing volume 64 (64d) when the object 20 is oriented with its front side 36 facing the vertical window 118 and its bottom side 28 facing the horizontal window 116. In some implementations, this success rate is greater than 75%. In some implementations, this success rate is greater than 90%. In some implementations, this success rate is greater than 95%. Furthermore, the rear or back side capture success rate can be obtained while maintaining the leading and trailing side capture success rates previously discussed. With respect to the capture of an optical code from the back or rear side of an object passing through the view volume, a combined SPSR can additionally be defined as the success rate when two images (one from each of the two image regions) of the back side are stitched together. The combined SPSR for back or rear side capture may be as good as or better than the rates presented above for single frame capture.

Each side of an object may be associated with its own SPSR with respect to a particular image region on the imager. However, with respect to the capture by an image region of an optical code from multiple sides of an object passing through the view volume, a combined SPSR can additionally be defined as the capture success rate when two or more images received by the same image region are stitched together. Alternatively, a combined SPSR may be an average of the SPSRs associated with each of the sides viewed by a region of the imager.

The single pass capture success rates with respect the leading, trailing, rear or back and bottom sides cooperate to provide the optical code reader 180 with a first pass read rate (FPRR) of greater than 75%. In some implementations, the optical code reader 180 has a FPRR that is greater than 80%. In some implementations, the optical code reader 180 has a FPRR that is greater than 85%. In some implementations, the optical code reader 180 has a FPRR that is greater than 90%. In some implementations, the optical code reader 180 has a FPRR that is greater than 95%.

There are a variety of design constraints/objectives that define the view orientation. If the scanner is set deeper, the window location is moved, or the window size is changed, the implementation would be different. Similarly, if the imagers are not on a common PCB, the mirrors could be in different locations. Such variations would affect the viewing angles and amount of skew.

C. Single Horizontal and Vertical Imagers, Each with Three-Way Split of Perspectives

This subsection describes, by way of example, details of one type of embodiment of an imager-based optical code reader 180. FIGS. 5A-5D are respective side, isometric, front, and top views of an optical code reader 180 capable of capturing multiple views of the object 20 (not shown in FIG. 5; see FIG. 1) from different perspectives. For convenience, the optical code reader 180 will be described to a large extent using similar reference numerals to those used to describe FIGS. 3 and 4 even though the dimensions of the housing 82, viewing windows, and/or transparent plates may be different; the perspectives, orientations, and/or sizes of the mirrors 130 may be different; the image paths 62 may have different angles; and/or the positioning, orientation, and/or dimensions of other components may be different.

The optical code reader 180 has only two imagers 60abc and 60def that each capture three views. The imager 60abc captures three views through the upper transparent plate 106 in the vertical housing portion 86. Those three views are from upper top, upper left and upper right perspectives, as described in greater detail below. The imager 60def captures three views through the lower viewing window 96 in the horizontal housing portion 84. Those three views are from lower left, lower right and back perspectives, as described in greater detail below

FIG. 5E is a map of an image field 186 of split-view or multi-region imager divided into three regions to capture separate views at the imager 60abc. With reference to FIGS. 5F-5H (described in greater detail below), the image field 186 of the imager 60abc may be split into three image field regions, such as a left region 192, a right region 194, and a top region 196, that may be adapted to capture images from the corresponding left upper perspective, right upper perspective, and top upper perspective, respectively. Thus, the mirror component 130b₂ reflects the image along the image path segment 62b₃ onto the left region 192 of the image field 186 of the imager 60abc; the mirror component 130c₂ reflects the image along the image path segment 62c₃ onto the right region 164 of the image field 156 of the imager 60abc; and the mirror component 130a₁ reflects the image along the image path segment 62a₂ onto the top region 196 of the image field 186 of the imager 60abc. One or more of image field variations previously discussed with respect to the image field 156 of FIG. 4 may optionally be employed in any combination with respect to the image field 186 except where such combinations are mutually exclusive.

FIG. 5F illustrates a first set of mirrors 130a (mirror 130a₁) reflecting a top upper perspective of the view volume 64a along the image path 62a to the imager 60abc of the optical code reader 180. With reference to FIG. 5F, an image of the object 20 in the view volume 64a, captured from the top upper perspective and propagated generally upward and horizontally through the upper transparent plate 106 along the image path segment 62a₁, is reflected downward by the primary mirror 130a₁ along the image path segment 62a₂ to the imager 60abc, which may be supported on the PCB 140 (not shown) located in the lower housing portion 84 of the housing 82. The image path segments 62a₁ and 62a₂ have respective lengthwise axes that intersect one another at an acute angle.

FIG. 5G is a top view of a second set of mirrors 130b (mirrors 130b₁, 130b₂ and 130b₃) reflecting a left upper perspective of the view volume 64b along the image path 62b to the imager 60abc of the optical code reader 180. With reference to FIG. 5G, an image of the object 20 in the view volume 64b, captured from the left upper perspective and propagated through the upper transparent plate 106 along the image path segment 62b₁, is reflected sideward toward the center of the reader 180 by the primary mirror 130b₁ along the image path segment 62b₂ to a secondary mirror 130b₂ in the mirror structure 130bc₂ which reflects the image along the image path segment 62b₃ to a tertiary mirror 130b₃ in the split mirror 130bc₃ which reflects the image downward along the image path segment 62b₄ to the imager 60abc. The image path segments 62b₁ and 62b₂ have respective lengthwise axes that intersect one another at an acute angle.

FIG. 5H is a top view of a third set of mirrors 130c (mirrors 130c₁, 130c₂ and 130c₃) reflecting a right upper perspective of the view volume 64c along the image path 62c to the imager 60abc of the optical code reader 180. With reference to FIG. 5H, an image of the object 20 in the view volume 64c, captured from the right upper perspective and propagated through the upper transparent plate 106 along the image path segment 62c₁, is reflected sideward toward the center of the reader 180 by the primary mirror 130c₁ along the image path segment 62c₂ to a secondary mirror 130c₂ in the mirror structure 130bc₂ which reflects the image along the image path segment 62c₃ to a tertiary mirror 130c₃ in the split mirror 130bc₃ which reflects the image downward along the image path segment 62c₄ to the imager 60abc. The image path segments 62c₁ and 62c₂ have respective lengthwise axes that intersect one another at an acute angle.

The mirror structure 130bc₂ is preferably a split or compound mirror that includes mirror components or surfaces 130b₂ and 130c₂ of the respective image paths 62b and 62c, and the mirror 130bc₃ is preferably a single planar mirror surface that has two sections 130b₃ and 130c₃ in the respective image paths 62b and 62c. The mirror components 130b₂ and 130c₂ and 130b₃ and 130c₃ of the respective split mirrors 130bc₂ and 130bc₂ may be arranged at different angles with respect to the horizontal or vertical planes (and with respect to each other) to accommodate the orientations of the different image paths 62b and 62c. The compound mirror structure 130bc₂ and its mirror components 130b₂ and 130c₂ may employ any of the variations discussed with respect to any of the other compound mirror structures and parts thereof described herein. In some embodiments, the mirror components 130b₂ and 130c₂ may have nonreflective regions in proximity to their intersections. FIG. 5I illustrates an example embodiment of the compound mirror structures 130bc₂.

FIG. 5J is a map of an image field 286 of a split-view or multi-region imager divided into three regions to capture separate views at the imager 60def. With reference to FIGS. 5K-5M (described in greater detail below), the image field 286 of the imager 60def may be split into three image field regions, such as a left region 292, a right region 294, and a back region 296, that may be adapted to capture images from the corresponding left lower perspective, right lower perspective, and back perspective, respectively. Thus, the mirror component 130d₃ reflects the image along the image path segment 62d₄ onto the left region 292 of the image field 286 of the imager 60def; the mirror component 130e₂ reflects the image along the image path segment 62e₄ onto the right region 294 of the image field 256 of the imager 60def; and the mirror component 130f₁ reflects the image along the image path 62f₂ onto the back region 296 of the image field 286 of the imager 60def. One or more of image field variations previously discussed with respect to the image field 156 of FIG. 4 may optionally employed in any combination with respect to the image field 286 except where such combinations are mutually exclusive.

FIG. 5K is a front view of a fourth set of mirrors 130d (mirrors 130d₁, 130d₂ and 130d₃) reflecting a left lower perspective of the view volume 64d along the image path 62d to an imager 60def of the optical code reader 180. With reference to FIG. 5K, an image of the object 20 in the view volume 64d, captured from the left lower perspective and propagated through the lower transparent plate 96 along the image path segment 62d₁, is reflected sideward toward the center of the imager 180 by the primary mirror 130d₁ along an image path segment 62d₂ to a secondary mirror 130d₂ in a mirror structure 130de₂ which reflects the image along an image path segment 62d₃ to a tertiary mirror 130d₃ in a mirror structure 130de₃ which reflects the image along an image path segment 62d₄ to the imager 60def, which may be supported on a PCB 140 (not shown). The imager 60def may be supported on a different PCB 140 than the one that may be used to support the imager 60abc. The image path segments 62d₁ and 62d₂ have respective lengthwise axes that intersect one another at an acute angle.

FIG. 5L is a front view of a fifth set of mirrors 130e (mirrors 130e₁, 130e₂ and 130e₃) reflecting a right lower perspective of the view volume 64e along an image path 62e to the imager 60def of the optical code reader 180. With reference to FIG. 5L, an image of the object 20 in the view volume 64e, captured from the right lower perspective and propagated through the lower transparent plate 96 along an image path segment 62e₁, is reflected sideward toward the center of the imager 180 by a primary mirror 130c₁ along an image path segment 62e₂ to the secondary mirror 130e₂ in the mirror structure 130de₂ which reflects the image along an image path segment 62e₃ to the tertiary mirror 130e3 in a mirror structure 130de₃ which reflects the image along an image path segment 62e₄ to the imager 60def. The image path segments 62e₁ and 62e₂ have respective lengthwise axes that intersect one another at an acute angle.

FIG. 5M is a side view of sixth set of mirrors 130f (mirror 130f₁) reflecting a back lower perspective of a view volume 64f along an image path 62f to the imager 60def of the optical code reader 180. With reference to FIG. 5M, an image of the object 20 in the view volume 64f, captured from the back lower perspective and propagated through the lower transparent plate 96 along an image path segment 62f₁, is reflected horizontally away from the checker side by a primary mirror 130f₁ along an image path segment 62f₂ to the imager 60def. The perspective associated with the image path 62f in FIG. 5 may be oriented similarly to or differently from the perspective associated with the image path 62f in FIGS. 3 and 4. In an alternative embodiment, one or two additional mirrors 130f may be positioned along the image path 62f to facilitate alignment with the imager 60def. The image path segments 62f₁ and 62f₂ have respective lengthwise axes that intersect one another at an acute angle

The mirror structure 130de₂ is preferably a compound or split mirror that includes mirror surfaces or components 130d₂ and 130e₂ of the respective image paths 62d and 62e, and the mirror 130de₃ is preferably a single planar mirror that includes mirror components or sections 130d₃ and 130e₃ in the respective image paths 62d and 62e. The mirror components 130d₂ and 130e₂ and 130d₃ and 130e₃ of the respective split mirrors 130de₂ and 130de₂ may be arranged at different angles with respect to the horizontal or vertical planes (and with respect to each other) to accommodate the orientations of the different image paths 62d and 62e. The compound mirror structures 130de₂ and its components 130d₂ and 130e₂ may employ any of the variations discussed with respect to any of the other compound mirror structures and parts thereof described herein. In some embodiments, the mirror components 130d₂ and 130e₂ may have nonreflective regions in proximity to their intersections. FIG. 5N illustrates an example embodiment of the compound mirror structures 130de₂.

With reference to FIGS. 4 and 5, the image paths 62d, 62e, and 62f may reflect the images of the object 20 onto a split field imager 156, such as described in connection with FIG. 4. Exemplary imagers 60 that may be used for these FIG. 5 embodiments include megapixel imagers with a resolution of 1280×1024 pixels for the imagers 60abc and 60def. One preferred megapixel imager is the model EV76C560 1.3 MP CMOS image sensor available from e2V of Essex, England and Saint-Egrève, France. However, any other suitable type of imager 60 of various resolutions may be employed.

FIG. 5O is an isometric view of multiple image paths 62 and respective multiple perspective view volumes 64 that form a cumulative view volume 64g of the optical code reader 180. An advantage of this embodiment is that two imagers 60 can capture six views from different perspectives. The image paths 62 can be alternatively arranged so that the imagers 60abc and 60def can be located in different housing portions or so that they can be supported by the same PCB 140. As with the previous embodiments and figures, any previously discussed variations or combinations thereof that are not mutually exclusive may be employed.

D. Single Imager Split for One Vertical and Multiple Horizontal Views

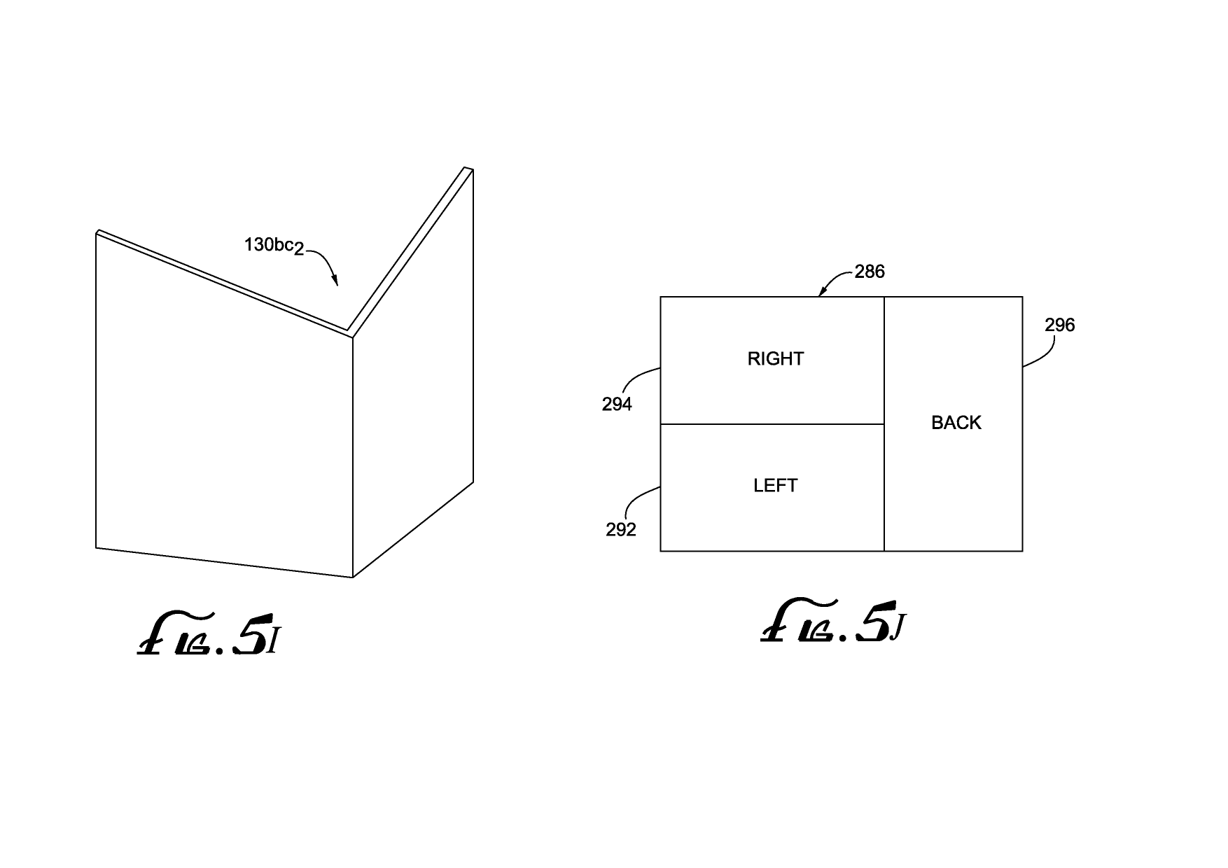

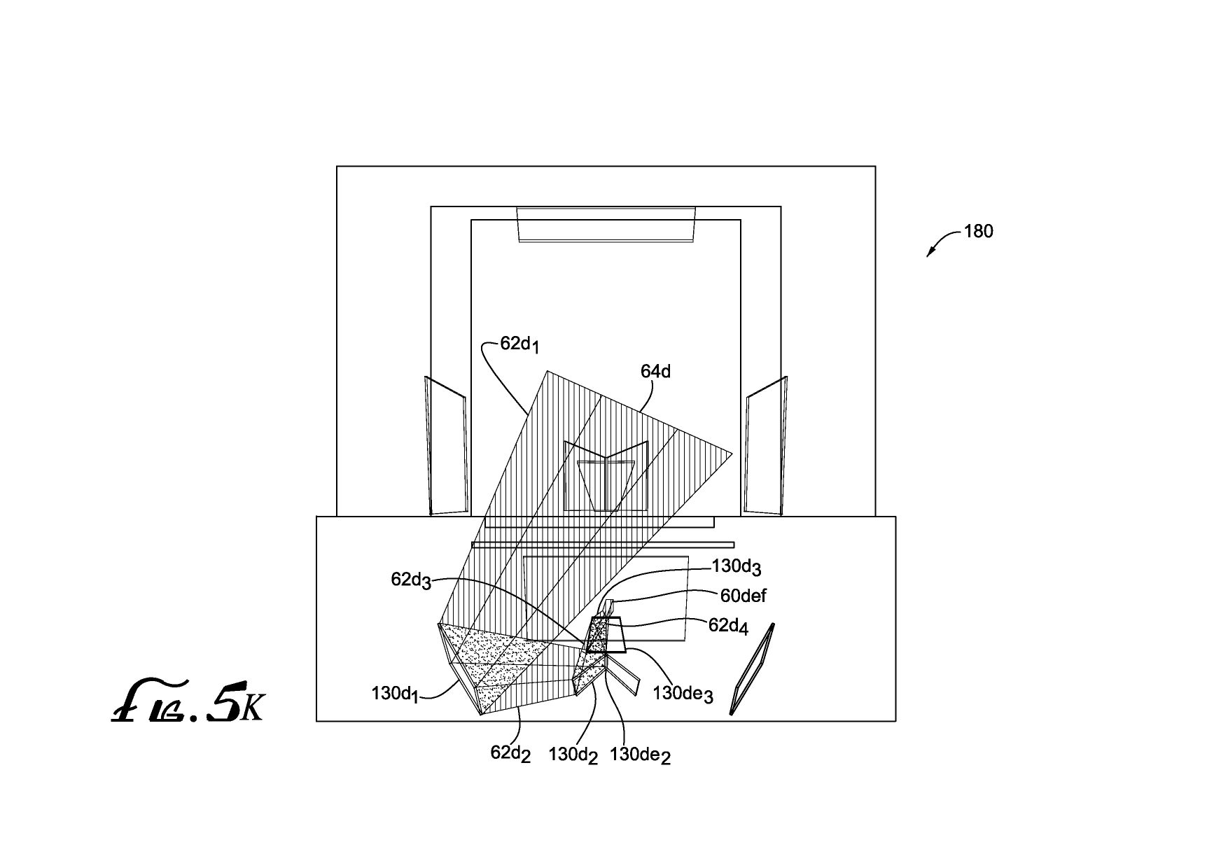

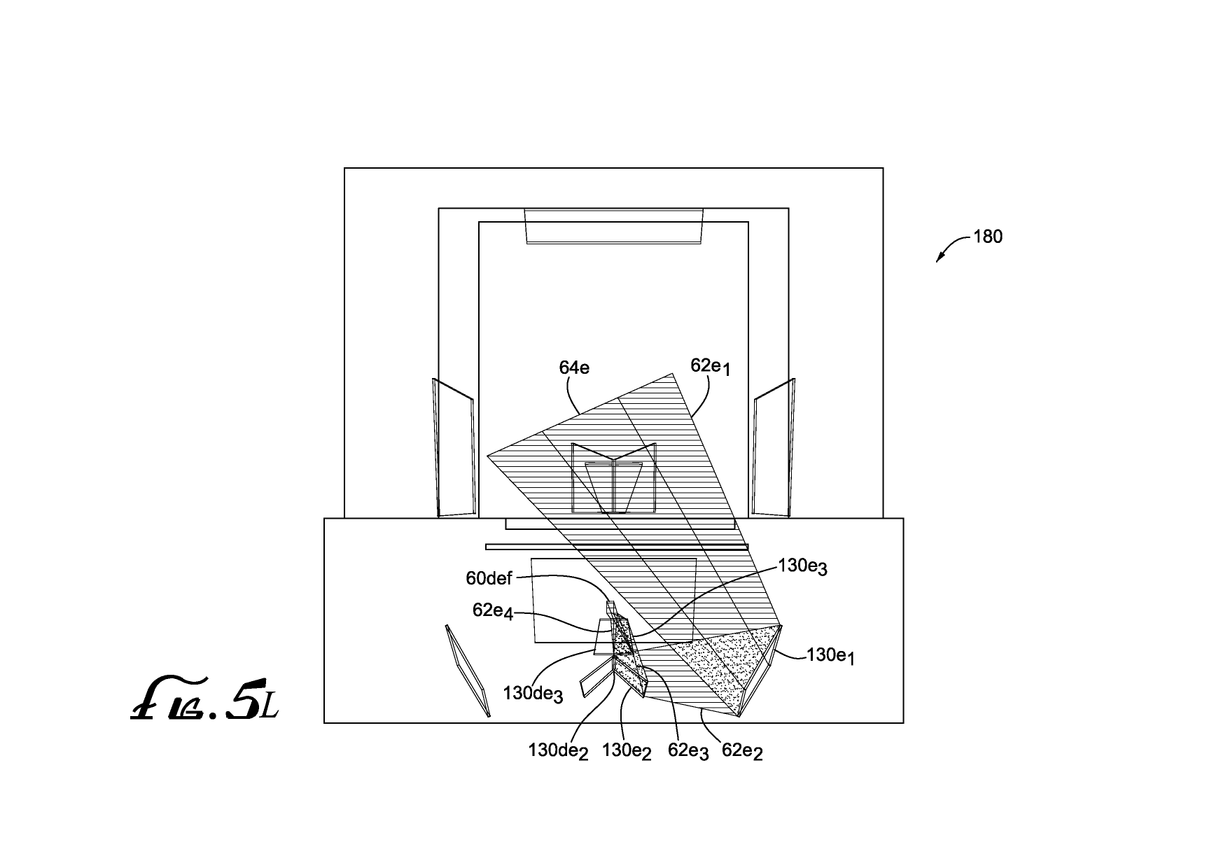

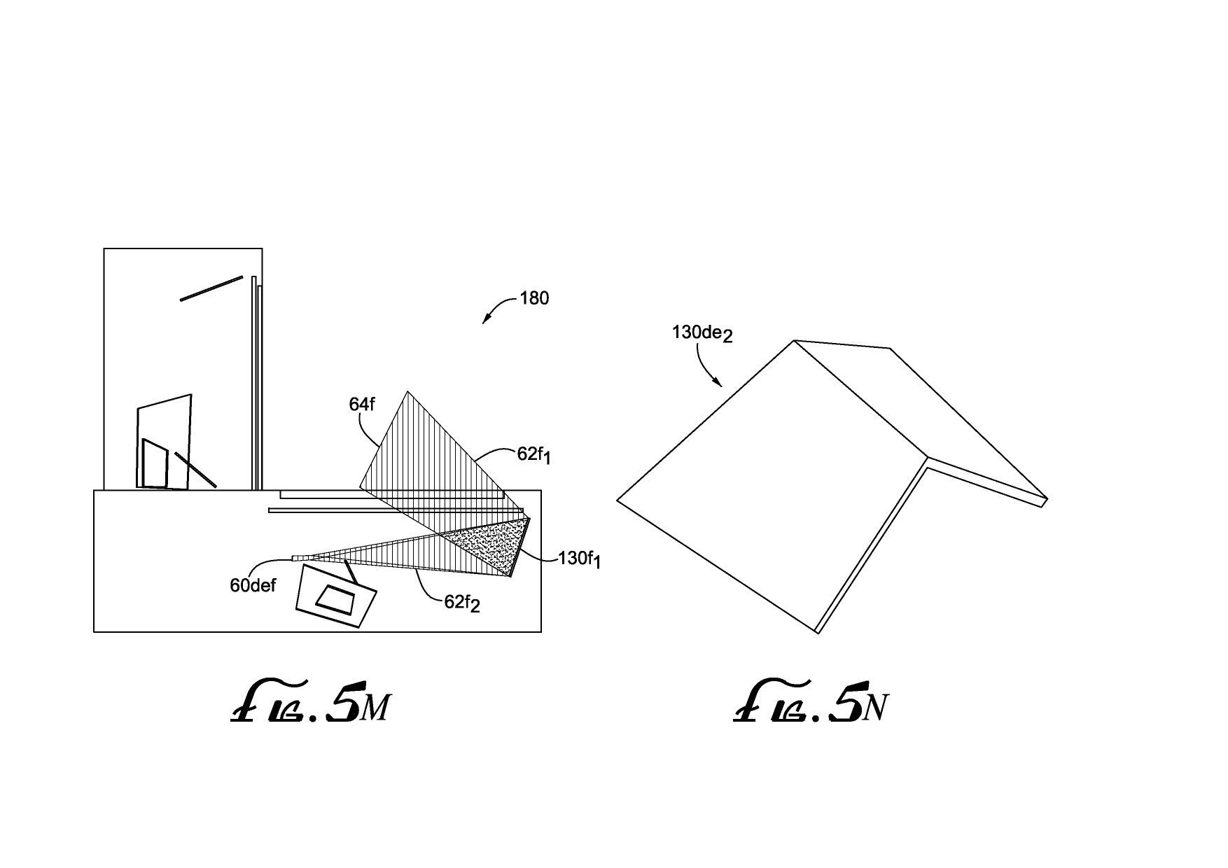

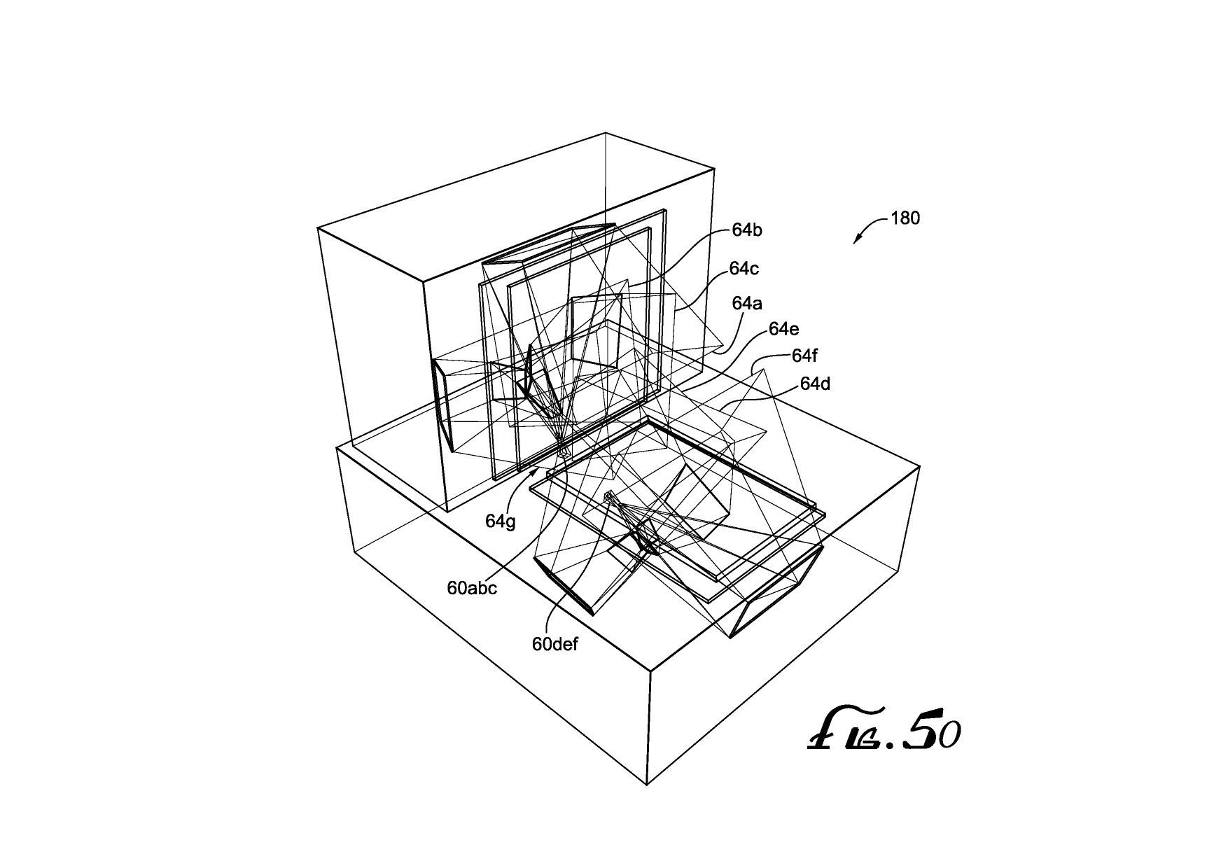

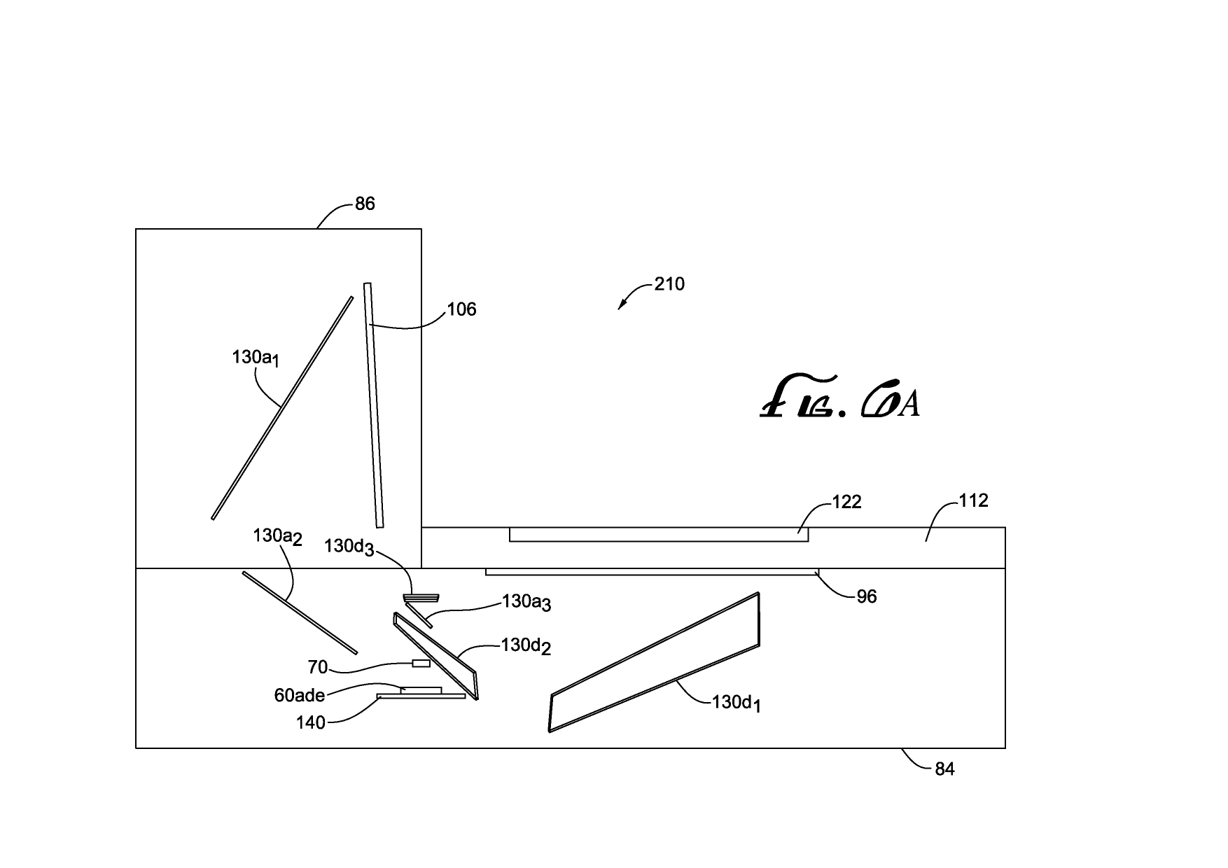

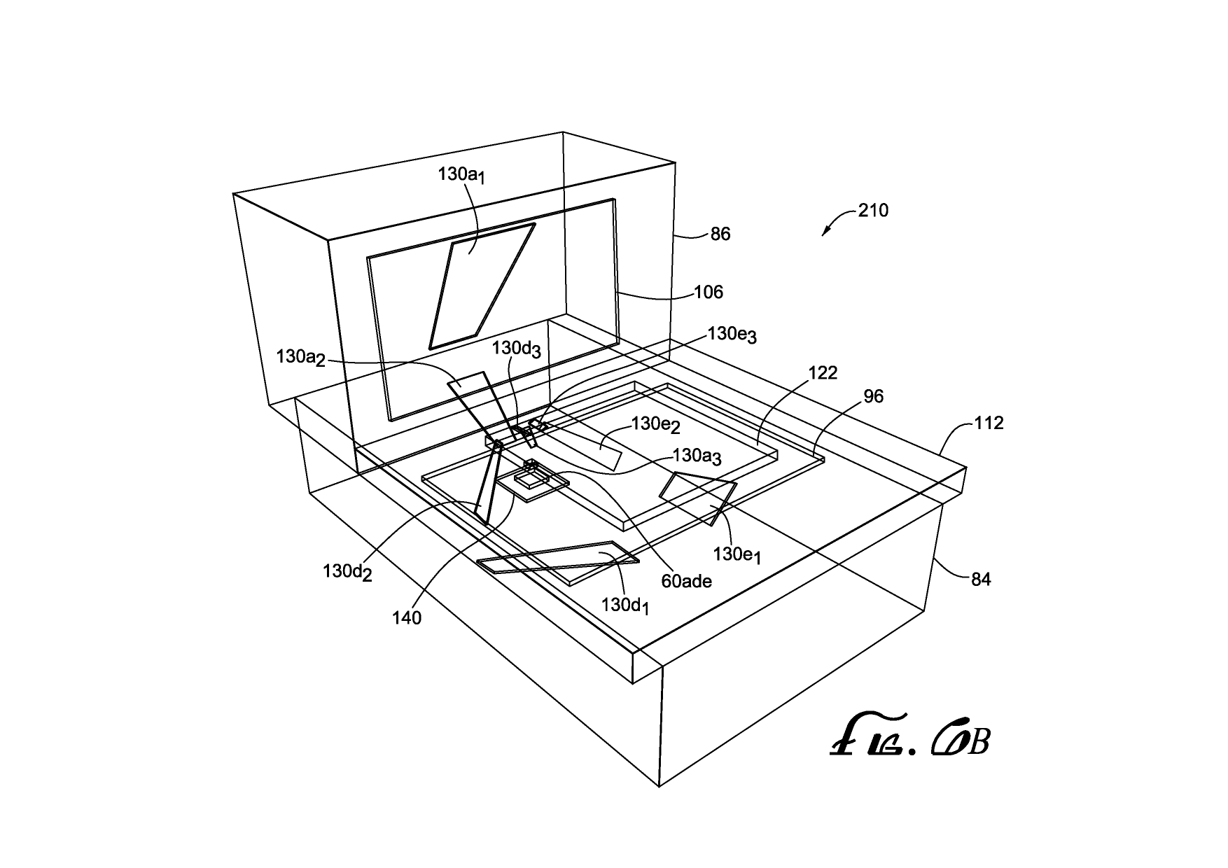

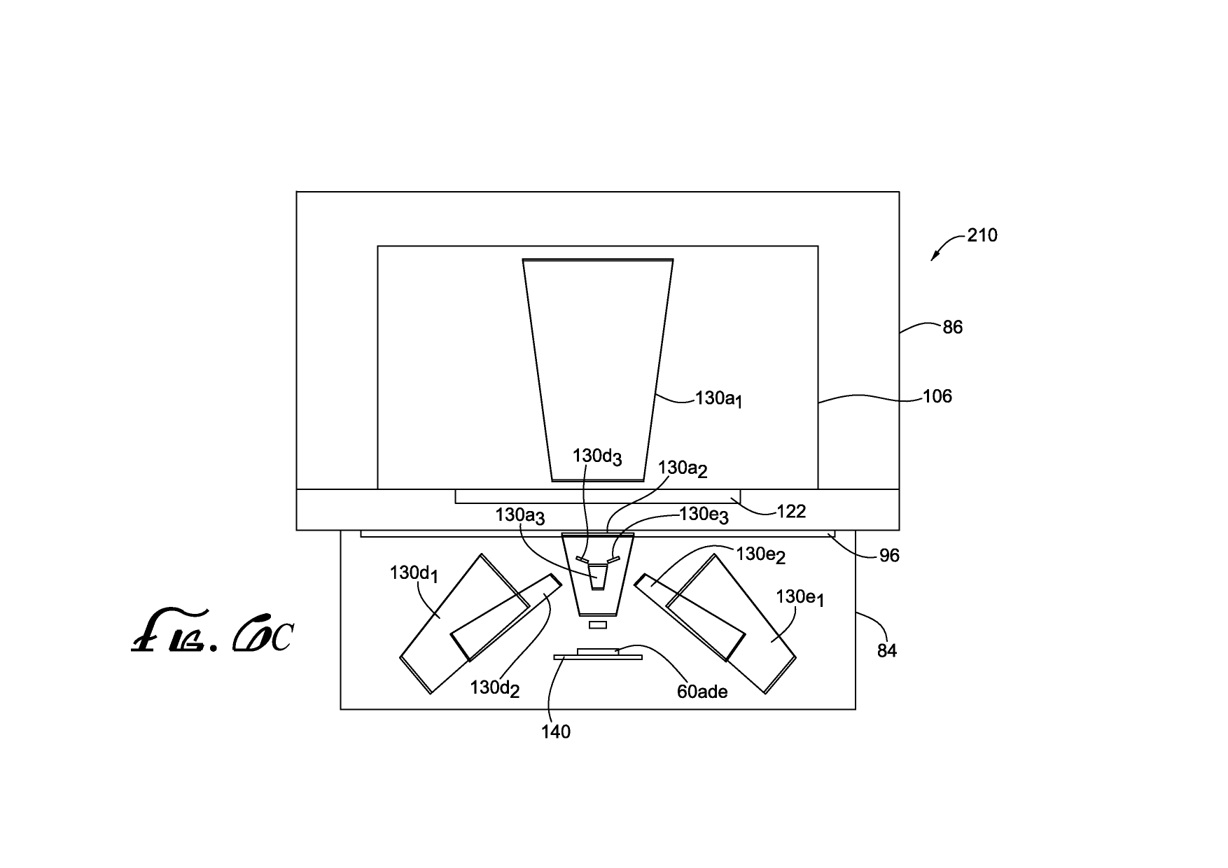

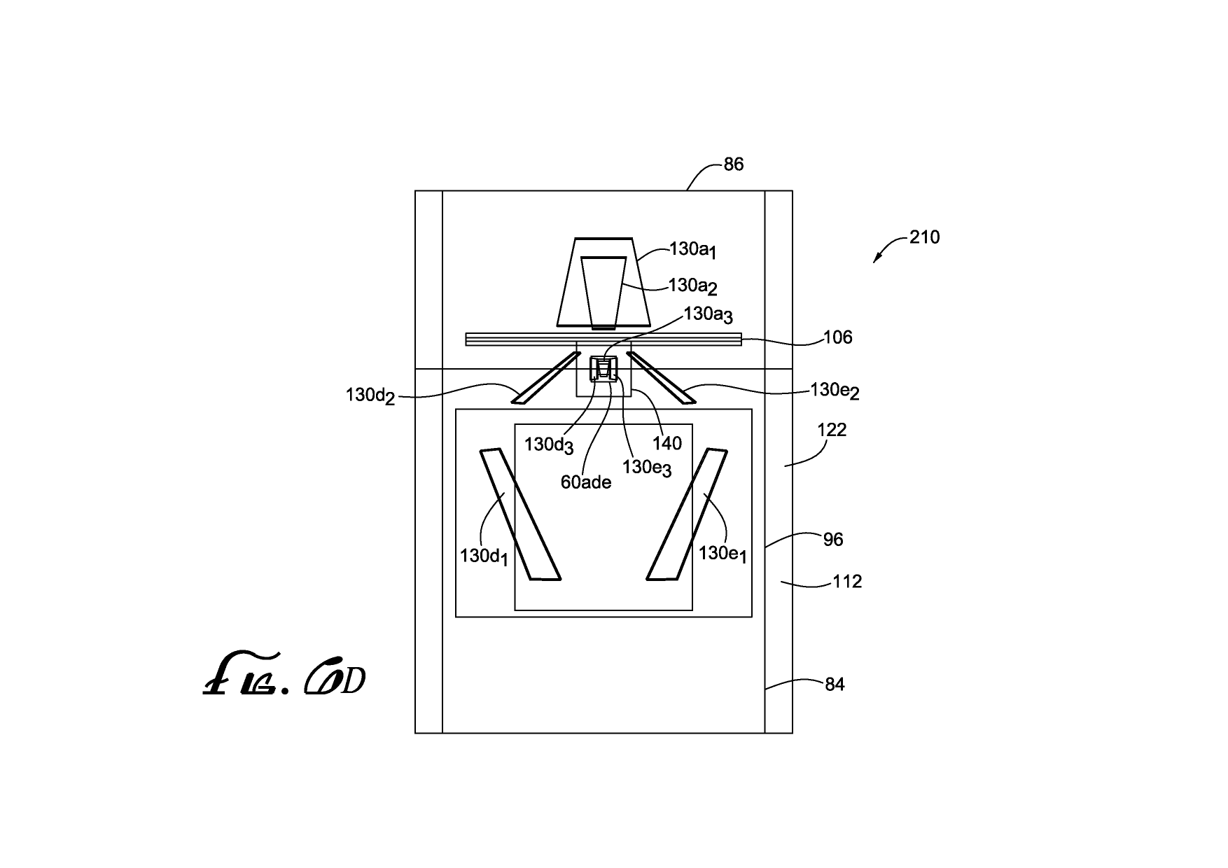

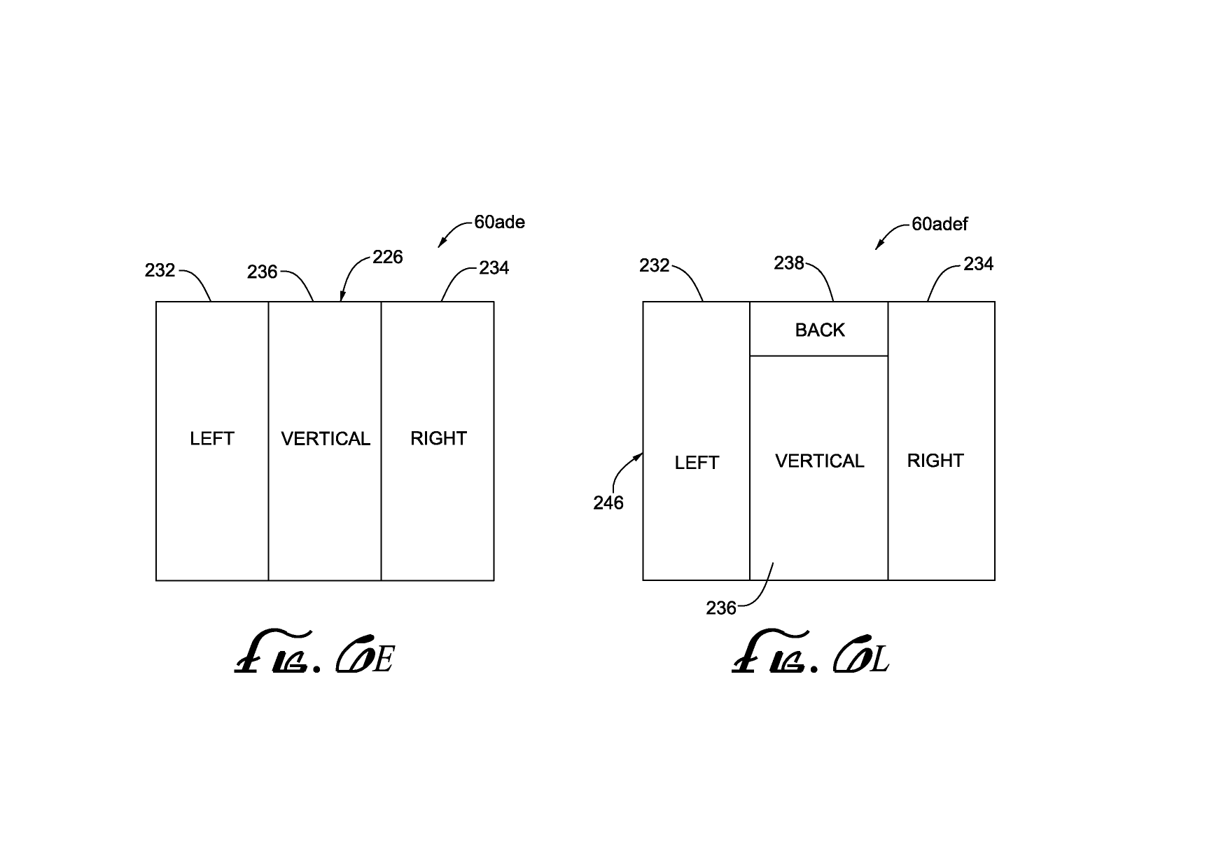

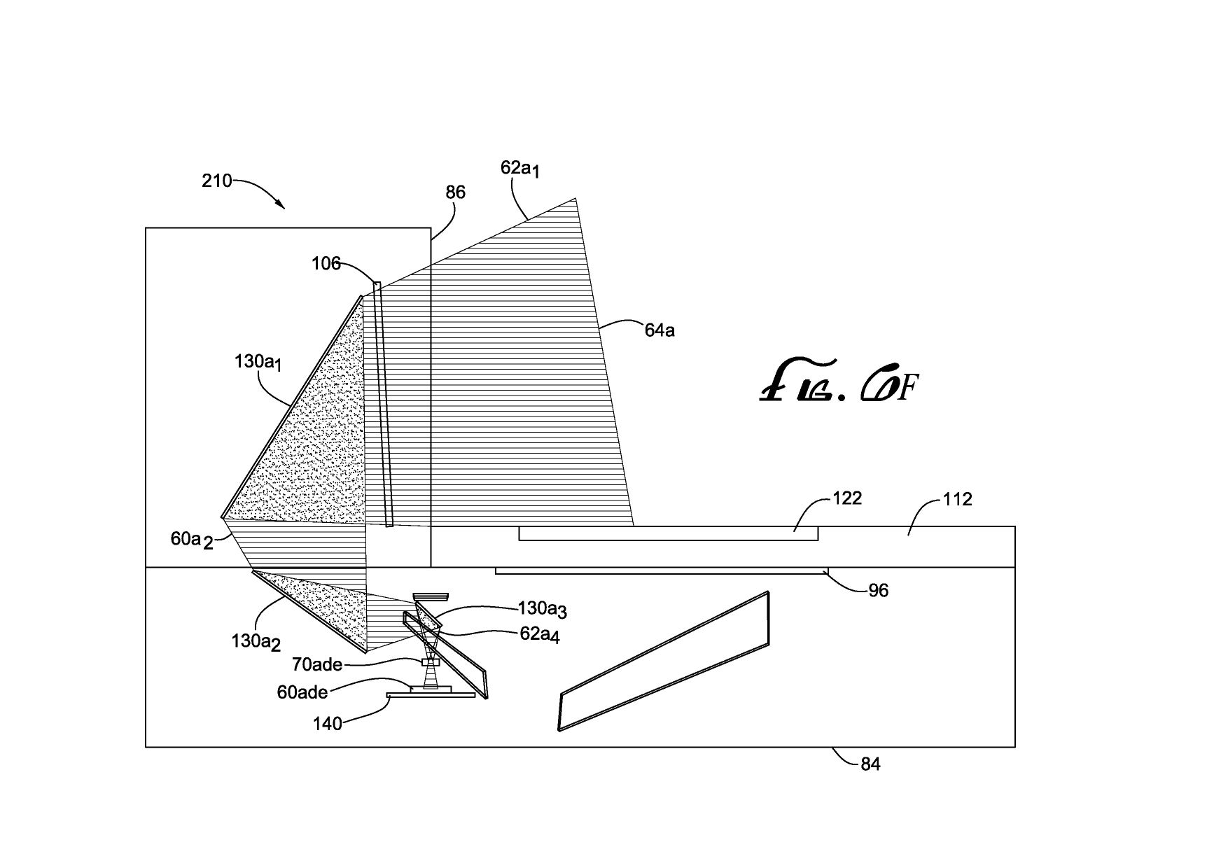

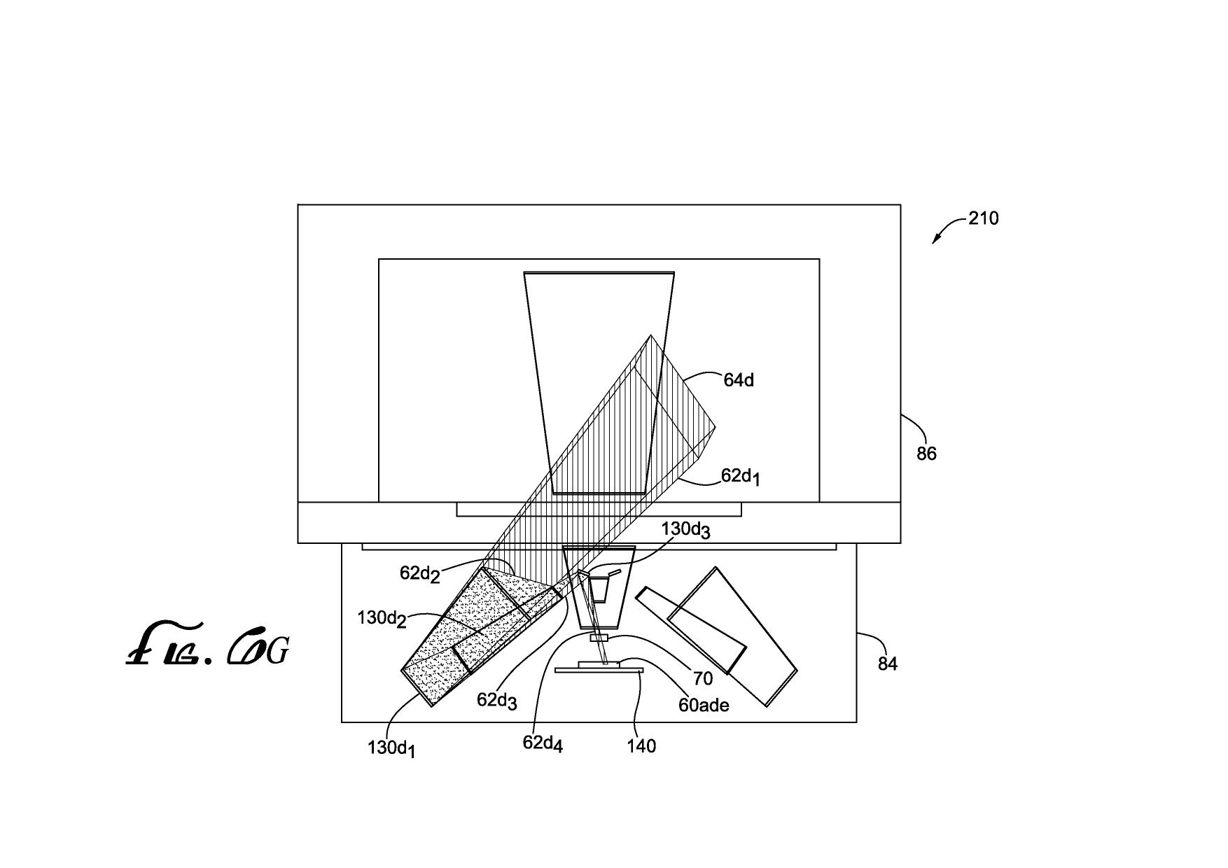

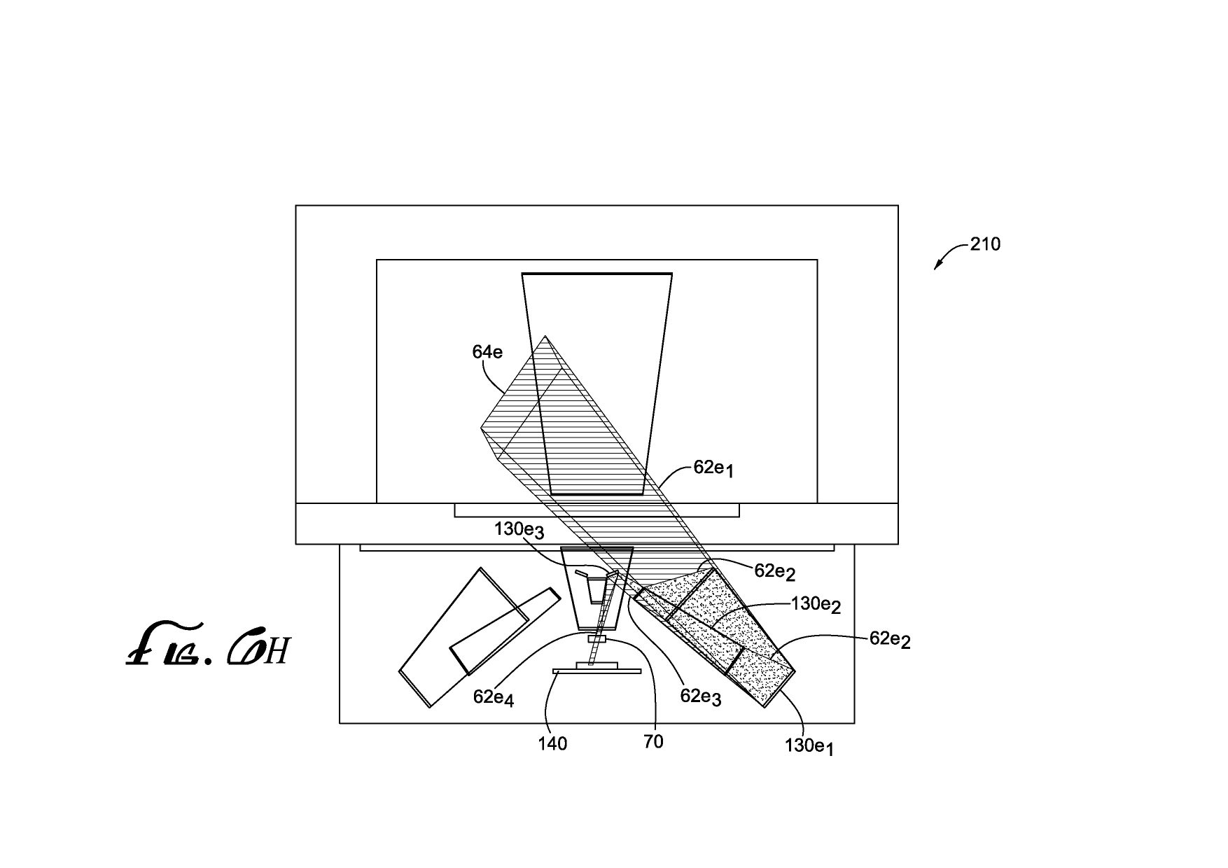

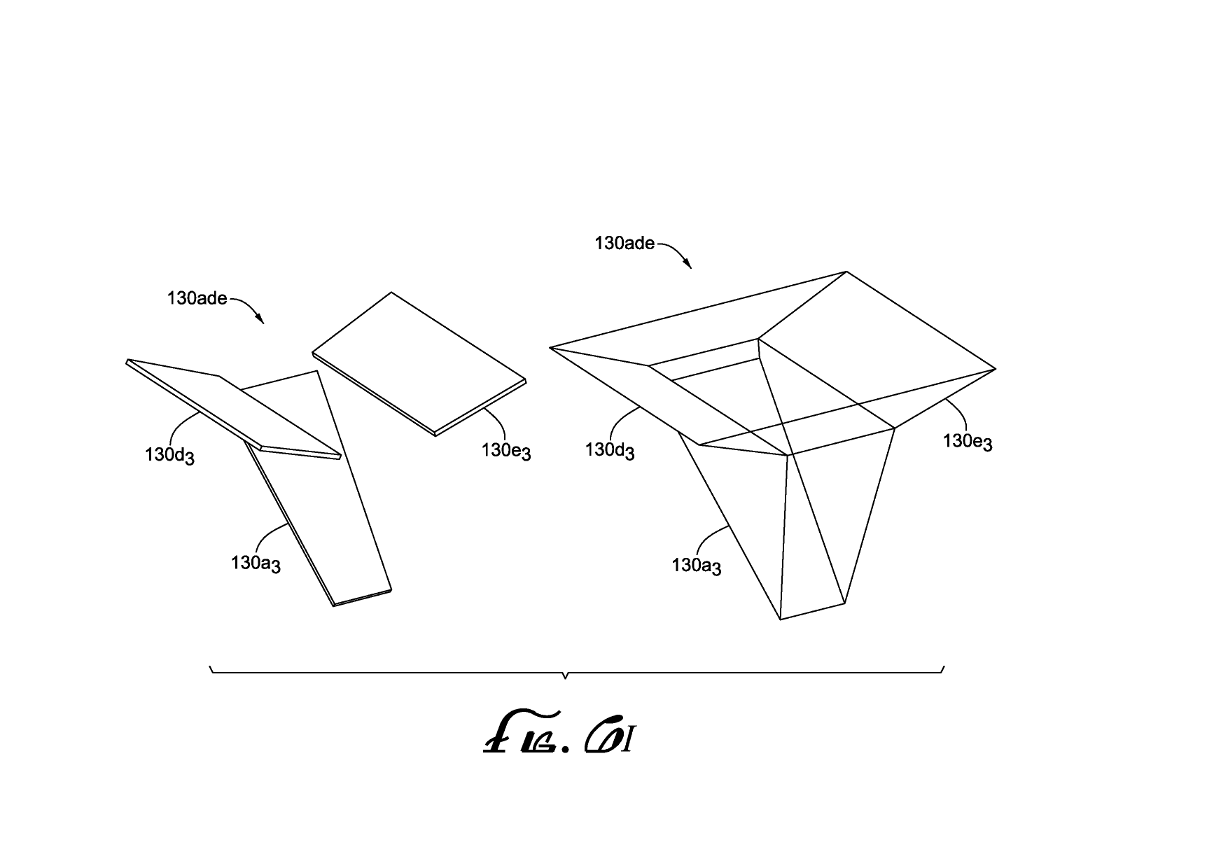

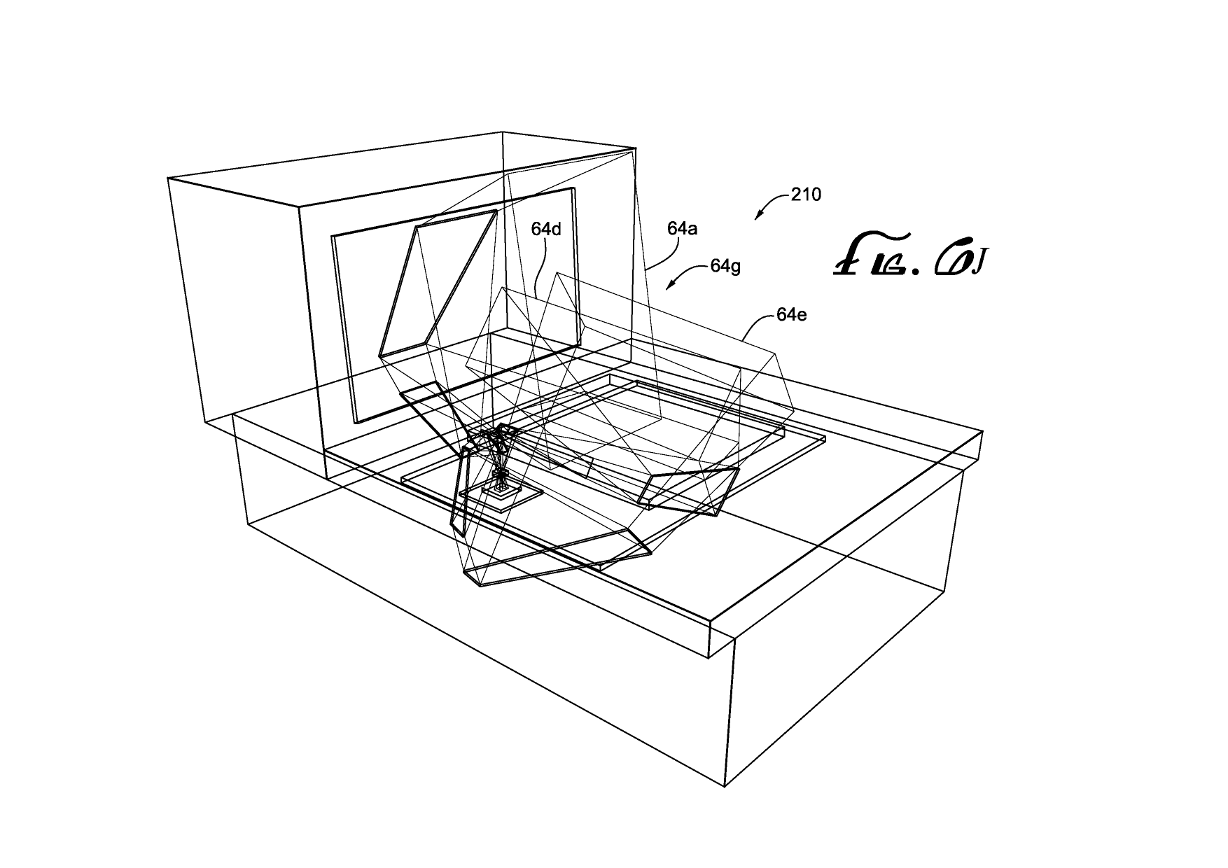

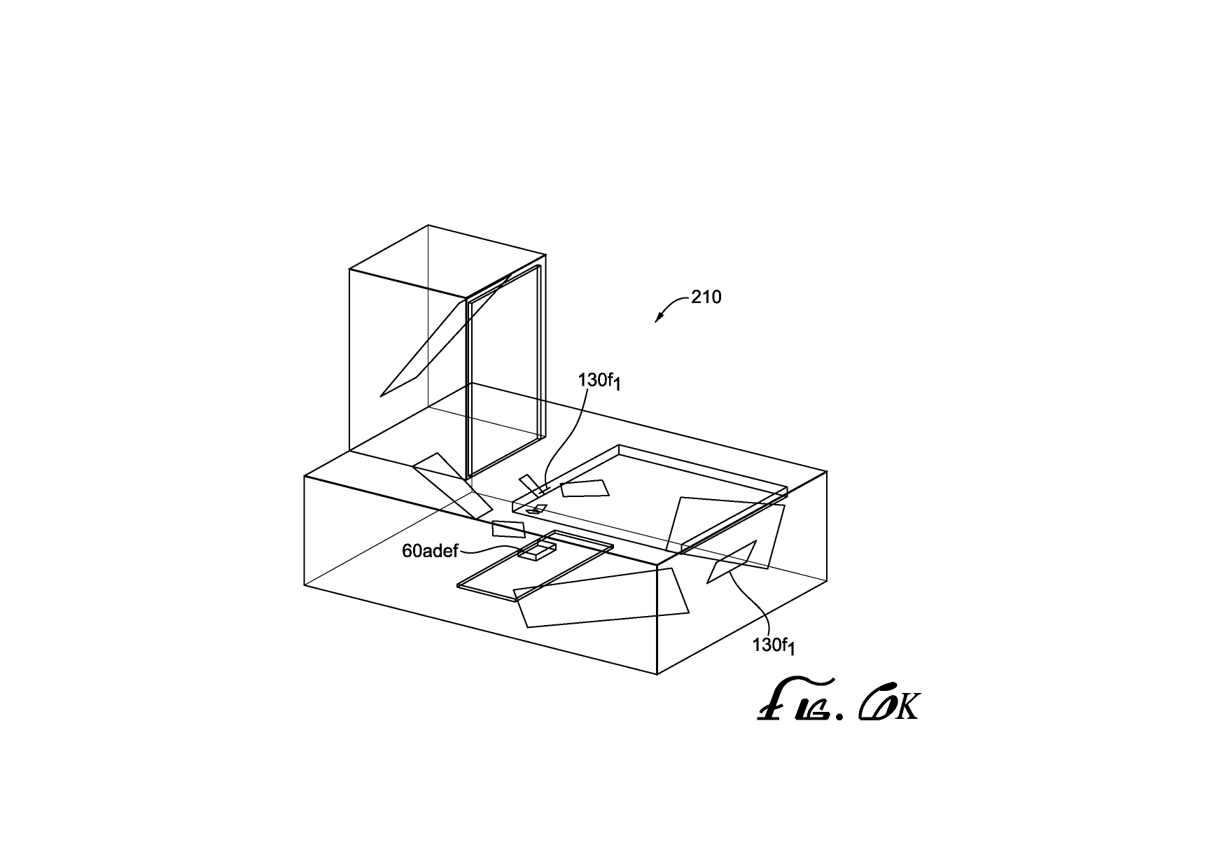

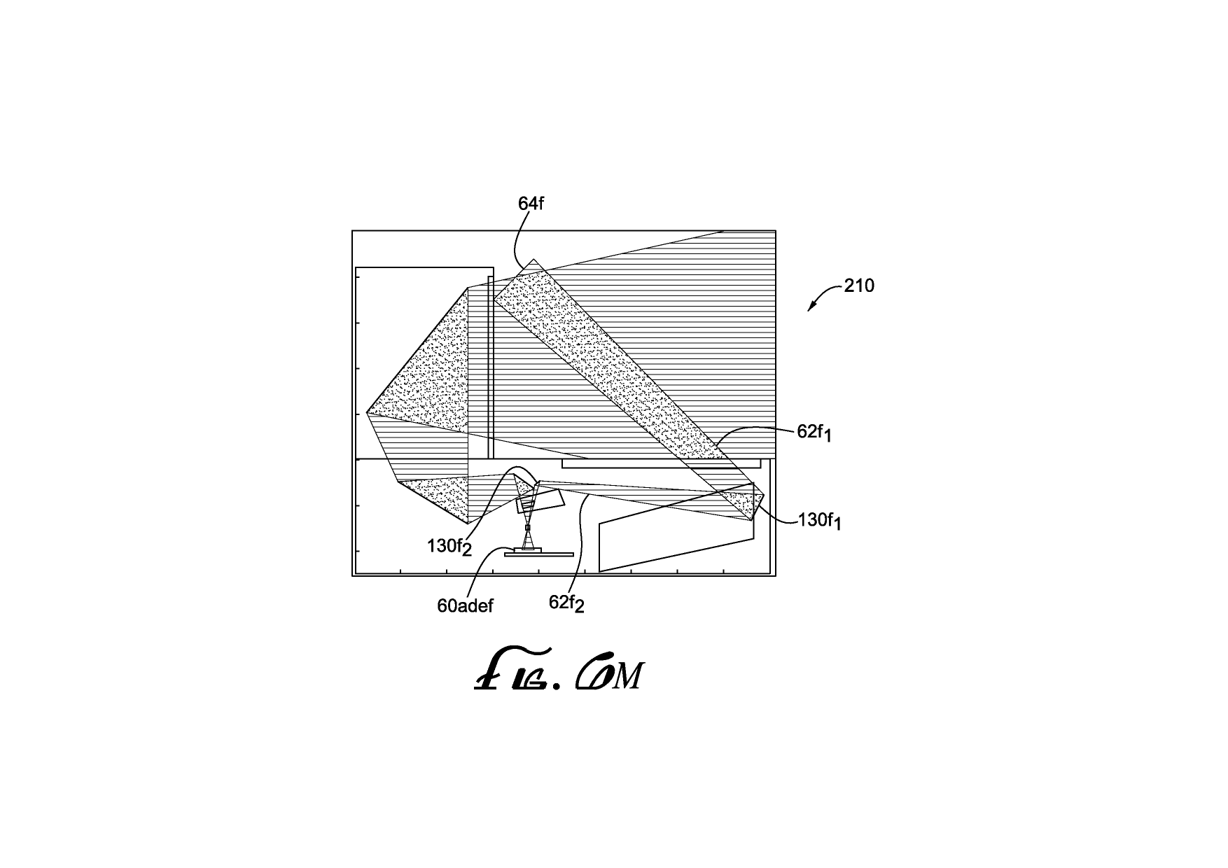

This subsection describes, by way of example, details of one type of embodiment of an imager-based optical code reader 210. FIGS. 6A-6D are respective side, isometric, front, and top views of an optical code reader 210 capable of capturing multiple views of an object 20 (not shown) from different perspectives. For convenience, the optical code reader 210 will be described to a large extent using similar reference numerals to those used to describe FIGS. 3-5 even though the dimensions of the housing 82, viewing windows, and/or transparent plates may be different; the perspectives, orientations, and/or sizes of the mirrors 130 may be different; the image paths 62 may have different angles; and/or the positioning, orientation, and/or dimensions of other components may be different.

With reference to FIGS. 6A-6D, the optical code reader 210 has only one imager 60ade that captures three views, including at least one view from the upper perspective and one view from the lower perspective.

FIG. 6E is a map of an image field 226 of the split-view or multi-region imager 60ade divided into three image field regions such as a left region 232, a right region 234, and a vertical region 236, that may be adapted to capture images from the corresponding left lower perspective, right lower perspective, and vertical perspective, respectively. Thus, with reference to the following FIGS. 6F-6I (described in greater detail in subsequent paragraphs), the mirror 130d₃ reflects the image along the image path segment 62d₄ onto the left region 232; the mirror 130e₃ reflects the image along the image path segment 62e₄ onto the right region 234; and the mirror 130a₃ reflects the image along the image path segment 62a₄ onto the vertical region 236. One or more of image field variations previously discussed with respect to the image fields 156 or 186 may optionally employed in any combination with respect to the image field 226 except where such combinations are mutually exclusive.

FIG. 6F is a side view of a first set of mirrors 130a (mirrors 130a₁, 130a₂ and 130a₃) reflecting an upper perspective of the view volume 64a along the image path 62a to the imager 60ade of the optical code reader 210. With reference to FIG. 6F, an image of the object 20 (not shown in FIG. 6) in the view volume 64a, captured generally horizontally from the upper perspective and propagated through the upper transparent plate 106 along the image path segment 62a₁, is reflected downward by the primary mirror 130a₁ along the image path segment 62a₂ to a secondary mirror 130a₂ which reflects the image horizontally toward the checker side along an image path segment 62a₃ to a tertiary mirror 130a₃ which reflects the image downward along an image path segment 62a₄ through a lens 70ade to the imager 60ade, which may be supported on the PCB 140 located in the lower housing portion 84 of the housing 82.

FIG. 6G is a front view of a second set of mirrors 130d (mirrors 130d₁, 130d₂ and 130d₃) reflecting a left lower perspective of the view volume 64d along the image path 62d to the imager 60ade of the optical code reader 210. With reference to FIG. 6G, an image of the object 20 in the view volume 64d, captured from the left lower perspective and propagated through the lower transparent plate 96 along the image path segment 62d₁, is reflected by the primary mirror 130d₁ along an image path segment 62d₂ to a secondary mirror 130d₂ which reflects the image along an image path segment 62d₃ to a tertiary mirror 130d₃ which reflects the image along an image path segment 62d₄ through the lens 70ade to the imager 60ade.

FIG. 6H is a front view of a third set of mirrors 130e (mirrors 130e₁, 130e₂ and 130e₃) reflecting a right lower perspective of the view volume 64e along an image path 62e to the imager 60ade of the optical code reader 210. With reference to FIG. 6H, an image of the object 20 in the view volume 64e, captured from the right lower perspective and propagated through the lower transparent plate 96 along an image path segment 62e₁, is reflected by a primary mirror 130e₁ along an image path segment 62e₂ to a secondary mirror 130e₂ which reflects the image along an image path segment 62e₃ to a tertiary mirror 130e₃ which reflects the image along an image path segment 62e₄ through the lens 70ade to the imager 60ade.

FIG. 6I is an isometric view of a compound mirror structure 130ade used in the optical code reader of FIGS. 6A-6D. The compound mirror structure 130ade comprises three reflective surfaces 130a₃, 130d₃ and 130e₃, which are generally on the bottom sides of the three surfaces shown on the left. The compound mirror structure 130ade may be a solid or hollow molded piece, such as shown on the right, with mirrors attached or reflective coatings applied to the desired surfaces. The other surfaces may be nonreflective, such as by painting or coating or virtue of the material used to construct the core piece. The compound mirror structure 130ade may be made by any other suitable process. In some embodiments, the mirror components may have nonreflective regions in proximity to their intersections.

FIG. 6J is an isometric view of multiple image paths 62 and respective multiple perspective view volumes 64 that form a cumulative view volume 64g of the optical code reader 210. An advantage of these embodiments is that one imager 60 can capture either three or four views, with at least one view from the upper perspective and at least one view from the lower perspective. As with the previous embodiments and figures, any previously discussed variations or combinations thereof that are not mutually exclusive may be employed.

The preceding FIGS. 6A-6J depict an embodiment of the optical code reader 210 that does not facilitate the capture of an image from the back side of an object 20. However, some embodiments of the optical code reader 210 can be adapted to capture back side images where the imager 60ade is split into four image field regions and is thus labeled imager 60adef, as in FIG. 6K, which is an isometric view of one example of an alternative embodiment of the optical code reader 210 modified to capture a back side image on the imager 60adef via mirrors 130f, which comprise individual mirrors 130f₁ and 130f₂ in this example embodiment.

FIG. 6L is a diagram of an image field 246 of the split-view or multi-region imager 60adef divided into four image field regions to capture separate views. The image field 246 may be in many respects similar to the image field 226; however, a portion of the image field region 238 of the image field 226 is employed to capture the back lower perspective. Thus, the mirror 130f₂ reflects the image along the image path 62f₃ onto a back region 238 of the image field 246 of the imager 60adef. One or more of image field variations previously discussed with respect to the image fields 156, 186, or 286 may optionally employed in any combination with respect to the image field 246 except where such combinations are mutually exclusive. Exemplary imagers 60 that may be used for these embodiments include megapixel imagers with a resolution of 1280×1024 pixels for the imager 60ade or the imager 60adef. One preferred megapixel imager is the model EV76C560 1.3 MP CMOS image sensor available from e2V of Essex, England and Saint-Egrève, France. However, any other suitable type of imager 60 of various resolutions may be employed.

FIG. 6M is a side view of an optional fourth set of mirrors 130f (mirrors 130f₁ and 130f₂) reflecting a back lower perspective of a view volume 64f along an image path 62f to imager 60adef of the optical code reader 210. An image of the object 20 in the view volume 64f, captured from the back lower perspective and propagated through the lower transparent plate 96 along an image path segment 62f₁, is reflected by a primary mirror 130f₁ generally horizontally away from the checker side along an image path segment 62f₂ to a secondary mirror 130f₂ which reflects the image generally downward along an image path segment 62f₃ through the lens (not shown) to the imager 60adef. The perspective associated with the image path 62f in FIG. 6 may be oriented similarly to or differently from the perspective associated with the image path 62f in FIGS. 3-5.

FIG. 6N is an isometric view of a compound mirror structure 130adef in the optical code reader of FIG. 6K. The compound mirror structure 130adef comprises four reflective surfaces 130a₃, 130d₃, 130e₃ and 130f₂. The compound mirror structure 130adef may be a solid or hollow molded piece, such as shown on the right, with mirrors attached or reflective coatings applied to the desired surfaces. The other surfaces may be nonreflective, such as by painting or coating or virtue of the material used to construct the core piece. In some embodiments, the mirror components may have nonreflective regions in proximity to their intersections. The compound mirror structure 130adef may be made by any other suitable process.

The optics arrangements described above may contain additional optical components such as filters, lenses, or other optical components which may be optionally placed in some or all of the image paths 62. The mirror components may include optical components such as surface treatments designed to filter or pass certain light wavelengths. In some embodiments, the image reflected by each mirror component can be captured by the entire image field or view volume 64 when pulsed lighting and/or different wavelengths are used to separate the images obtained by the different perspectives. One or more lenses may be positioned within one or more of the image paths 62. The mirrors 130 preferably have planar reflecting surfaces. In some embodiments, however, one or more curved mirrors or focusing mirrors could be employed in one or more of the imaging paths 62 provided that appropriate lenses or image manipulating software is employed. In some embodiments, one or more of the mirrors 130 may be a dichroic mirror to provide for selective reflection of images under different wavelengths.

The mirrors 130 may have quadrilateral profiles or outlines, but may have other shapes, such as other polygons. In some preferred embodiments, one or more of the mirrors 130 have trapezoidal profiles. In some alternative embodiments, one or more of the mirrors 130 may have a circular or oval profile. The mirrors 130 may have dimensions sufficient for their respective locations to propagate an image large enough to occupy an entire image field of an imager 60. The mirrors 130 may also be positioned and have dimensions sufficiently small so that the mirrors do not occlude images being propagated along any of the other image paths 62.

The mirrors 130 may be appropriately spaced to account for the depth of field of the respective imagers 60. The imagers 60 may have different depths of field, and the image paths 62 may have different lengths, different segment lengths, and different numbers of mirrors 130. In some embodiments, the numbers of mirrors 130 in any image path 62 is selected to provide the fewest number of mirrors 130 in a housing of given dimensions. The image paths 62 may also or alternatively be modified to introduce additional mirrors 130 to select whether an actual image or whether a reverse image (enantiomorphic image) of the object will be received by any given imager 60. Moreover, the same enantiomorphic image of the object 20 from the different perspectives of the object 20 may reach the imagers 60 or different enantiomorphic images of the object 20 may reach the imagers 60. Exemplary imagers 60 that may be used include wide VGA imagers with a resolution of 752×480 pixels. One preferred VGA imager is the model MT9V022 available from Aptina Imaging of Corvallis, Oreg. or San Jose, Calif.; however, any other suitable type of imager 60 of various resolutions may be employed.

The mirrors 130 not only facilitate to capture many different perspectives of an object 20, but also help to reduce the dimensions of a housing 82 needed to house all the imagers 60. For example, the image paths 62 from the imagers into the view volume 64 via the sets of mirrors 130 associated with the respective perspectives permits either or both of the lower and upper housing portions 84 and 86 to have at least one housing dimension that is smaller than a direct-perspective dimension for viewing the view volume from the same perspective directly.

### III. METHODS AND/OR MODES OF OPERATION

A. Virtual Scan Line Processing

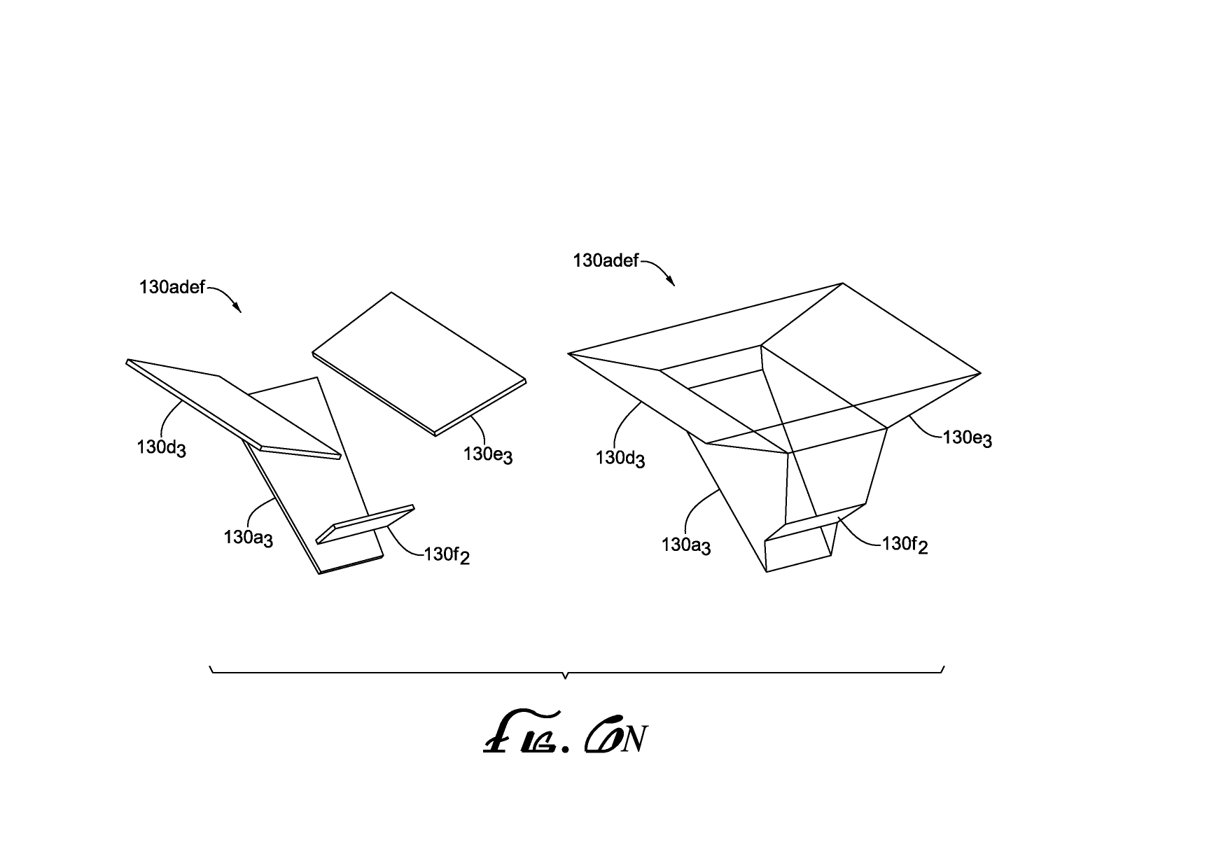

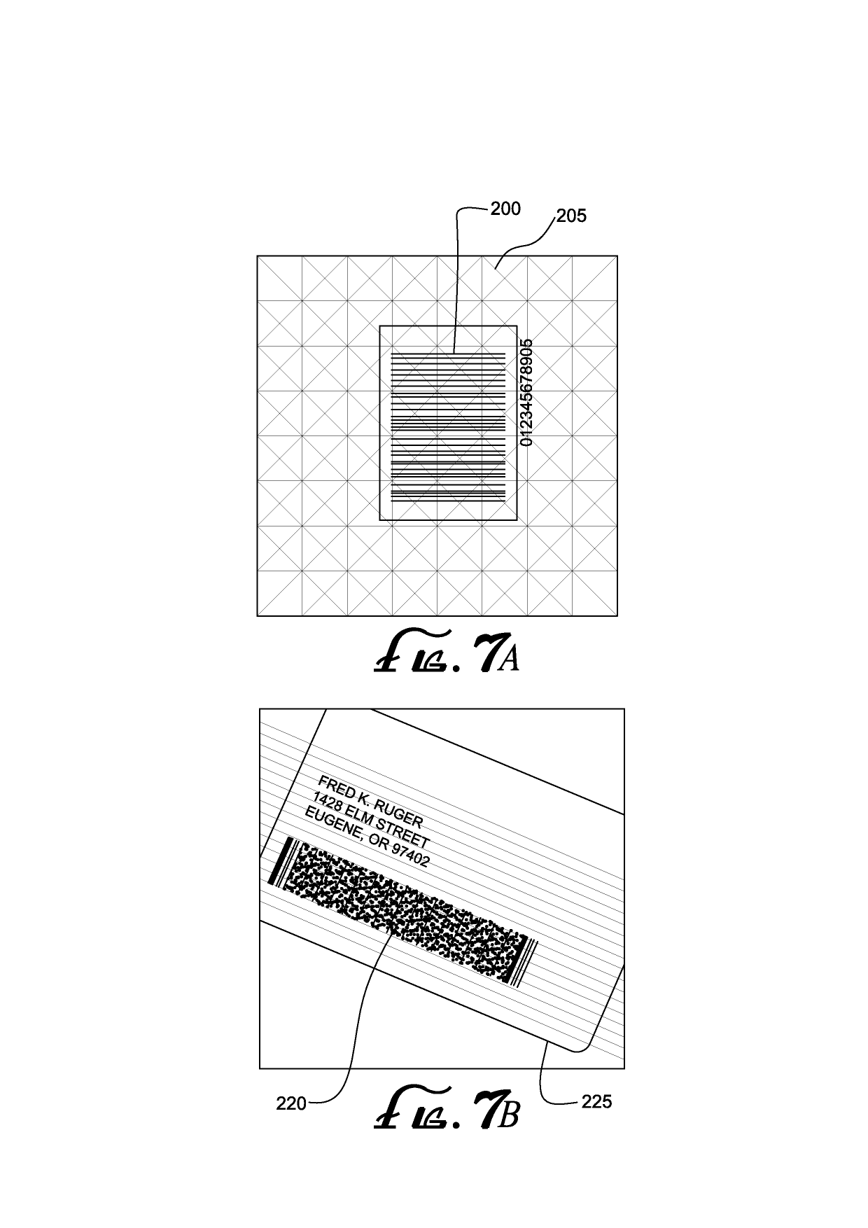

A fixed virtual scan line pattern (omnidirectional pattern in FIG. 7A) can be used to decode images such as used in the Magellan-1000i model scanner made by Datalogic Scanning, Inc. of Eugene, Oreg. In some embodiments, an alternative technique based on a vision library may be used with one or more of the imagers 60. In general, any image processing technique for decoding an optical code in an image can be employed with the readers described herein.

B. Adaptive Virtual Scan Line Processing

In order to reduce the amount of memory and processing required to decode linear and stacked barcodes, an adaptive virtual scan line processing method may be used. The left picture of FIG. 7A shows an image of a linear barcode. The scan lines traverse or overlie linear subsets of the 2-D image, of various angles and offsets. These “virtual scan lines” can be processed as a set of linear signals in a fashion conceptually similar to a flying spot laser scanner. The image can be deblurred with a one-dimensional filter kernel instead of a full 2-D kernel, reducing the processing requirements significantly.

The rotationally symmetric nature of the lens blurring function allows the linear deblurring process to occur without needing any pixels outside the virtual scan line boundaries. The virtual scan line is assumed to be crossing roughly orthogonal to the bars. The bars will absorb the blur spot modulation in the non-scanning axis, yielding a line spread function in the scanning axis. The resulting line spread function is identical regardless of virtual scan line orientation. However, because the pixel spacing varies depending on rotation (a 45 degree virtual scan line has a pixel spacing that is 1.4× larger than a horizontal or vertical scan line) the scaling of the deblurring equalizer needs to change with respect to angle.

If a stacked barcode symbology (such as RSS or PDF-417, as shown in FIG. 7B) is imaged, the device can start with an omnidirectional virtual scan line pattern and then determine which scan lines were best aligned to the barcode. The pattern can then be adapted to more closely align with the orientation and position of the barcode to enable efficient decoding. Thus the device can read highly truncated barcodes and stacked barcodes with a low amount of processing compared to a reader that processes the entire image in every frame.

C. Stitching

Partial portions of an optical code (from multiple perspectives) may be combined to form a complete optical code by a process known as stitching. The concept of stitching may be described herein only by way of example to a UPCA label, one of the most common types in the grocery world. The UPCA label has “guard bars” on the left and right side of the label and a center guard pattern in the middle. Each side has 6 digits encoded. It is possible to discern whether you are decoding the left or the right half. It is possible to decode the left half and the right half separately and then combine (stitch) the decoded results to create the complete label. It is also possible to stitch one side of the label from two pieces. In order to reduce errors, it is best that these partial scans include some overlap region. Suppose we denote the end guard patterns as G and the center guard pattern as C and we are encoding the UPCA label 012345678905, we could write this as G012345C678905G.

Stitching left and right halves would entail reading G012345C and C678905G and putting that together to get the full label. Stitching a left half with a 2-digit overlap might entail reading G0123 and 2345C to make G012345C. An example virtual scan line decoding system outputs pieces of labels that may be as short as a guard pattern and 4 digits. Using stitching rules, full labels can be assembled from pieces decoded from subsequent images from the same camera or pieces decoded from images of multiple cameras. Further details of stitching and virtual scan line methods are described in U.S. Pat. Nos. 5,493,108 and 5,446,271, the disclosures of which are herein incorporated by reference in their entireties.

D. Progressive Imaging

Some of the following techniques for optical code reading may be employed in some of the embodiments. In some embodiments, a data reader includes an image sensor that is progressively exposed to capture an image on a rolling basis. This type of imager is also known as a rolling shutter imager. The image sensor is used with a processor to detect and quantify ambient light intensity. Based on the intensity of the ambient light, the processor controls integration times for the rows of photodiodes of a CMOS imager. The processor also coordinates when a light source is pulsed based on the intensity of the ambient light and the integration times for the photodiode rows.

Depending on the amount of ambient light and the integration times, the light source may be pulsed one or more times per frame to create stop-motion images of a moving target where the stop-motion images are suitable for processing to decode data represented by the moving target. Under bright ambient light conditions, for example, the processor may cause the rows to sequentially integrate with a relatively short integration time and without pulsing the light source, which creates a slanted image of a moving target. Under medium light conditions, for example, the rows may integrate sequentially and with an integration time similar to the integration time for bright ambient light, and the processor pulses the light source several times per frame to create a stop-motion image of a moving target with multiple shifts between portions of the image. The image portions created when the light pulses may overlie a blurrier, slanted image of the moving target. Under low light conditions, for example, the processor may cause the rows to sequentially integrate with a relatively long integration time and may pulse the light source once when all the rows are integrating during the same time period. The single pulse of light creates a stop-motion image of a moving target that may overlie a blurrier, slanted image of the moving target.

In some embodiments, a data imager contains multiple CMOS imagers and has multiple light sources. Different CMOS imagers “see” different light sources, in other words, the light from different light sources is detected by different CMOS imagers. Relatively synchronized images may be captured by the multiple CMOS imagers without synchronizing the CMOS imagers when the CMOS imagers operate at a relatively similar frame rate. For example, one CMOS imager is used as a master so that all of the light sources are pulsed when a number of rows of the master CMOS imager are integrating. In other embodiments, it is beneficial to have all CMOS imagers synchronized with each other and with the pulsed illumination sources. All illumination sources could be set to pulse at the same time, providing illumination for all imagers. Alternatively, one or more imagers may receive pulsed illumination from a subset of the illumination sources. This may reduce the effects of specular reflection.

Another embodiment pulses a light source more than once per frame. Preferably, the light source is pulsed while a number of rows are integrating, and the number of integrating rows is less than the total number of rows in the CMOS imager. The result of dividing the total number of rows in the CMOS imager by the number of integrating rows is an integer in some embodiments. Alternatively, in other embodiments, the result of dividing the total number of rows in the CMOS imager by the number of integrating rows is not an integer. When the result of dividing the total number of rows in the CMOS imager by the number of integrating rows is an integer, image frames may be divided into the same sections for each frame. On the other hand, when the result of dividing the total number of rows in the CMOS imager by the number of integrating rows is not an integer, successive image frames may be divided into different sections.

Other embodiments can use a mechanical shutter in place of a rolling shutter to capture stop-motion images of a moving target. A mechanical shutter may include a flexible member attached to a shutter that blocks light from impinging a CMOS imager or other suitable image sensor. The shutter may be attached to a bobbin that has an electrically conductive material wound around a spool portion of the bobbin, where the spool portion faces away from the shutter. The spool portion of the bobbin may be proximate one or more permanent magnets. When an electric current runs through the electrically conductive material wound around the spool, a magnetic field is created and interacts with the magnetic field from the one or more permanent magnets to move the shutter to a position that allows light to impinge a CMOS imager or other suitable image sensor.

### IV. CONCLUSION

The terms and descriptions used above are set forth by way of illustration only and are not meant as limitations. Those skilled in the art will recognize that many variations can be made to the details of the above-described embodiments without departing from the underlying principles of the invention. For example, split mirrors 130 and/or sets of multiple fold mirrors 130 can be employed in alternative embodiments of the optical code reader that obtains views from only one of the upper or lower perspectives. As another example, although described primarily with respect to a checker-assisted data reader, the readers and methods described herein may be employed in a self-checkout system or an automatic reader, such as a tunnel scanner employing multiple housing portions that obtain multiple perspectives through multiple viewing windows. The subject matter disclosed in any sentence or paragraph herein can be combined with the subject matter of one or more of any other sentences or paragraphs herein as long as such combinations are not mutually exclusive or inoperable.

1. An optical code reader for obtaining images from multiple views of a six-sided box-shaped object within a viewing volume, the object having an upwardly-facing top side, a downwardly-facing bottom side, and four sidewardly facing lateral sides including a left side, a right side, a front side, and a back side, the optical code reader comprising:
a housing including a lower housing and an upper housing, the lower housing containing an upwardly-facing horizontal window and the upper housing containing a sidewardly-facing vertical window;
a first imager located within the lower housing;
a first set of first fold mirrors located within the lower housing to reflect, along a first image path passing through the upwardly-facing horizontal window, a first view of the viewing volume onto a first region of the first imager, such that the first view is adapted to capture a leading perspective of the left side of the object, a first far side perspective of the back side of the object, and a first bottom perspective of the bottom side of the object when the object is passed though the viewing volume and oriented with its front side facing the vertical window and its bottom side facing the horizontal window;
a second set of second fold mirrors located within the lower housing to reflect, along a second image path passing through the upwardly-facing horizontal window, a second view of the viewing volume onto a second region of the first imager, such that the second view is adapted to capture a trailing perspective of the right side of the object, a second far side perspective of the back side of the object, and a second bottom perspective of the bottom side of the object when the object is passed though the viewing volume and oriented with its front side facing the vertical window and its bottom side facing the horizontal window;
a second imager located within the housing; and
a third set of third fold mirrors, at least some of which are located within the upper housing to reflect, along a third image path passing through the sidewardly-facing vertical window, a third view of the viewing volume onto the second imager, such that the third view is adapted to capture at least a near side perspective of the front side of the object when the object is passed though the viewing volume and oriented with its front side facing the vertical window and its bottom side facing the horizontal window.

2. The optical code reader of claim 1, wherein the near side perspective of the front side of the object is a first near side perspective of the front side of the object, wherein the third view is captured by a first region of the second imager, and wherein the optical code reader further comprises:
a fourth set of fourth fold mirrors, at least some of which are located within the upper housing to reflect, along a fourth image path passing through the sidewardly-facing vertical window, a fourth view of the viewing volume onto a second region of the second imager, such that the fourth view is adapted to capture at least a second near side perspective of the front side of the object when the object is passed though the viewing volume and oriented with its front side facing the vertical window and its bottom side facing the horizontal window.

3. The optical code reader of claim 1, wherein the first and second regions of the first imager each comprise greater than 40% of the area of the first imager.

4. The optical code reader of claim 1, wherein a minimum dimensional area of a cross section of the viewing volume of the first view captured by the first image region on the first imager facilitates capture of an image of an entire optical code.

5. The optical code reader of claim 1, wherein sidewardly-facing vertical window forms a generally vertical plane, wherein one of the first fold mirrors forms a first fold mirror plane that is nonperpendicular along any axis to the plane of the sidewardly-facing vertical window.

6. The optical code reader of claim 1, wherein:
the first set of first fold mirrors includes at least a first set primary mirror and a first set secondary mirror;
the first image path has multiple first image path segments including at least a first primary image path segment and a first secondary image path segment, such that the first image path leads from the viewing volume along the first primary image path segment to the first set primary mirror and from the first set primary mirror along the first secondary image path segment to the first set secondary mirror;
the second set of fold mirrors includes at least a second set primary mirror and a second set secondary mirror,
the second image path has multiple second image path segments including at least a second primary image path segment and a second secondary image path segment, such that the second image path leads from the viewing volume along the second primary image path segment to the second set primary mirror and from the second set primary mirror along the second secondary image path segment to the second set secondary mirror;
the third set of third fold mirrors includes at least a third set primary mirror and a third set secondary mirror; and
the third image path has multiple third image path segments including at least a third primary image path segment and a third secondary image path segment, such that the third image path leads from the viewing volume along the third primary image path segment to the third set primary mirror and from the third set primary mirror along the third secondary image path segment to the third set secondary mirror.

7. The optical code reader of claim 1, wherein the first view is adapted to capture an image of an entire optical code from the bottom side of the object and the right or left sides of the object.

8. The optical code reader of claim 1, wherein the upwardly-facing horizontal window and sidewardly-facing vertical window are transverse to each other and transverse to a vertical plane, wherein the first set of fold mirrors include a sequentially primary first image path mirror along the first image path from the view volume to the first region of the imager, wherein the primary first image path mirror has a mirror plane between a lower edge and an upper edge, wherein the mirror plane or the lower edge or upper edge is positioned at a horizontal skew angle with respect to the vertical plane, and wherein the horizontal skew angle has a value between 10 degrees and 50 degrees.

9. The optical code reader of claim 8, wherein the second set of fold mirrors includes a sequentially primary second image path mirror along the second image path from the view volume to the second region of the imager, and wherein the second image path is symmetrical to the first image path about a bisecting vertical plane.

10. The optical code reader of claim 1, wherein the first and second imagers are mounted on a common circuit board.

11. A method for obtaining images from multiple views associated with respective perspectives of an object within a view volume, comprising:
providing a housing;
providing, within the housing, an imager;
arranging, within the housing, a first set of one or more first fold mirrors to reflect a first view associated with a first perspective of the view volume onto a first image region of the imager, the first image region capturing first images from at least three different sides of a three-dimensional object passing through the view volume; and
arranging, within the housing, a second set of one or more second fold mirrors to reflect a second view associated with a second perspective of the view volume onto a second image region of the imager, the second image region capturing second images from at least three different sides of the three-dimensional object passing through the view volume, the images being different from the first images, such that the imager acquires perspectives of views of at least four sides of the three-dimensional object.

12. The method of claim 11, wherein the object is a six-sided box-shaped object having an upwardly-facing top side, a downwardly-facing bottom side, and four sidewardly facing lateral sides including a left side, a right side, a front side, and a back side, and wherein the first set of fold mirrors reflects the first view along a first image path passing through an upwardly-facing horizontal window of the housing, such that the first view is adapted to capture a leading perspective of the left side of the object, a first far side perspective of the back side of the object, and a first bottom perspective of the bottom side of the object when the object is passed though the view volume and oriented with its bottom side facing the horizontal window.

13. The method of claim 11, wherein the second set of fold mirrors reflects the second view along a first image path passing through an upwardly-facing horizontal window of the housing, such that the second view is adapted to capture a trailing perspective of the right side of the object, a second far side perspective of the back side of the object, and a second bottom perspective of the bottom side of the object when the object is passed though the viewing volume and oriented with its bottom side facing the horizontal window.

14. The method of claim 11, wherein the first view is adapted to capture an image of an entire optical code from the bottom side of the object and the right or left sides of the object.

15. The method of claim 11, wherein the first and second regions of the imager each comprise about half of the area of the imager.

16. The method of claim 11, wherein:
the first set of first fold mirrors includes at least a first set primary mirror and a first set secondary mirror;
the first image path has multiple first image path segments including at least a first primary image path segment and a first secondary image path segment, such that the first image path leads from the viewing volume along the first primary image path segment to the first set primary mirror and from the first set primary mirror along the first secondary image path segment to the first set secondary mirror;
the second set of fold mirrors includes at least a second set primary mirror and a second set secondary mirror; and
the second image path has multiple second image path segments including at least a second primary image path segment and a second secondary image path segment, such that the second image path leads from the viewing volume along the second primary image path segment to the second set primary mirror and from the second set primary mirror along the second secondary image path segment to the second set secondary mirror.

17. The method of claim 16, wherein an image propagates in a first path primary direction from the view volume along the first image path to the first set primary mirror and in a first path secondary direction from the first set primary mirror along the first image path to the first set secondary mirror, wherein an image propagates in a second path primary direction from the view volume along the second image path to the second set primary mirror and in a second path secondary direction from the second set primary mirror along the second image path to the second set secondary mirror, and wherein the first path secondary direction and the second path secondary direction lead away from each other in substantially opposite directions.

18. The method of claim 11, wherein the housing contains a sidewardly-facing vertical window, wherein a second imager is located within the housing; and wherein a third set of third fold mirrors, at least some of which are located within the upper housing, are arranged to reflect, along a third image path passing through the sidewardly-facing vertical window, a third view of the viewing volume onto the second imager, such that the third view is adapted to capture at least a near side perspective of the front side of the object when the object is passed though the viewing volume and oriented with its front side facing the vertical window and its bottom side facing the horizontal window.

19. The method of claim 18, wherein the near side perspective of the front side of the object is a first near side perspective of the front side of the object, wherein the third view is captured by a first region of the second imager, and wherein the optical code reader further comprises:
a fourth set of fourth fold mirrors, at least some of which are located within the upper housing to reflect, along a fourth image path passing through the sidewardly-facing vertical window, a fourth view of the viewing volume onto a second region of the second imager, such that the fourth view is adapted to capture at least a second near side perspective of the front side of the object when the object is passed though the viewing volume and oriented with its front side facing the vertical window and its bottom side facing the horizontal window.

20. The method of claim 11, wherein the housing contains an upwardly-facing horizontal window and a sidewardly-facing vertical window that are transverse to each other and transverse to a vertical plane, wherein the first set of fold mirrors include a sequentially primary first image path mirror along a first image path from the view volume to the first region of the imager, wherein the primary image path mirror has a mirror plane between a lower edge and an upper edge, wherein the mirror plane or the lower edge or upper edge is positioned at a horizontal skew angle with respect to the vertical plane, and wherein the horizontal skew angle has a value between 10 degrees and 50 degrees.

21. The method of claim 20, wherein the second set of fold mirrors include a sequentially primary second image path mirror along a second image path from the view volume to the second region of the imager, and wherein the second image path is symmetrical to the first image path about a bisecting vertical plane.

22. An optical code reader for obtaining images of an optical code on an object, comprising:
a first window;
a second window generally transverse to the first window, the first and second windows bounding a viewing volume in which the object may be imaged;
a set of two or more imagers positioned on an opposite side of one or more of the first and second windows relative to the viewing volume, and oriented and configured to capture images of the object, when the object is in the viewing volume, from at least three different views, wherein each of the views passes through one of said first and second windows, at least one of said views passes through the first window, and at least one of said views passes through the second window;
a common circuit board having opposing first and second sides, wherein at least some of said imagers are mounted on the first side of the common circuit board and at least some of said imagers are mounted on the second side of the common circuit board; and
at least one mirror positioned on an opposite side of one or more of the first and second windows relative to the viewing volume, wherein at least one of the views is reflected off one or more of said at least one mirror.

23. The optical code reader of claim 22, wherein the first window is a sidewardly-facing vertical window and the second window is an upwardly-facing horizontal window, wherein the first side of the common circuit board is an upwardly-facing circuit board side and the second side of the common circuit board is a downwardly-facing circuit board side, wherein the set of two or more imagers includes at least first and second imagers, wherein the first imager is mounted on the upwardly-facing circuit board side and captures at least a first image that passes through the sidewardly-facing vertical window, and wherein the second imager is mounted on the downwardly-facing circuit board side and captures at least a second image that passes through the upwardly-facing horizontal window.

24. The optical code reader of claim 23, further comprising:
a housing including a lower housing and an upper housing, the lower housing containing the upwardly-facing horizontal window and the upper housing containing the sidewardly-facing vertical window, wherein the first imager is mounted at a first distance to the sidewardly-facing vertical window and the second imager is mounted at a second distance to the sidewardly-facing vertical window, and wherein the second distance is greater than the first distance.

25. The optical code reader of claim 22, wherein the set of two or more imagers includes at least first and second imagers, and wherein the first and second imagers are separated by a distance of at least 7.5 cm.

26. The optical code reader of claim 22, wherein the first side of the common circuit board has a first configuration of components and the second side of the common circuit board has a second configuration of components, wherein the first and second configurations of components are identical, and wherein the first and second configurations of components are rotated 180 degrees with respect to each other.

27. The optical code reader of claim 23, wherein the common circuit board has a first end that is proximal to the sidewardly-facing vertical window, wherein the common circuit board has a second end that is distal from the sidewardly-facing vertical window and opposite the proximal end, and wherein the first imager is mounted to the proximal end and the second imager is mounted to the distal end.

28. The optical code reader of claim 22, wherein the first window is a sidewardly-facing vertical window and the second window is an upwardly-facing horizontal window, the optical code reader further comprising:
a housing including a lower housing and an upper housing, the lower housing containing the upwardly-facing horizontal window and the upper housing containing the sidewardly-facing vertical window, wherein the set of two or more imagers includes at least first and second imagers, and wherein the first and second imagers are located within the lower housing;
a first set of first fold mirrors located within the lower housing to reflect, along a first image path passing through the upwardly-facing horizontal window, a first view of the object in the viewing volume onto a first region of the first imager;
a second set of second fold mirrors located within the lower housing to reflect, along a second image path passing through the upwardly-facing horizontal window, a second view of the of the object in viewing volume onto a second region of the first imager;
a third set of third fold mirrors, at least some of which are located within the upper housing to reflect, along a third image path passing through the sidewardly-facing vertical window, a third view of the object in the viewing volume onto a first region of the second imager;
a fourth set of fourth fold mirrors, at least some of which are located within the upper housing to reflect, along a fourth image path passing through the sidewardly-facing vertical window, a fourth view of the object in the viewing volume onto a second region of the second imager.

29. The optical code reader of claim 28, wherein the upwardly-facing horizontal window and sidewardly-facing vertical window are transverse to each other and transverse to a vertical plane, wherein the first set of fold mirrors include a sequentially primary first image path mirror along the first image path from the view volume to the first region of the imager, wherein the primary first image path mirror has a mirror plane between a lower edge and an upper edge, wherein the mirror plane or the lower edge or upper edge is positioned at a horizontal skew angle with respect to the vertical plane, and wherein the horizontal skew angle has a value between 10 degrees and 50 degrees.

30. The optical code reader of claim 29, wherein:
the first set of first fold mirrors includes at least a first set primary mirror and a first set secondary mirror;
the first image path has multiple first image path segments including at least a first primary image path segment and a first secondary image path segment, such that the first image path leads from the viewing volume along the first primary image path segment to the first set primary mirror and from the first set primary mirror along the first secondary image path segment to the first set secondary mirror;
the second set of fold mirrors includes at least a second set primary mirror and a second set secondary mirror,
the second image path has multiple second image path segments including at least a second primary image path segment and a second secondary image path segment, such that the second image path leads from the viewing volume along the second primary image path segment to the second set primary mirror and from the second set primary mirror along the second secondary image path segment to the second set secondary mirror;
the third set of third fold mirrors includes at least a third set primary mirror and a third set secondary mirror;
the third image path has multiple third image path segments including at least a third primary image path segment and a third secondary image path segment, such that the third image path leads from the viewing volume along the third primary image path segment to the third set primary mirror and from the third set primary mirror along the third secondary image path segment to the third set secondary mirror;
the fourth set of fourth fold mirrors includes at least a fourth set primary mirror and a fourth set secondary mirror;
the fourth image path has multiple fourth image path segments including at least a fourth primary image path segment and a fourth secondary image path segment, such that the fourth image path leads from the viewing volume along the fourth primary image path segment to the fourth set primary mirror and from the third set primary mirror along the fourth secondary image path segment to the fourth set secondary mirror;
the first and second imagers are mounted at an imager distance from each other;
the first set primary mirror is positioned at a mirror distance from the third set primary mirror; and
the mirror distance is greater than the imager distance.
